(19) United States
(12) Patent Application Publication
(10) Pub. No.: US 2004/0010592 A1
(43) Pub. Date: Jan. 15, 2004

(54) Resource allocation

(76) Inventors: Andrew Richard Carver, Cambridgeshire (GB); David Sinclair Ferguson, Cambridgeshire (GB); Russell Jon Haggar, Hertfordshire (GB); Neil Philip Piercy, Cambridgeshire (GB); Rebecca Bryony Hoyle, Cambridgeshire (GB); Peter Kelly, Cambridgeshire (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/181,209

(22) PCT Filed: Jan. 15, 2001
(86) PCT No.: PCT/GB01/00143

(30) Foreign Application Priority Data
Jan. 14, 2000 (GB) 0000910.0
Aug. 4, 2000 (GB) 0019229.4

(51) Int. Cl. G06F 15/173

(52) U.S. Cl. 709/226

(57) ABSTRACT

A shared resource allocation system for allocating a shared resource amongst a plurality of devices operable to access or use the resource. The system includes controlling means for controlling access to or use of the resource by each of the devices and means for receiving bids from one or more of the devices. Each bid indicates a requested amount of the resource and a price offered for the requested amount. The system also includes allocation means for processing the received bids to determine an appropriate allocation of the resource, and instructing means for instructing the controlling means to control access to or use of the shared resource in accordance with the determined allocation.

The present invention relates to a method and apparatus for allocating a shared resource to the users of a communications network, and in particular, to a method and apparatus which permits such allocation to be performed on a dynamic basis and in dependence upon the value ascribed to the resource by the user.

Within a communications network, such as a telephone network or a computer network, there are a number of shared resources including bandwidth across constraining data links (ie bottlenecks), processing power on shared processing units and data storage capacity on shared data storage units. The conventional way of sharing such resources is to allocate the resource on a first come first served basis until the resource is being fully utilised. The price charged for that service is then fixed, except for periodical revisions.

In times of high demand, the resource is fully utilised and further user demand is rejected and in times of low demand, the resource is under used. The resource is therefore not utilised in an efficient manner.

According to a first aspect of the present invention, there is provided a shared resource allocation system comprising

(i) a shared resource;

(ii) a plurality of devices adapted to access or use the resource;

(iii) controlling means for controlling access or use of the resource by each of the devices;

(iv) means for receiving bids from one or more of the devices, which bids indicate a requested amount of the shared resource and a price which they are prepared to pay for the requested amount; and

(v) means for processing the received bids to define an appropriate allocation of the shared resource and for instructing the controlling means to control access or use of the shared resource in accordance with the determined allocation.

Such a system provides the advantage that even when the shared resource is in high demand, other users can still access the shared resource provided they are prepared to offer a high enough price. Similarly, when demand is low, the shared resource can still be utilised by allocating it to users who are prepared to offer only a low price.

Preferably, the shared resource is a resource required to permit a communication of data between two of the devices. Ideally, more than one device may bid for the same allocation of the resource to permit a communication of data between the two devices so that, for example, both parties can contribute to the cost. For example, both devices which are party to the communication may preferably bid for and thus contribute towards the cost of the allocation of the resource required to permit the communication by combining the price offers from each bid.

The price charged per unit of utilisation of the resource is preferably charged at a rate determined by establishing a price which approximates to the market clearing price at which the mean demand for the shared resource corresponds to a predetermined large fraction of the total amount of the resource available. This has the advantage of encouraging bidders to offer a price which is a true reflection of the value which they ascribe to the resource.

The shared resource is preferably allocated to the devices for a predetermined period as this permits the system to avoid excessive signalling overhead and acts as a dampening mechanism to reduce fluctuations in the price charged to bidders. Preferably the predetermined period is within the range of 1 to 100 seconds. In times of rising demand, the initial price charged to devices requesting a new allocation of some of the shared resource is preferably greater than the price charged to devices who were first allocated some of the resource at some earlier time and who have maintained their allocation of the resource during that time. This also provides stability to the system.

Exemplary embodiments of the present invention will now be described with reference to the accompanying drawings in which:

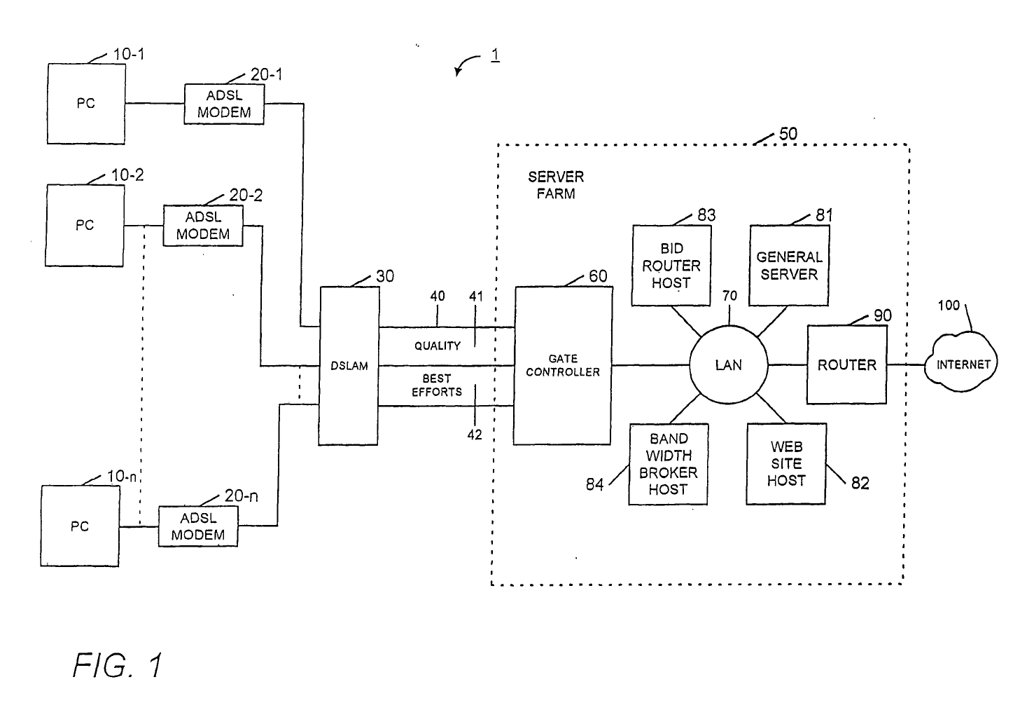

FIG. 1 is a schematic diagram of a computer network comprising a number of computer terminals which communicate with each other via a constraining data link;

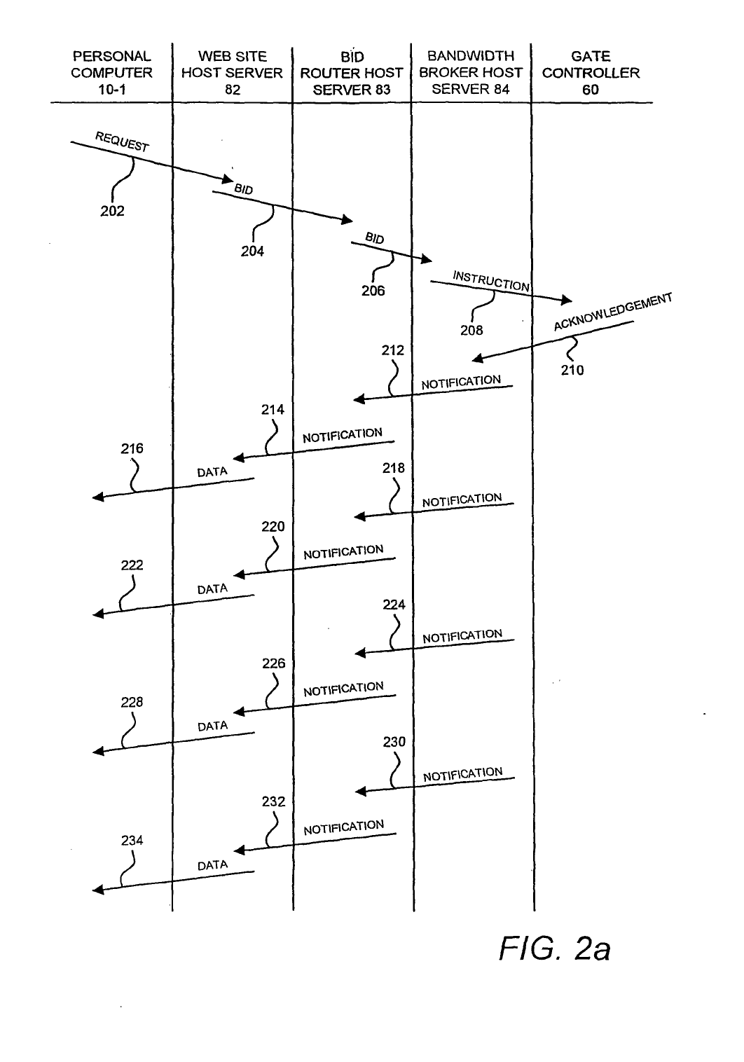

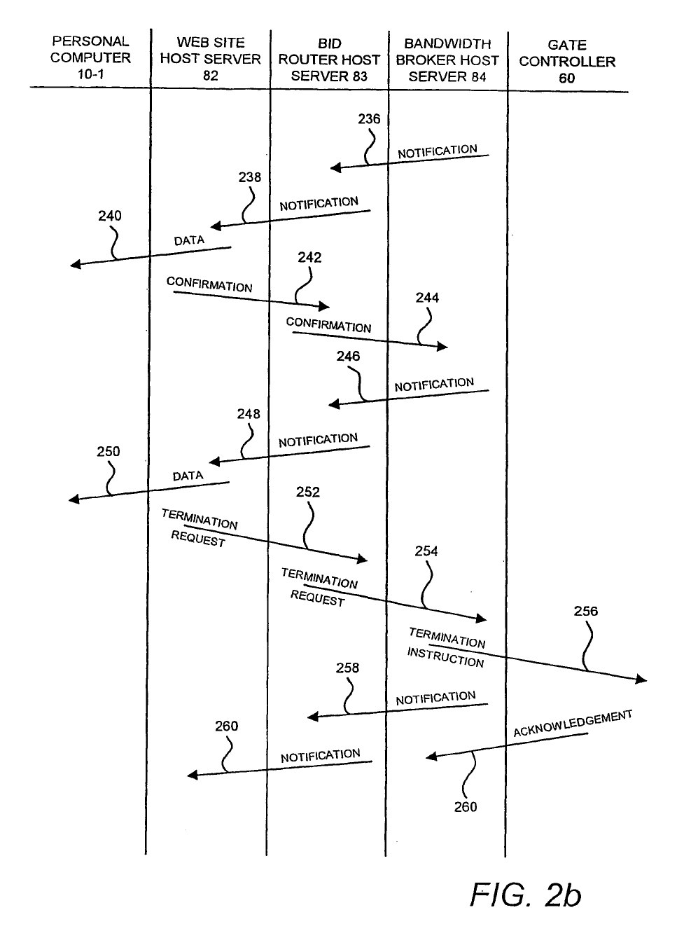

FIG. 2a shows part of a flow diagram illustrating data flow between the computer terminals shown in FIG. 1 during and after a bidding operation for bandwidth over the constraining data link;

FIG. 2b shows the remaining part of the flow diagram illustrated in FIG. 2a;

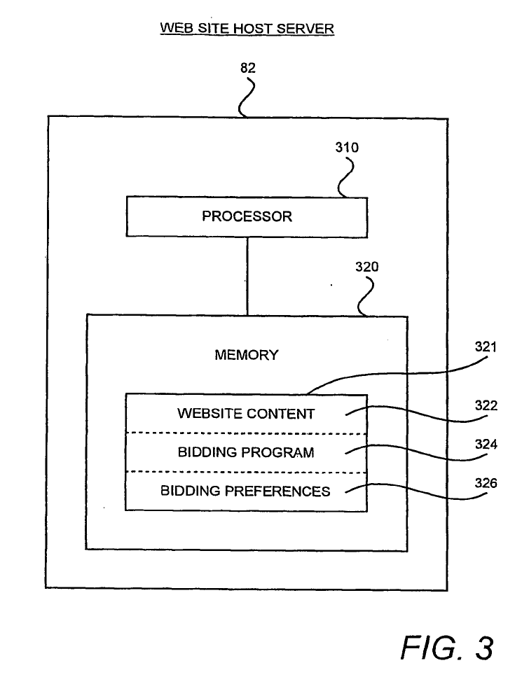

FIG. 3 is a block diagram illustrating the main components of a web site host server forming part of the computer network shown in FIG. 1;

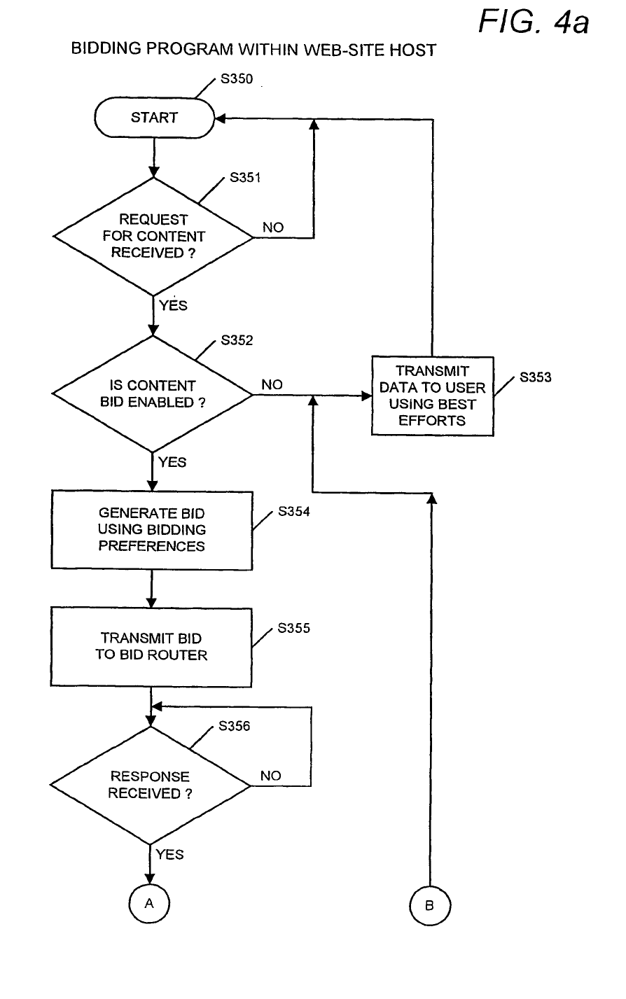

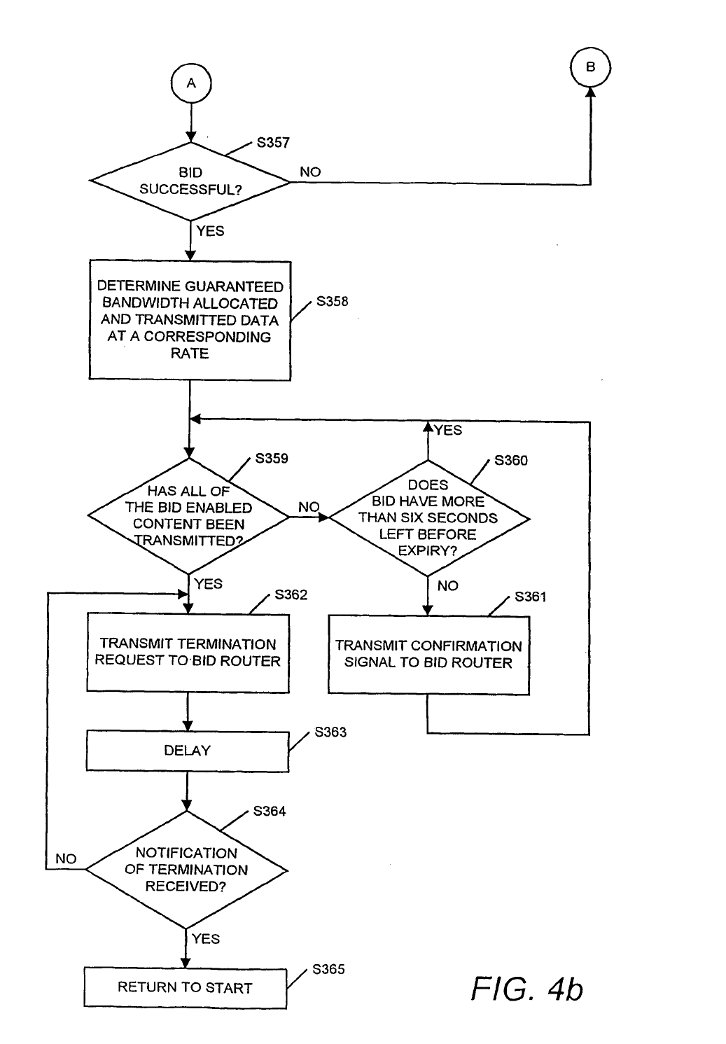

FIG. 4a is a flow diagram illustrating part of the flow control of a bidding program which forms part of the web site host server shown in FIG. 3;

FIG. 4b is a flow diagram illustrating the remaining flow control of the bidding program;

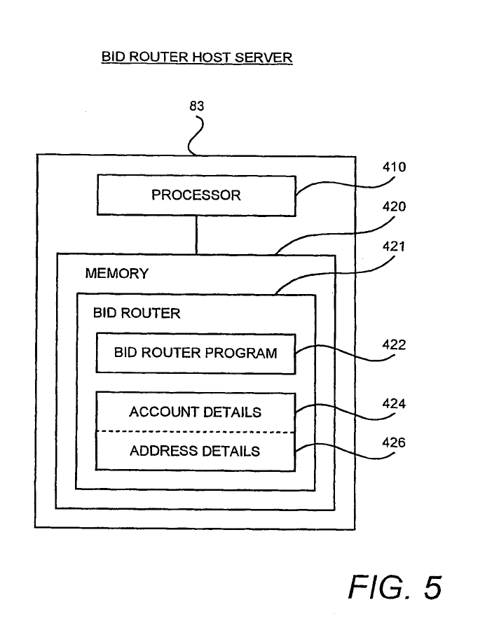

FIG. 5 is a schematic diagram illustrating the main components of a bid router host server;

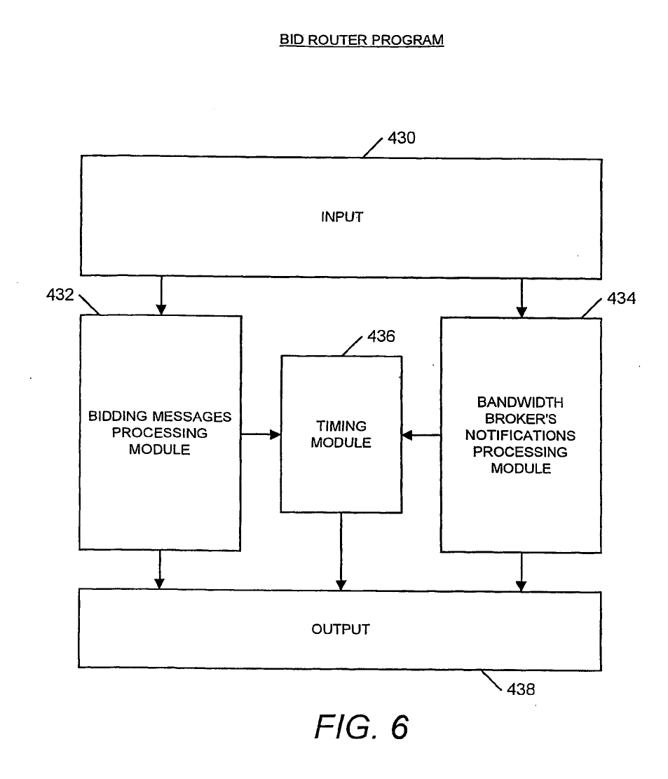

FIG. 6 is a block diagram illustrating the principal components of a bid router program forming part of the bid router host server;

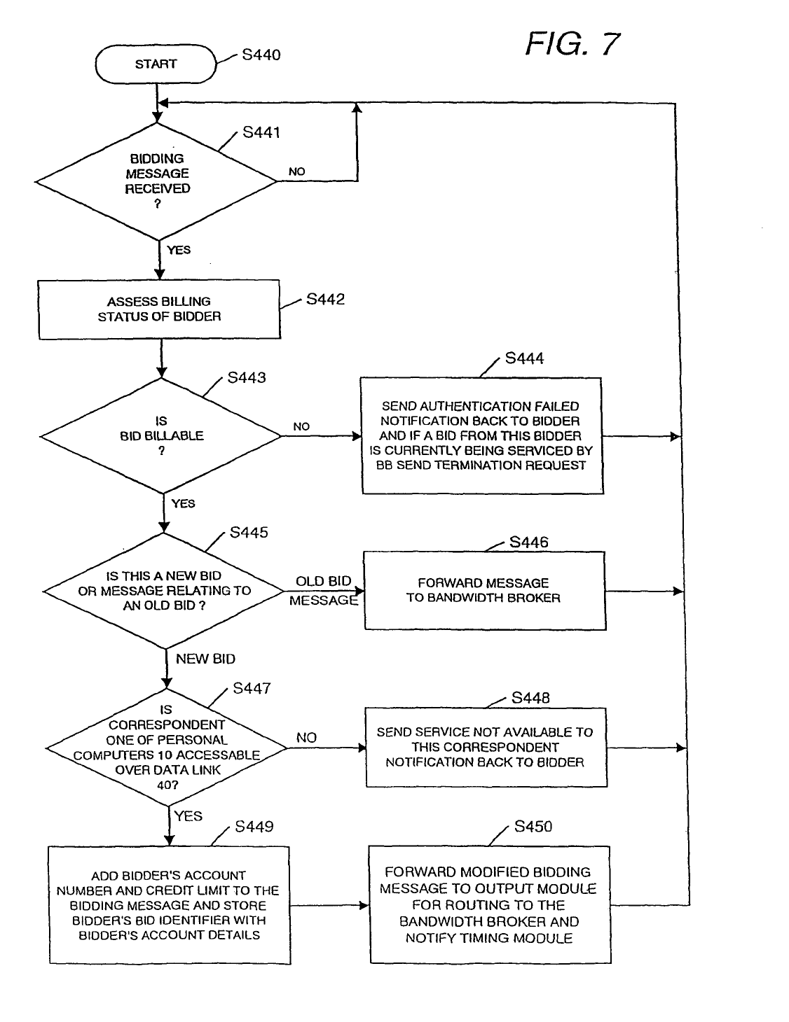

FIG. 7 is a flow diagram illustrating the flow control of a bidding messages processing module which forms part of the bid router program shown in FIG. 6;

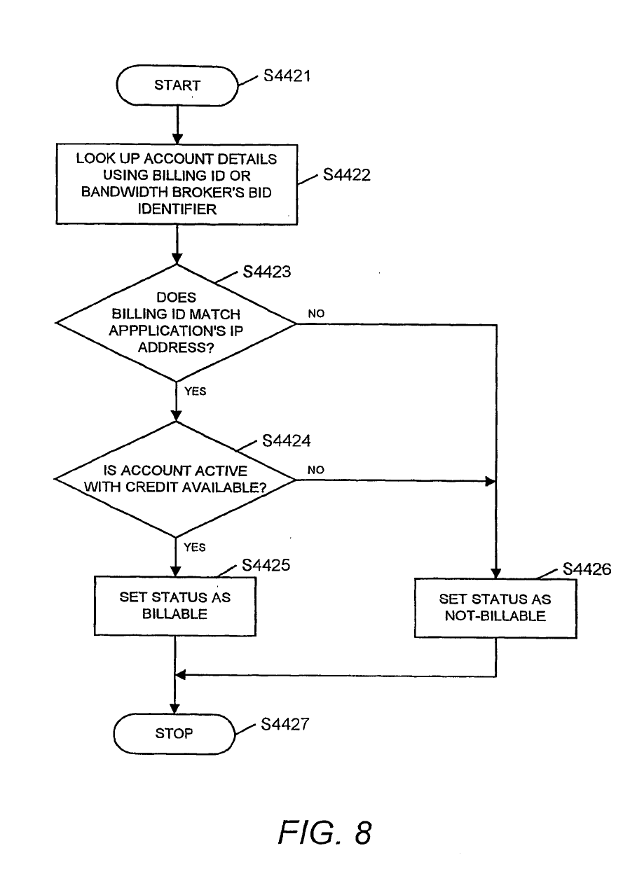

FIG. 8 is a flow chart illustrating the processing steps involved in the assessing of the billing status of a bidder which forms part of the process steps illustrated in FIG. 7;

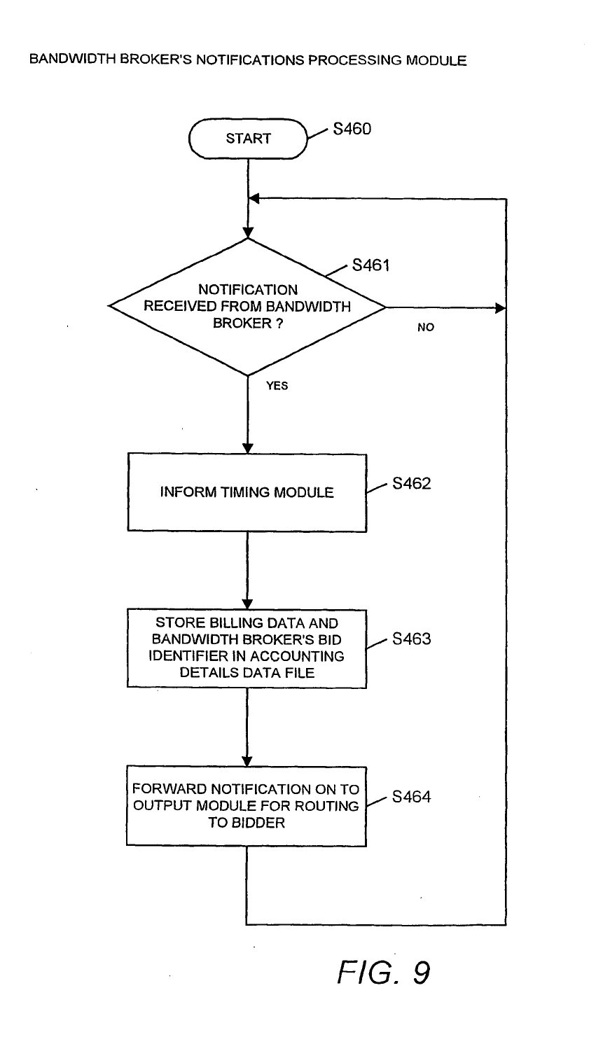

FIG. 9 is a flow chart illustrating the processing steps of a bandwidth broker's notifications processing module forming part of the bid router program illustrated in FIG. 6;

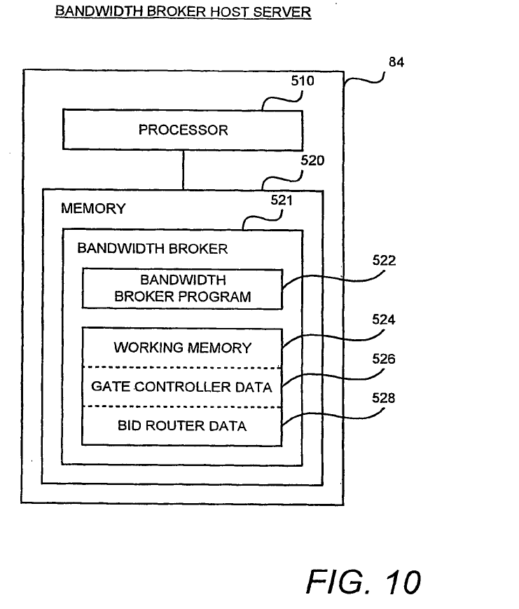

FIG. 10 is a schematic diagram illustrating the main components of a bandwidth broker host server;

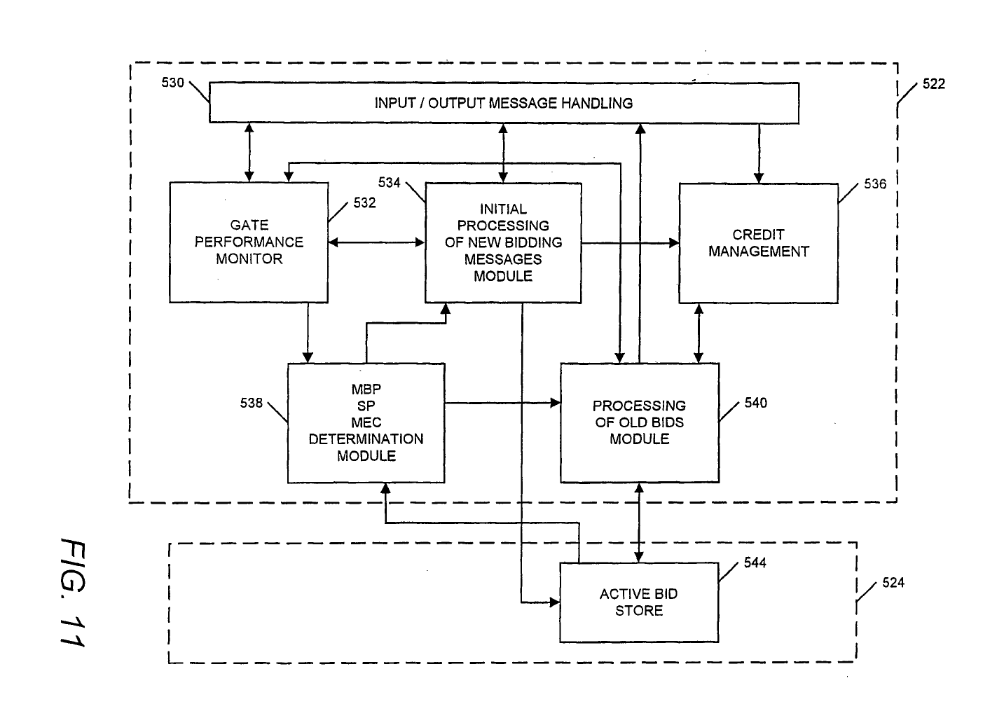

FIG. 11 is a block diagram illustrating the principal components of a bandwidth broker program forming part of the bandwidth broker host server illustrated in FIG. 10;

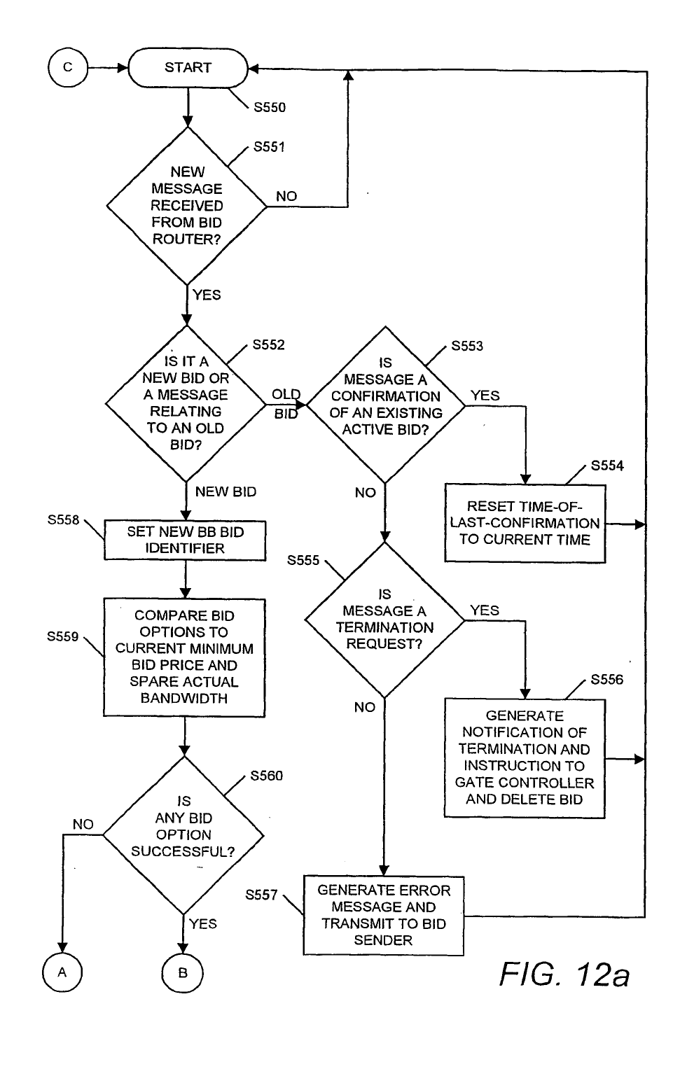

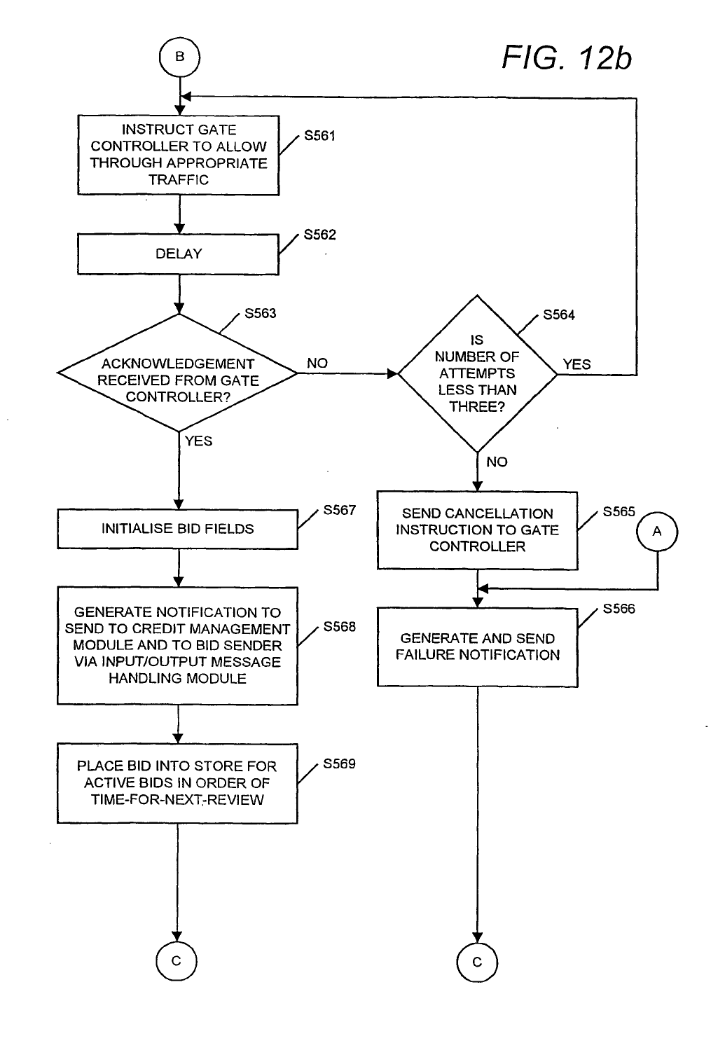

FIG. 12a is flow chart illustrating part of the processing steps involved in an initial processing of new bidding messages module which forms part of the bandwidth broker shown in FIG. 11;

FIG. 12b is a flow diagram illustrating the remaining processing steps of the initial processing of new bidding messages module;

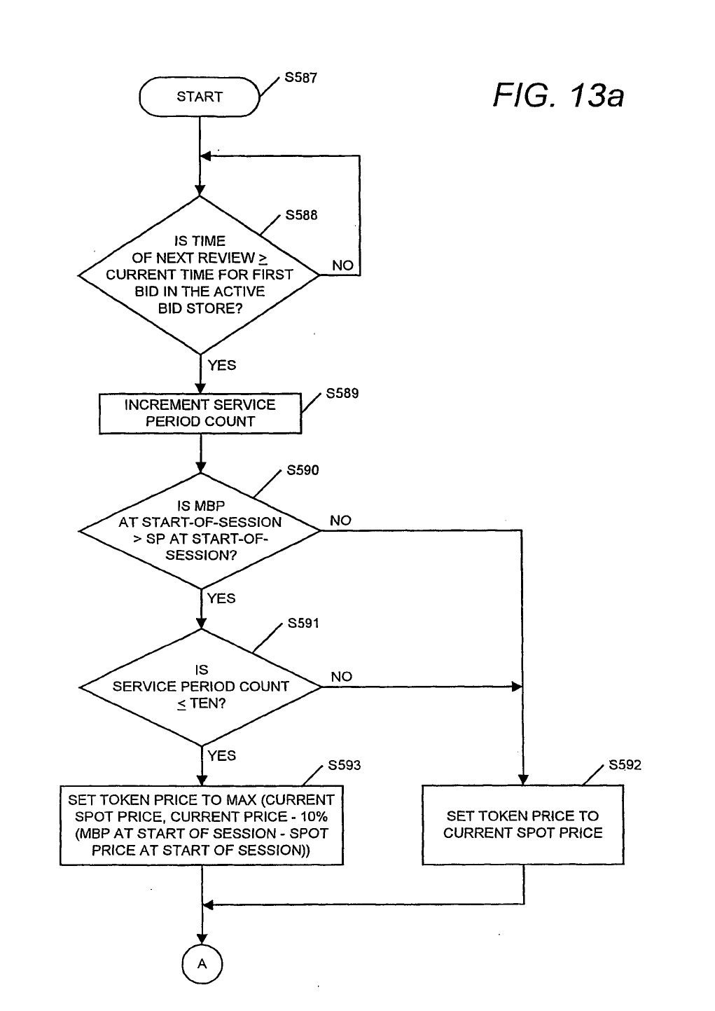

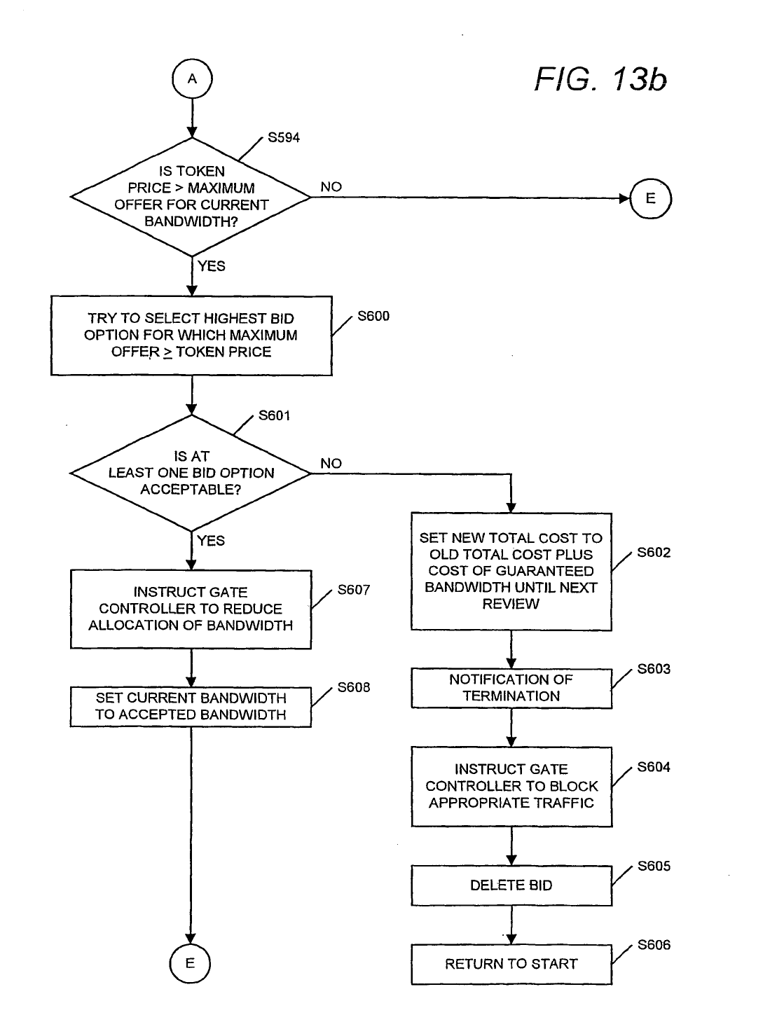

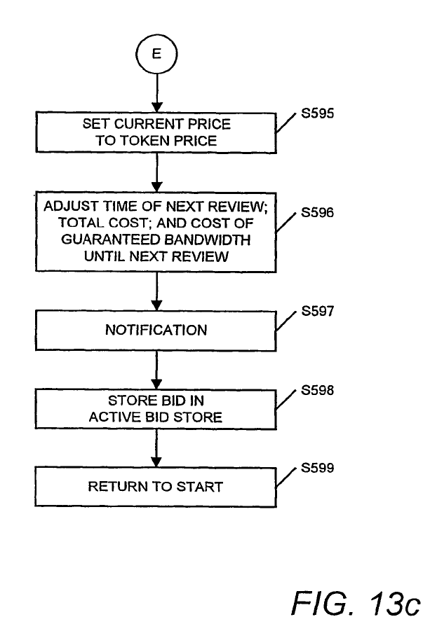

FIG. 13a is a flow diagram illustrating part of the processing steps involved in a processing of old bids module which forms part of the bandwidth broker illustrated in FIG. 11;

FIG. 13b is a flow diagram illustrating another part of the processing steps involved in the processing of old bids module;

FIG. 13c is a flow diagram illustrating the remaining processing steps involved in the processing of old bids module;

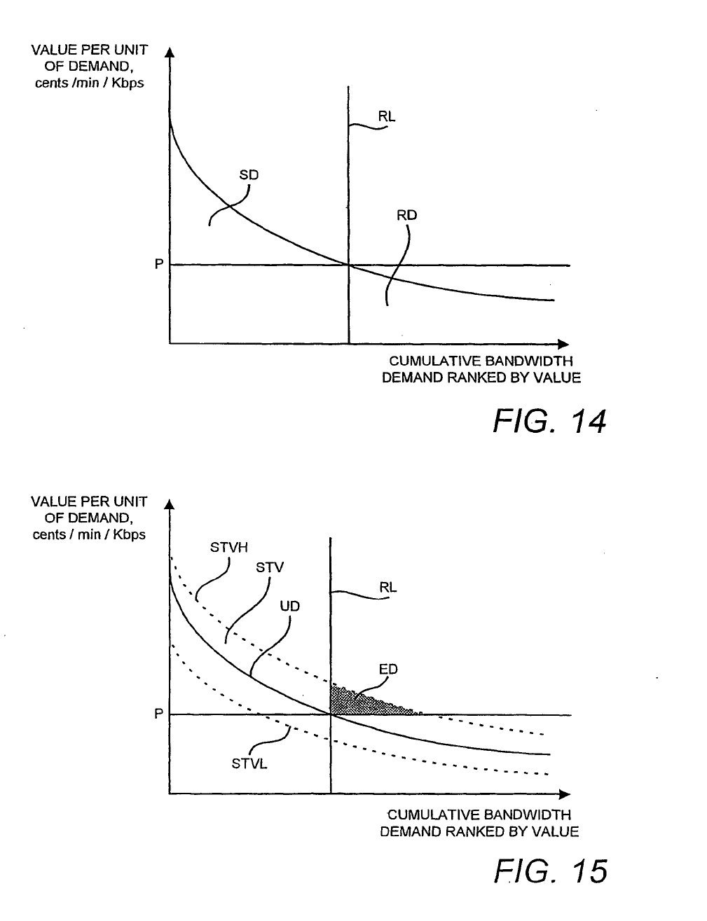

FIG. 14 is a plot illustrating the way in which the value per unit of demand affects the demand;

FIG. 15 is a plot illustrating the way in which the value per unit of demand fluctuates about an underlying demand;

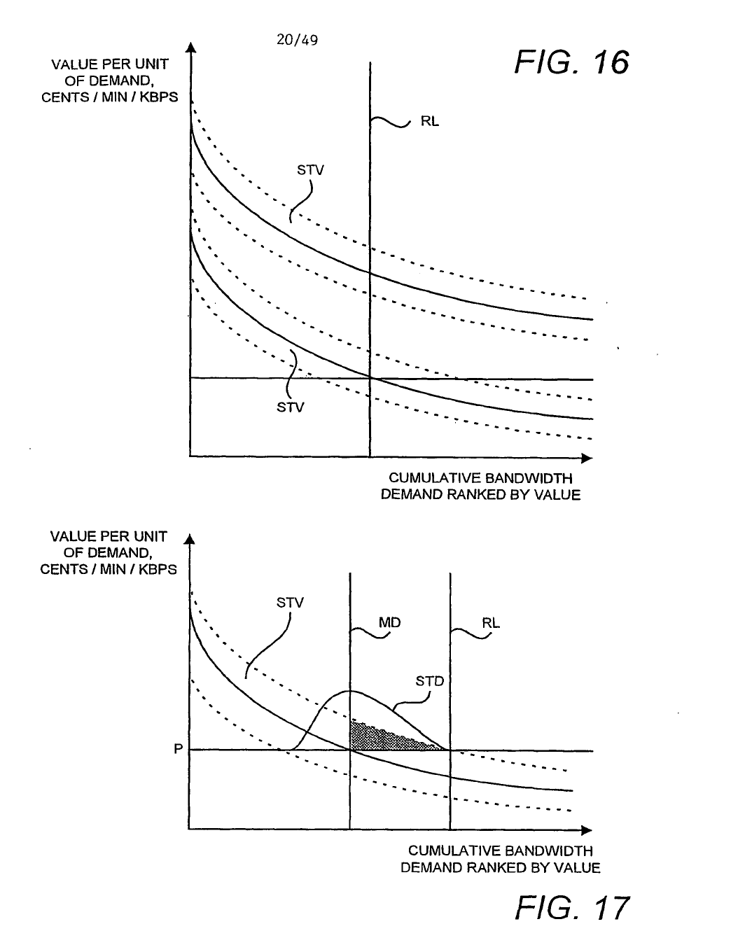

FIG. 16 is a plot illustrating the way in which the value per unit of demand can change as a result of a change in the underlying demand without any change in the short term variability;

FIG. 17 is a plot illustrating the way in which the instantaneous demand at a fixed price varies about a mean demand with a normal probability distribution;

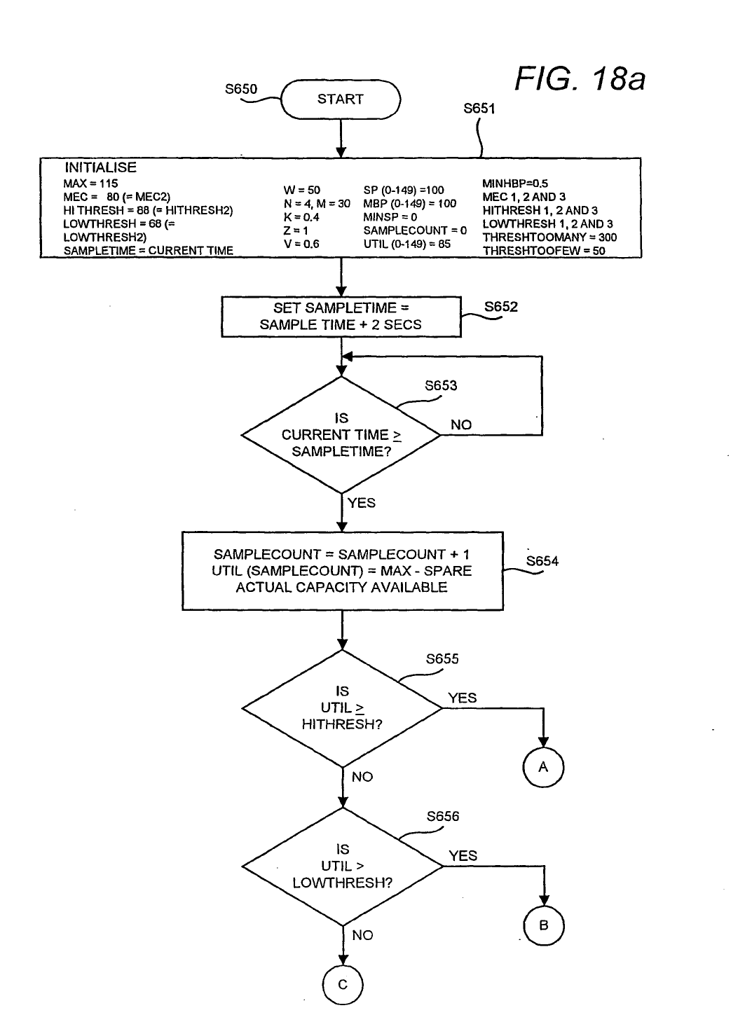

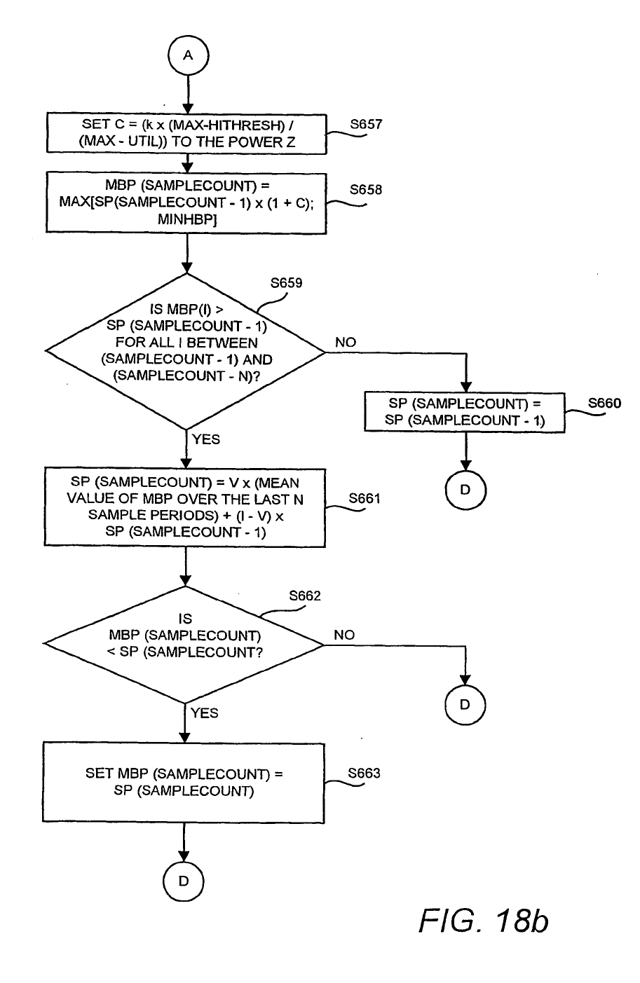

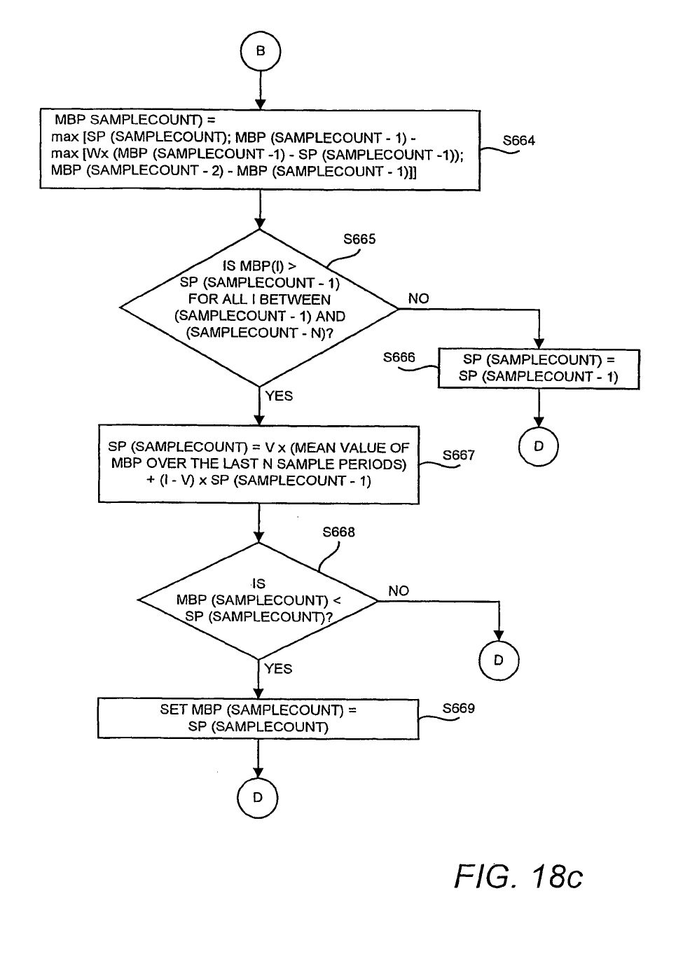

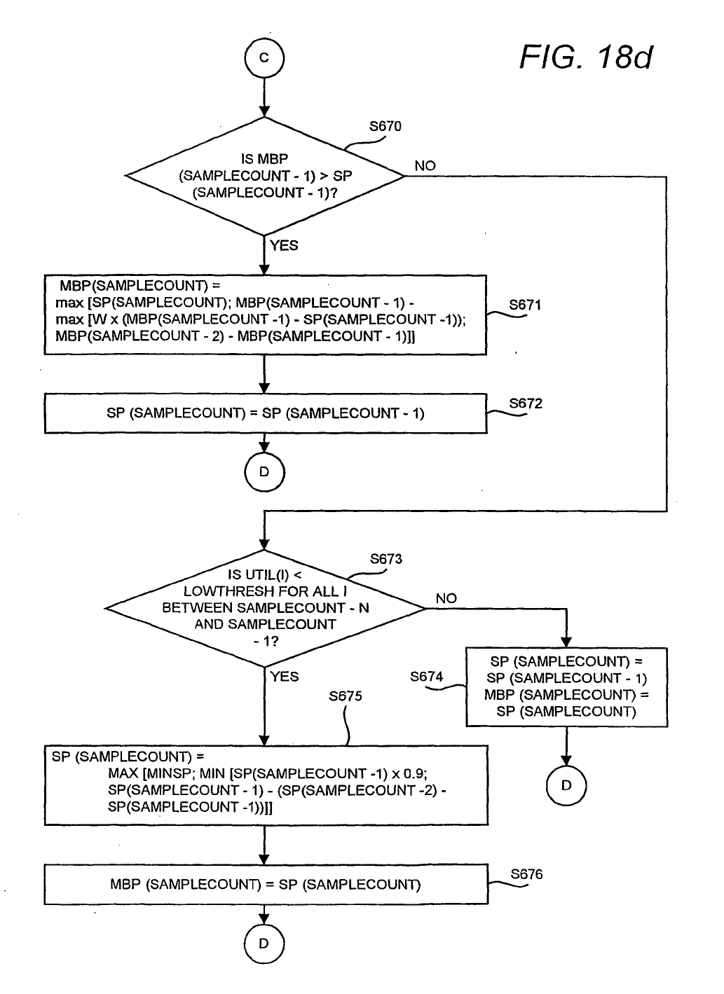

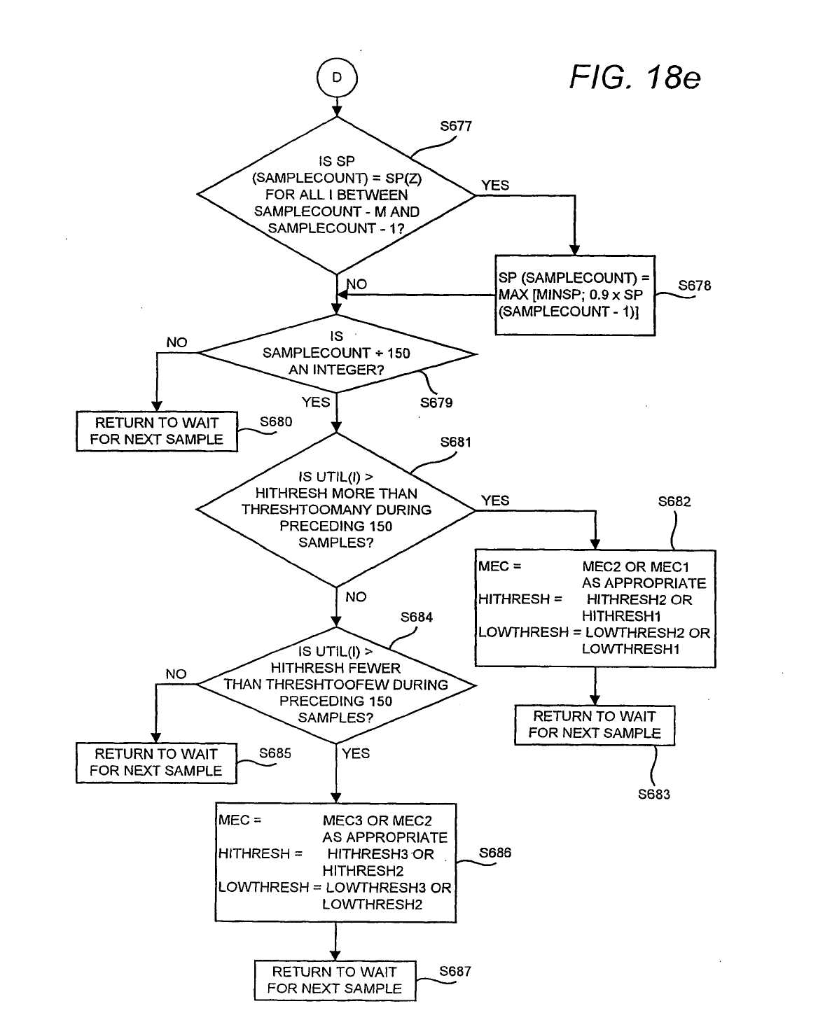

FIG. 18a is a flow diagram illustrating part of the processing steps involved in a MBP, SP, MEC determination module which form part of the bandwidth broker shown in FIG. 11;

FIG. 18b is a flow diagram illustrating another part of the processing steps employed by the MBP, SP, MEC determination module;

FIG. 18c is a flow diagram illustrating another part of the processing steps employed by the MBP, SP, MEC, determination module;

FIG. 18d is a flow diagram illustrating another part of the processing steps employed by the MBP, SP, MEC, determination module;

FIG. 18e is a flow diagram illustrating the remaining processing steps employed by the MBP, SP, MEC, determination module;

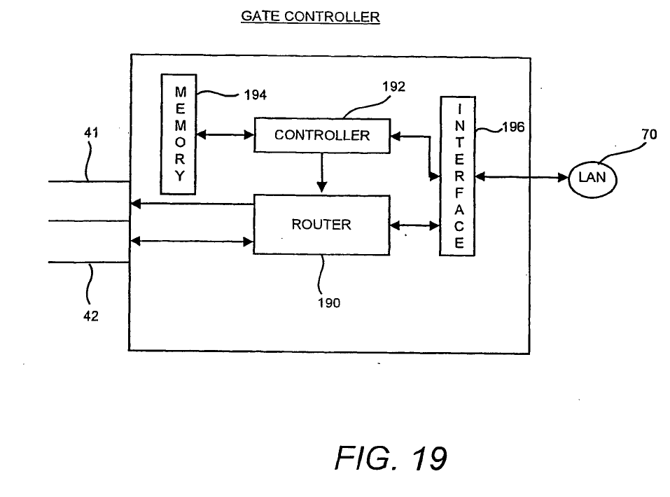

FIG. 19 is a block diagram illustrating the main components of a gate controller forming part of the computer network shown in FIG. 1;

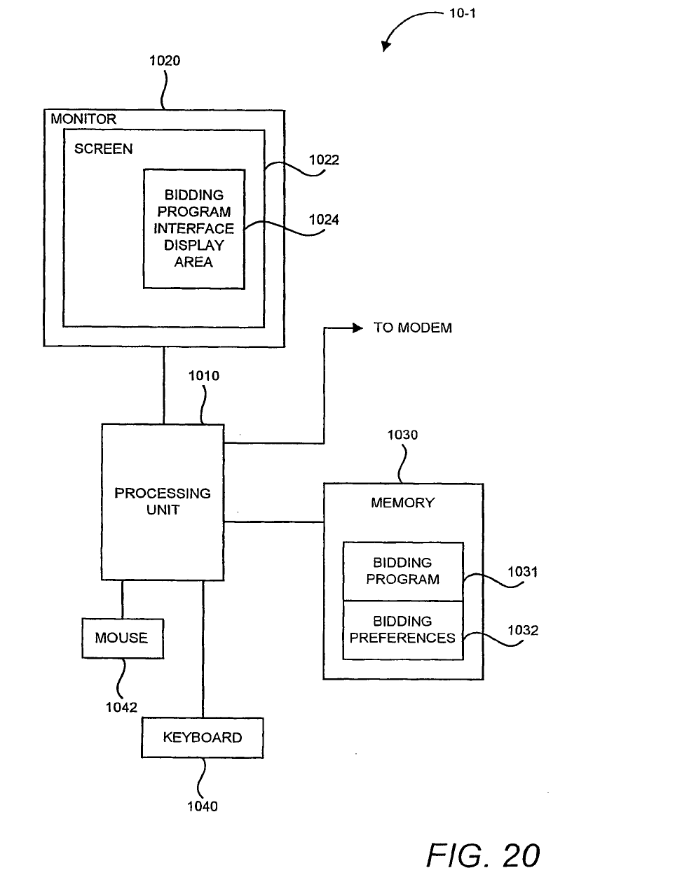

FIG. 20 is a block diagram showing the main components of a personal computer forming part of the computer network illustrated in FIG. 1;

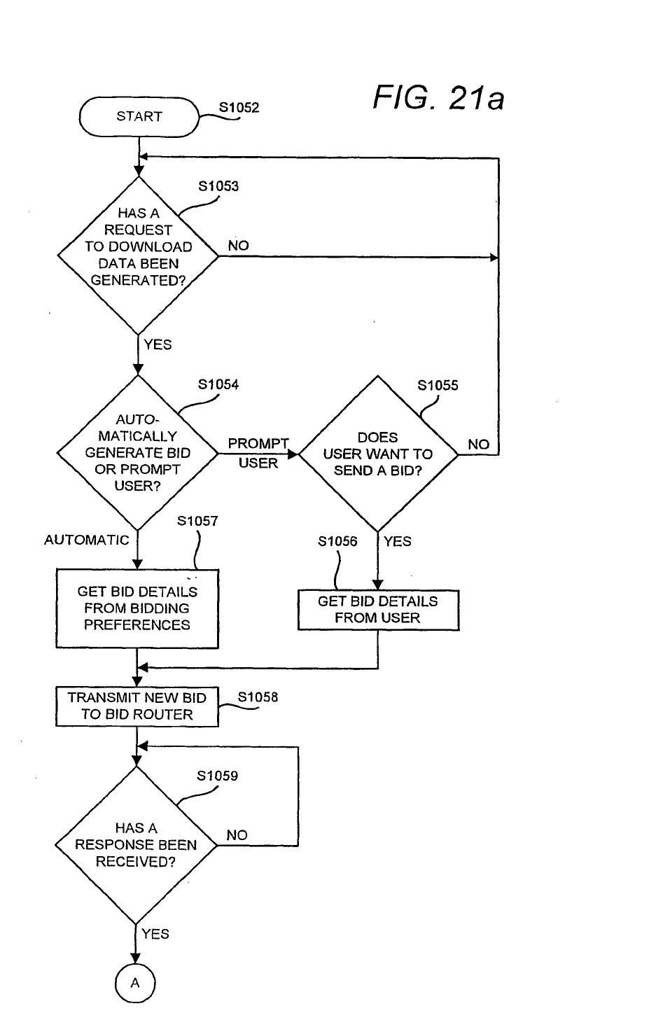

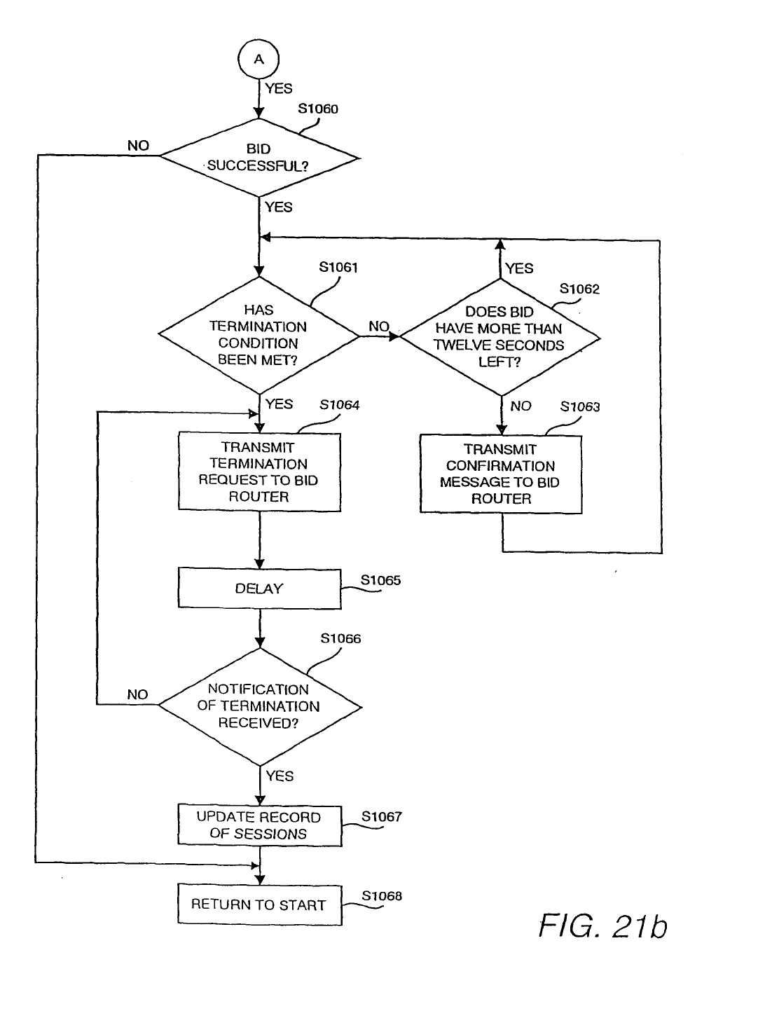

FIG. 21a is a flow diagram illustrating part of the processing steps formed by the personal computer illustrated in FIG. 20;

FIG. 21b is a flow diagram illustrating the remaining processing steps performed by the personal computer illustrated in FIG. 20;

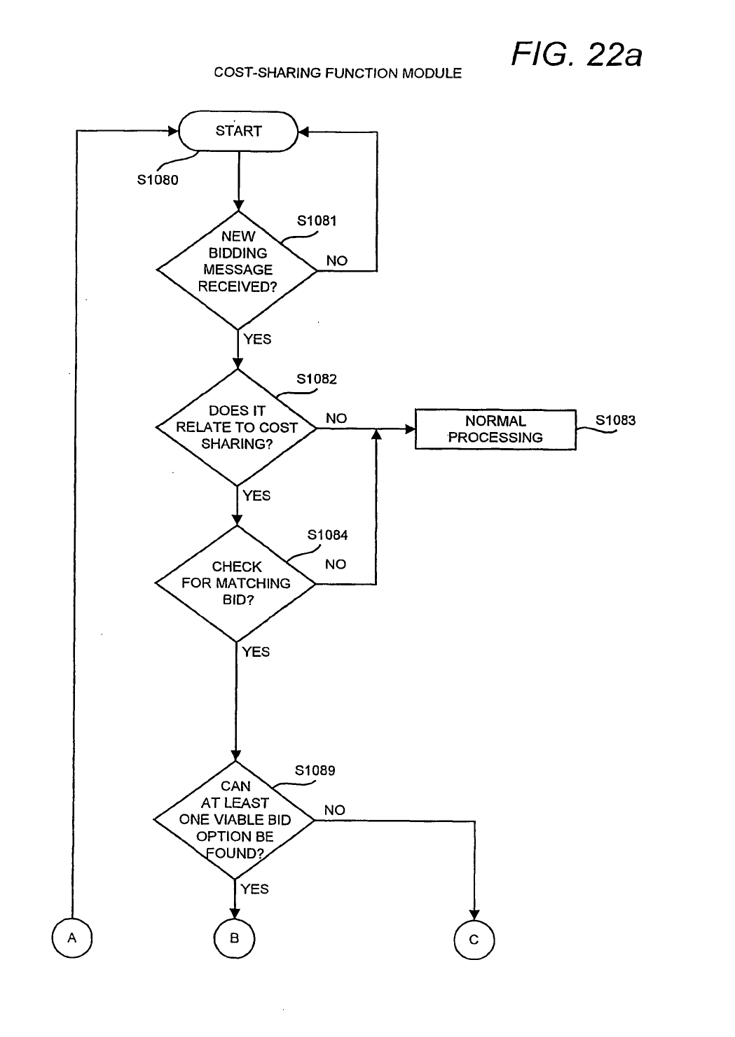

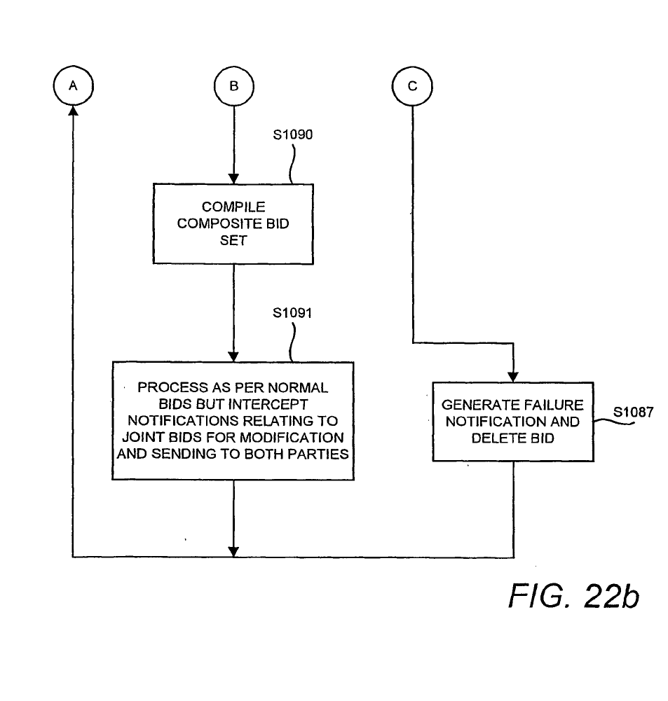

FIG. 22a is a flow diagram illustrating part of the processing steps performed by a cost-sharing function module;

FIG. 22b is a flow diagram illustrating the remaining processing steps employed by the cost-sharing function module;

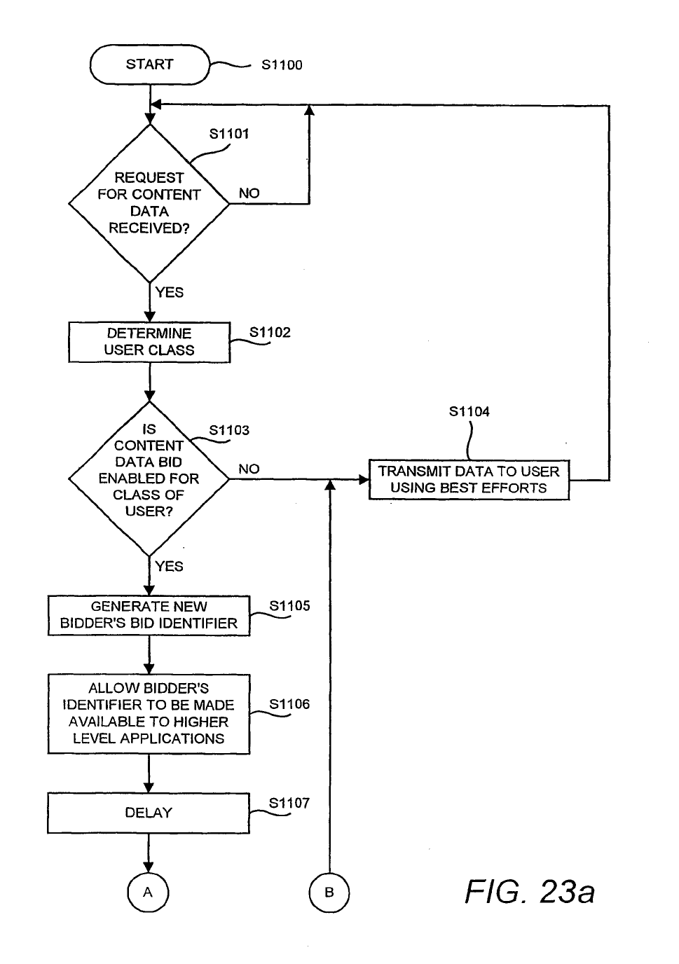

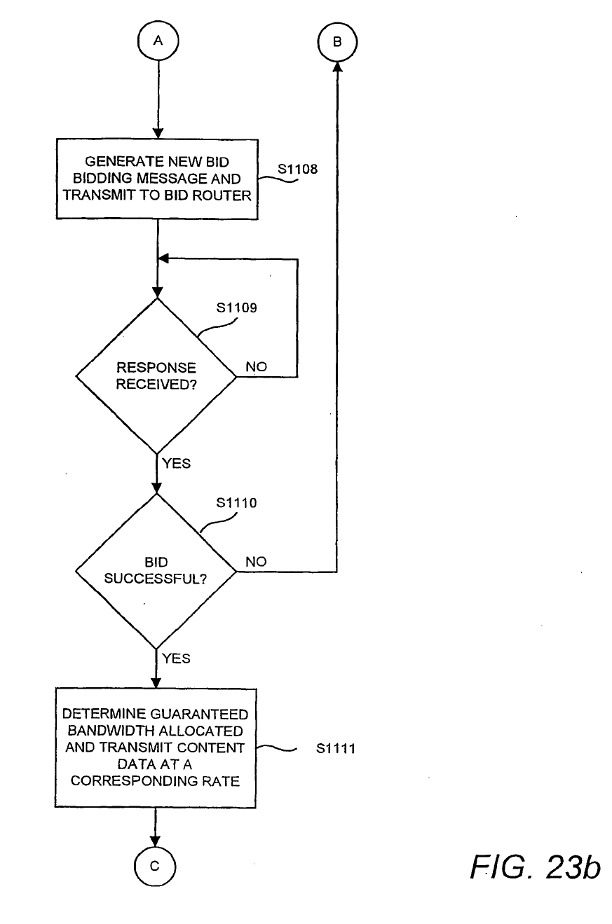

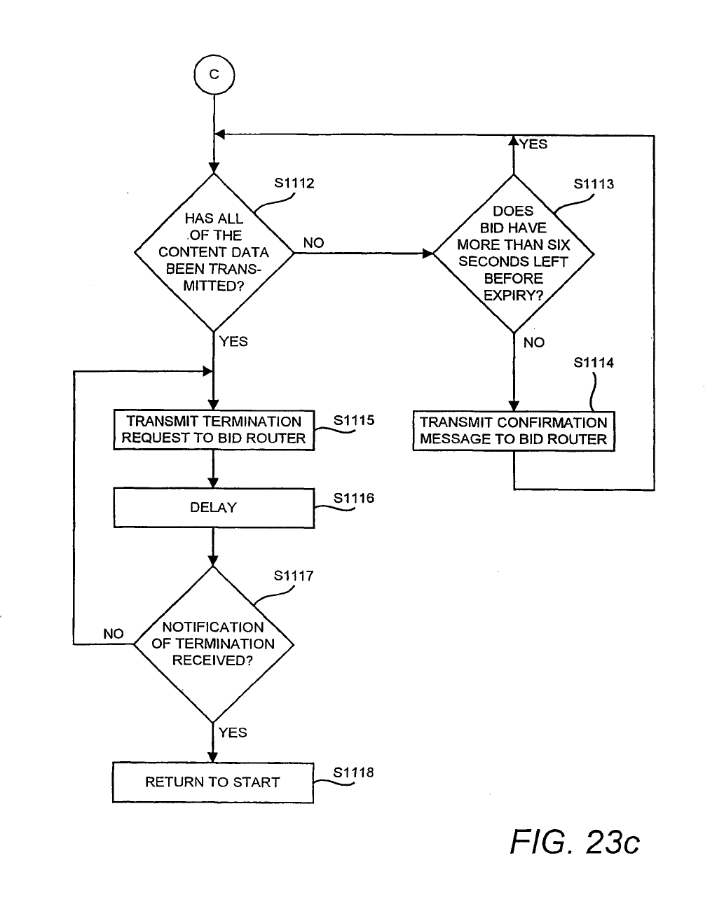

FIG. 23a is a flow diagram illustrating the processing steps performed by a web site host server;

FIG. 23b is a flow diagram illustrating another part of the processing steps employed by the web site host server;

FIG. 23c is a flow diagram illustrating the remaining parts of the processing steps employed by the web site host server;

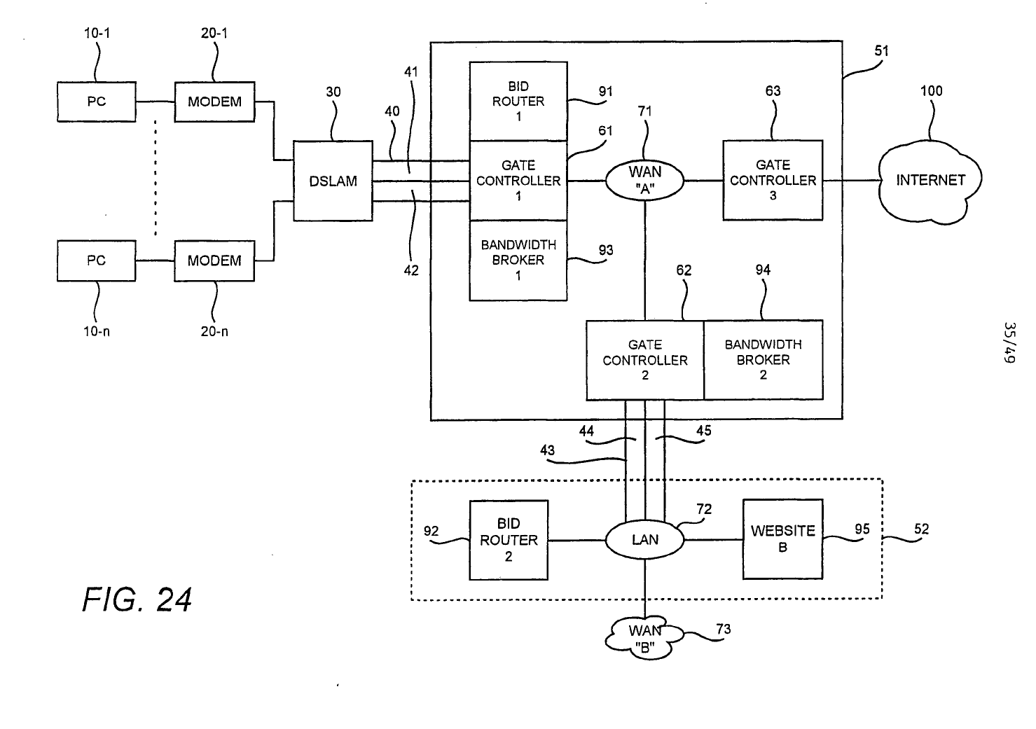

FIG. 24 is a schematic diagram of a computer network comprising a number of computer terminals which communicate with each other via two constraining data links;

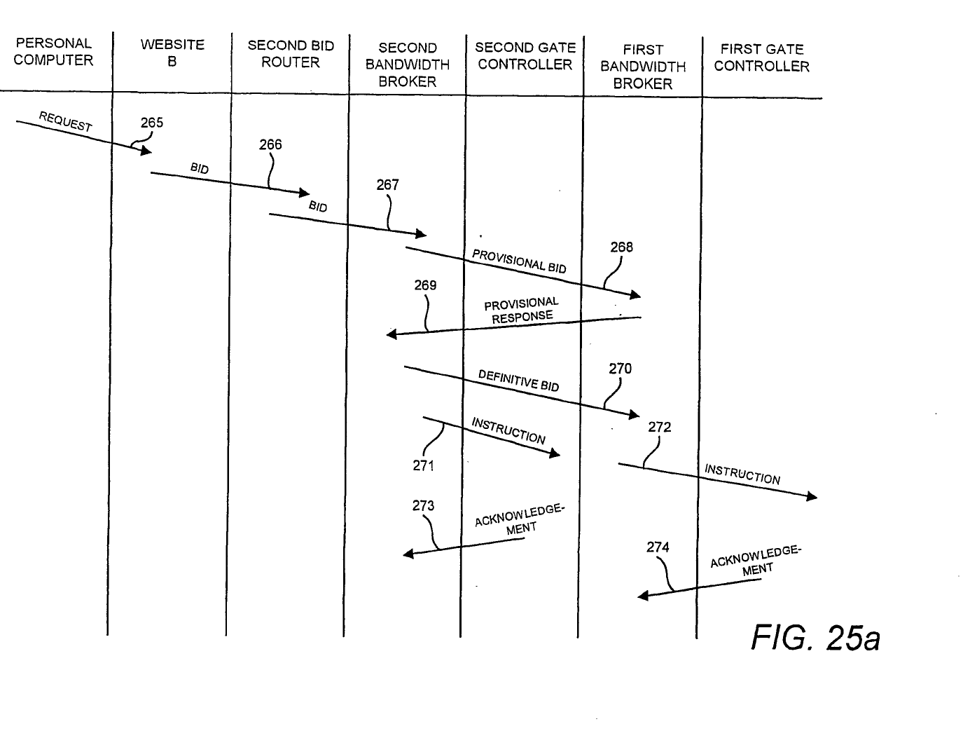

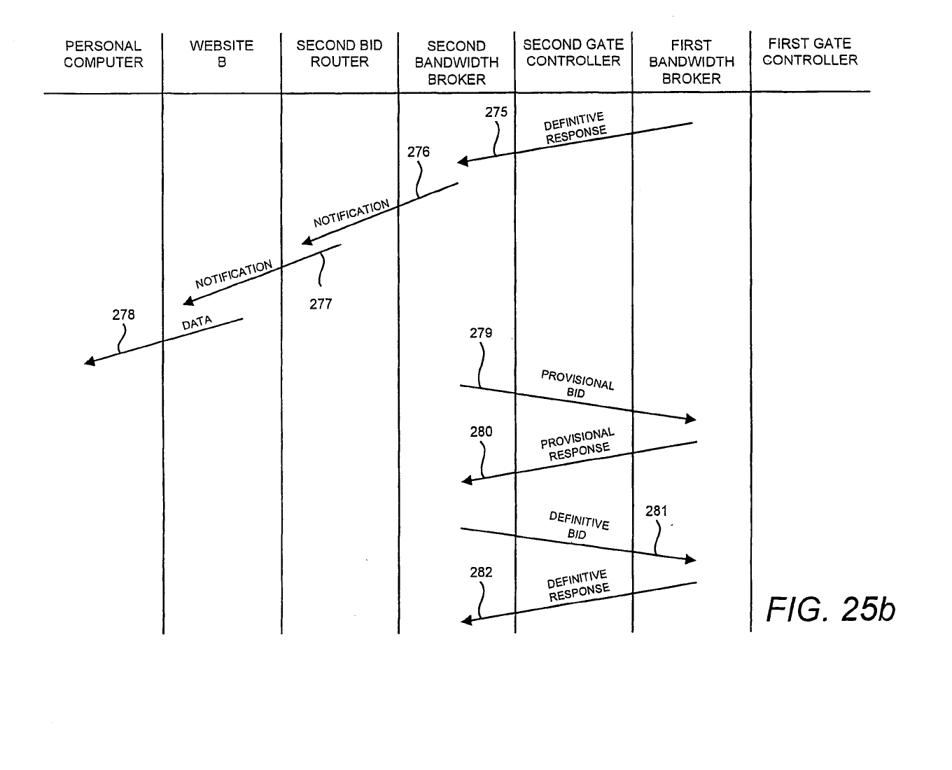

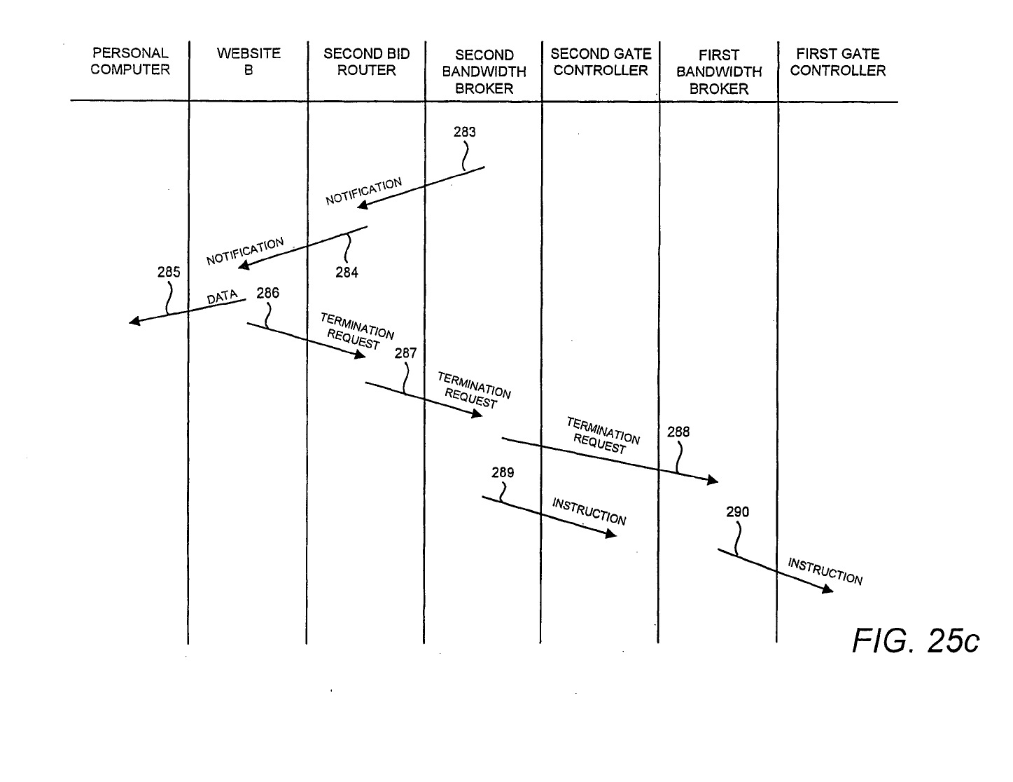

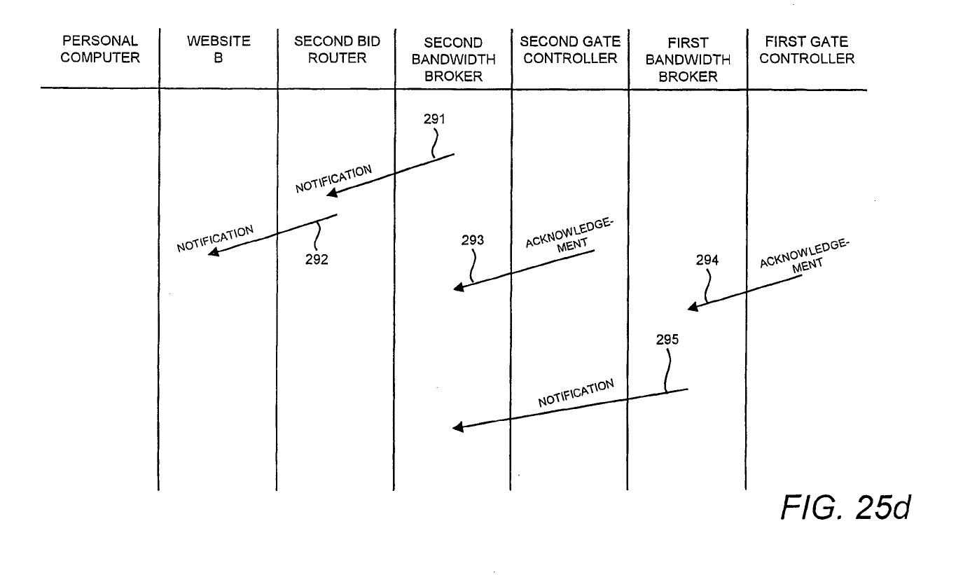

FIG. 25a shows part of a flow diagram illustrating data flow between the computer terminals shown in FIG. 24 during and after a bidding operation for band width over the constraining data links;

FIG. 25b shows a further part of the flow diagram illustrated in FIG. 25a;

FIG. 25c shows a further part of the flow diagram illustrated in FIG. 25a;

FIG. 25d shows the remaining part of the flow diagram illustrated in FIG. 25a;

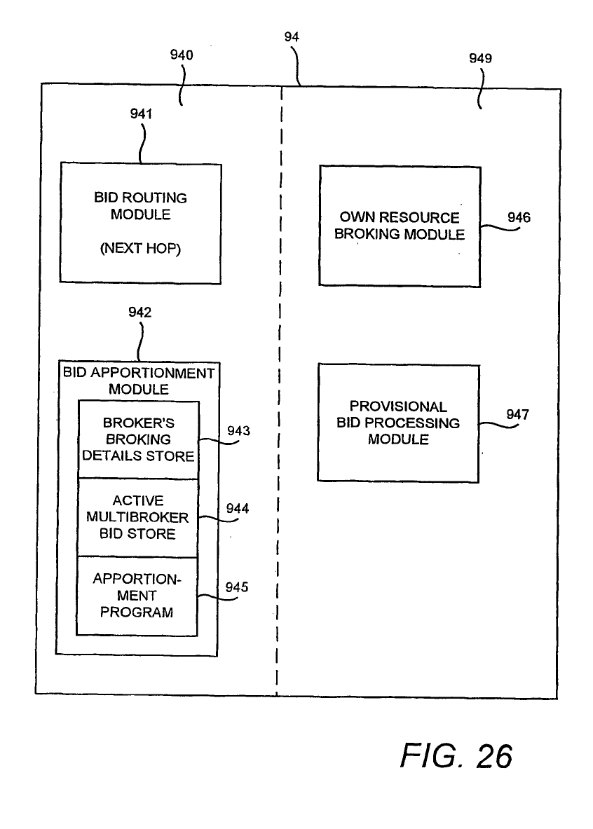

FIG. 26 is a block diagram illustrating the principal components of a bandwidth broker forming part of the computer network of FIG. 25;

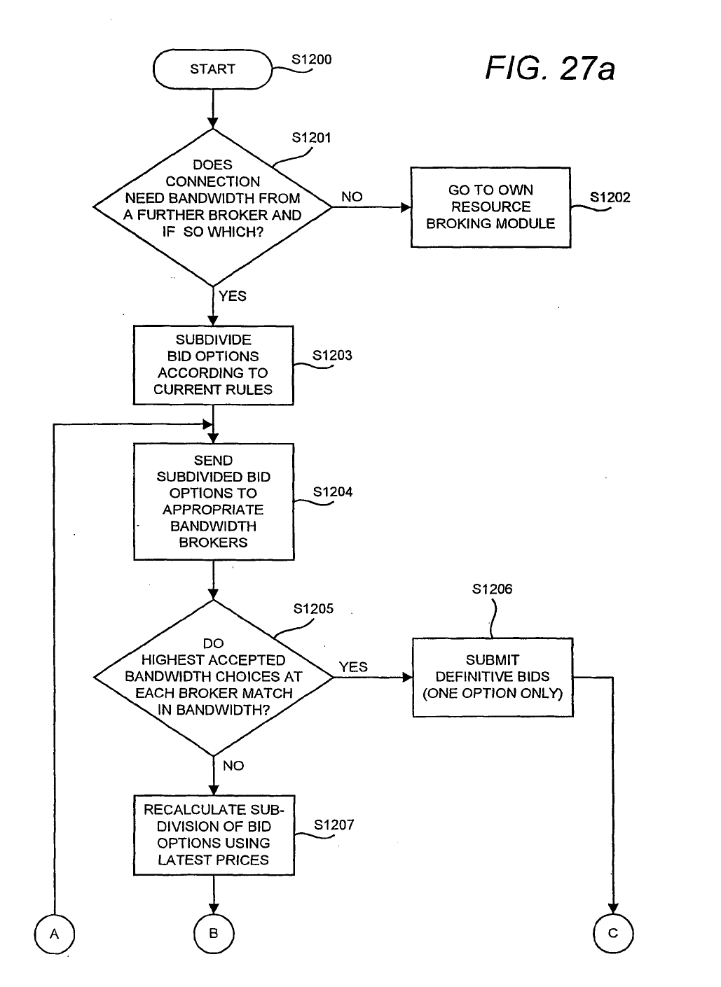

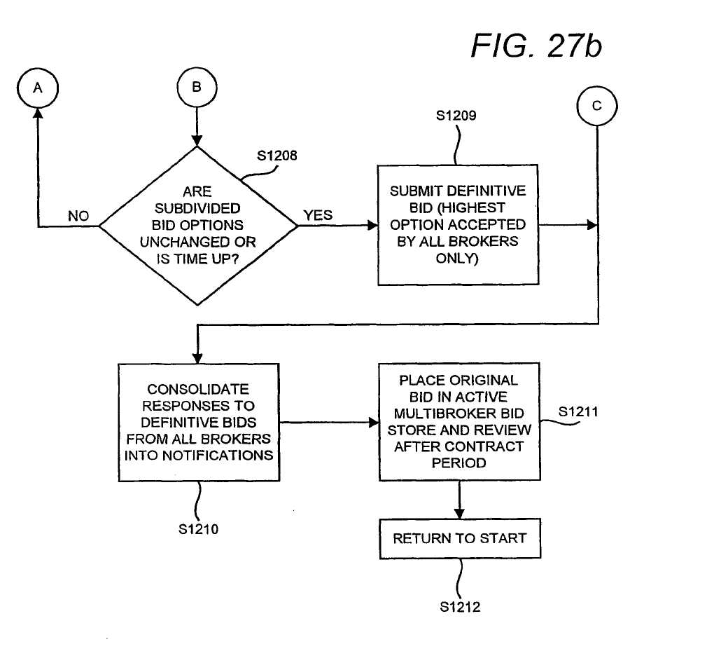

FIG. 27a is a flow diagram illustrating part of the processing steps performed by an apportionment program forming part of the bandwidth broker of FIG. 26;

FIG. 27b is a flow diagram illustrating the remaining processing steps employed by the apportionment program;

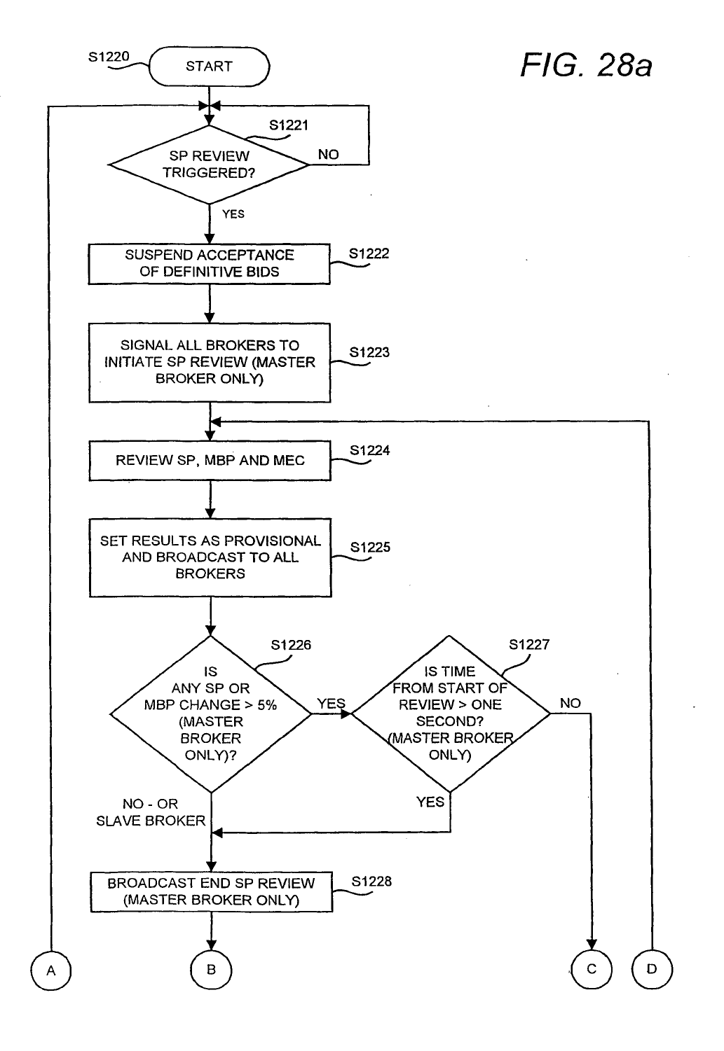

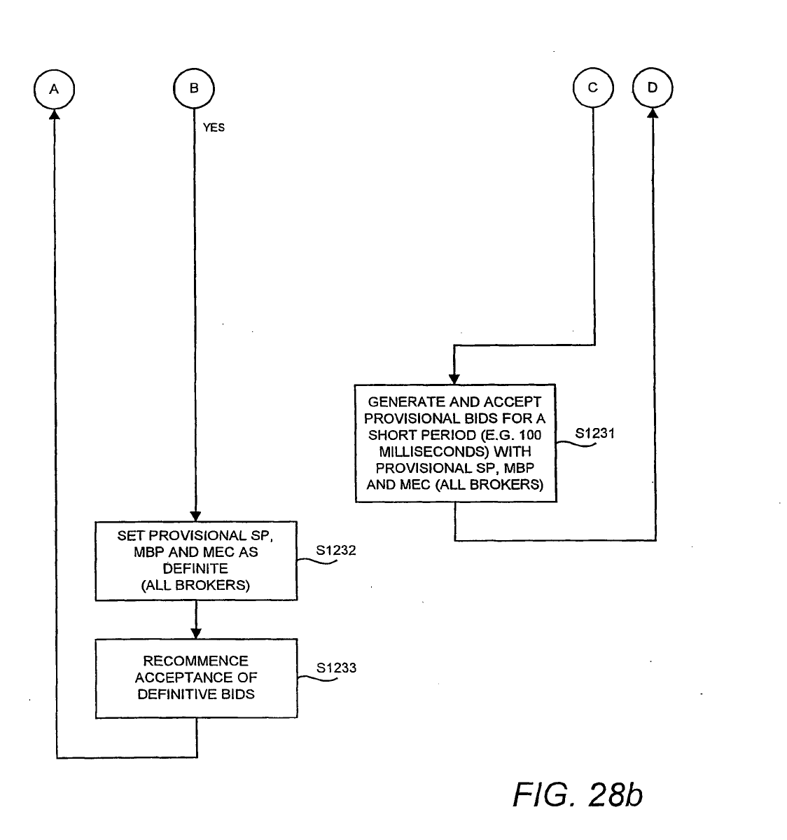

FIG. 28a is a flow diagram illustrating the processing steps for determining when bandwidth brokers which are components of the computer network shown in FIG. 25 should perform an SP and MBP review;

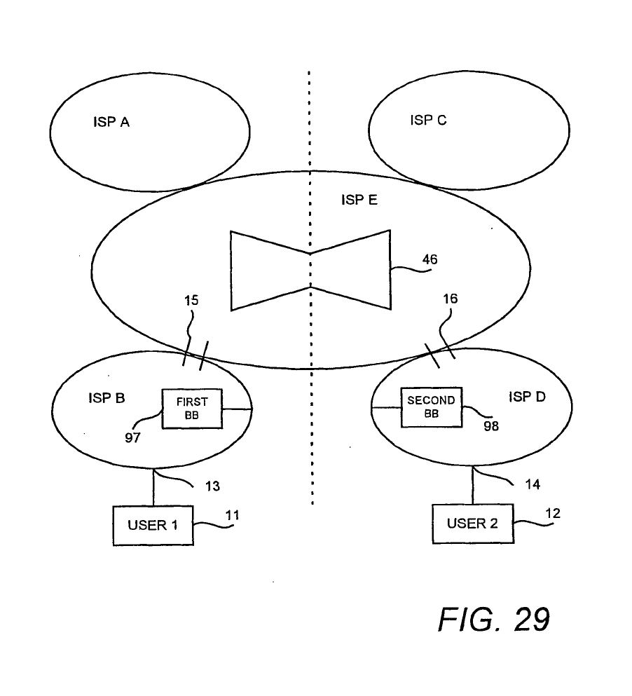

FIG. 28b is a flow diagram illustrating the remaining part of the flow diagram illustrated in FIG. 29a;

FIG. 29 is a schematic diagram of a computer network in which two computer terminals communicate with each other via a number of constraining data links and via three different domains;

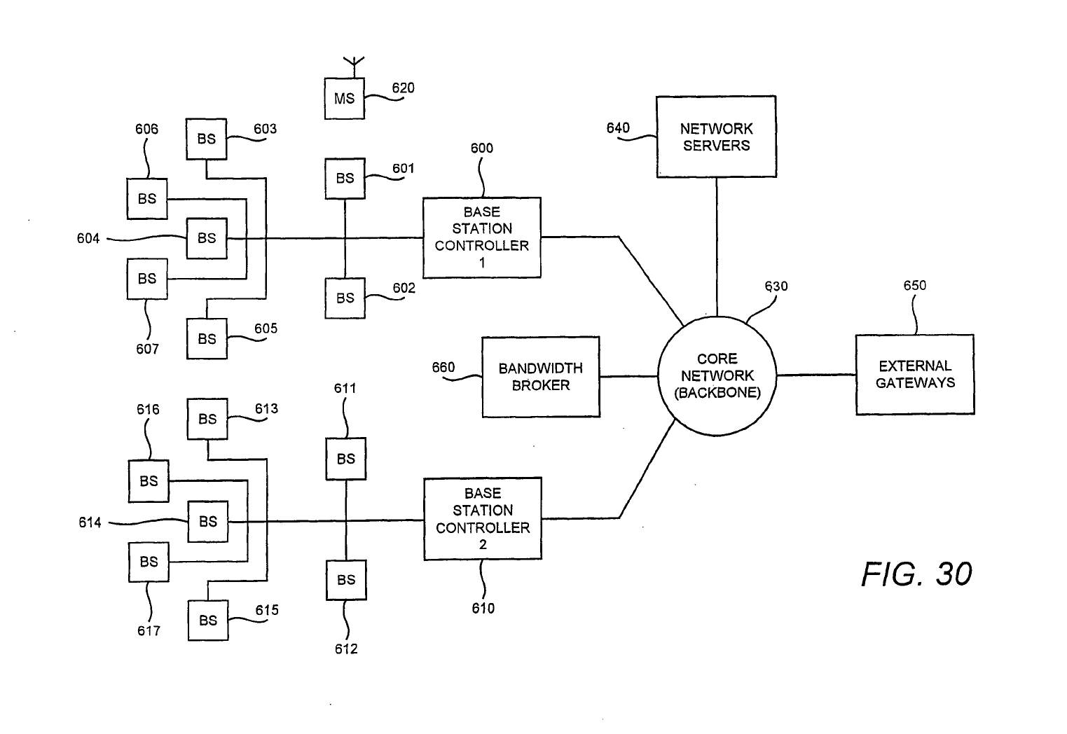

FIG. 30 is a schematic diagram illustrating a mobile telephone network;

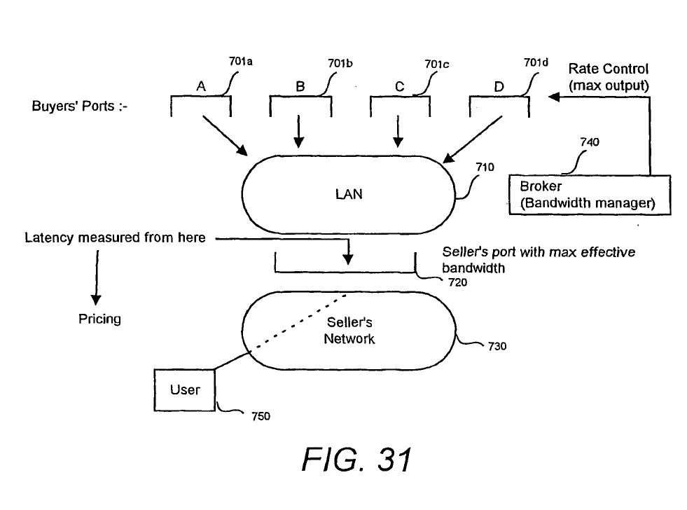

FIG. 31 is a schematic diagram of a network which is connected via a local area network to four potential buyers of service from the network, in which the network controls the cost of the use of the network to maintain the level of delay experienced by traffic passing through the network at or below some threshold maximum delay;

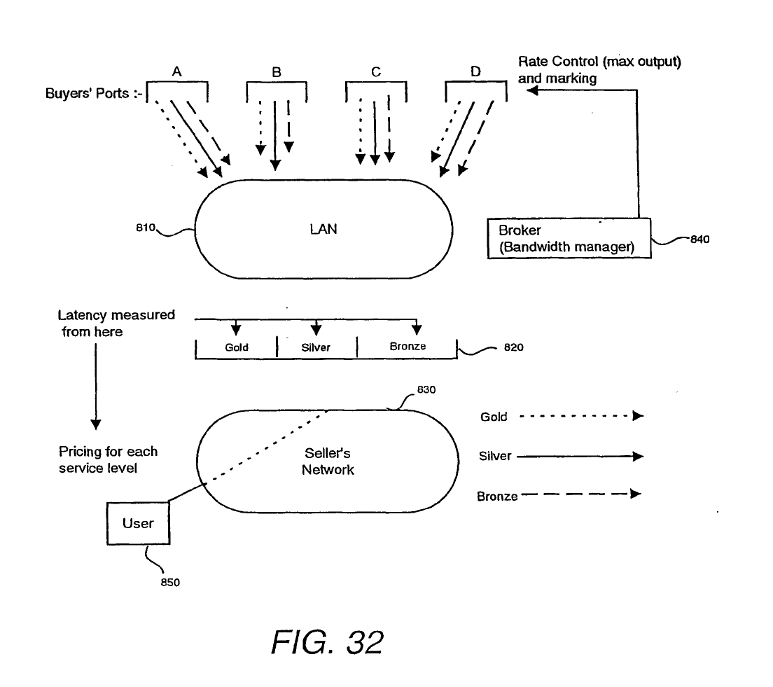

FIG. 32 is a schematic diagram of a network similar to that of FIG. 31 showing how more than one assured quality of service, service level may be provided by a network; and

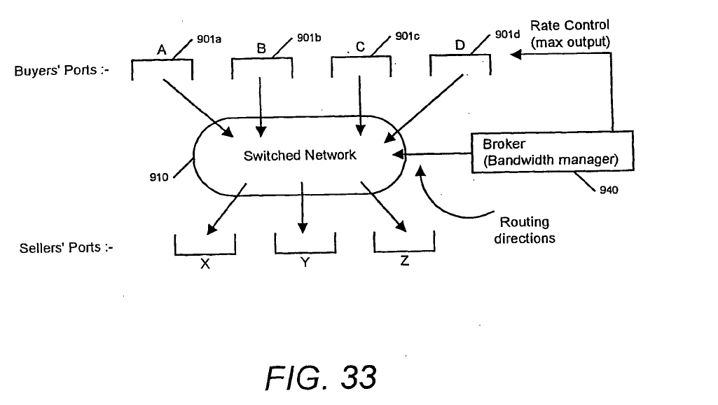

FIG. 33 is a schematic diagram of a network arrangement in which a plurality of networks are in direct competition with one another for carrying traffic for potential buyers of service from the networks.

### FIRST EMBODIMENT

Overview

The present embodiment is a data communications system in which a group of interconnected servers (hereinafter referred to as a server farm) is connected to a large number of personal computers across a data link having a constraint on the maximum rate of transmission of data (ie the maximum bandwidth) across the link. The data communication system permits a website application which is hosted on one of the servers within the server farm to bid for, and if successful to procure, a guaranteed allocation of bandwidth to any one of the personal computers. The bandwidth is allocated on a dynamic basis to permit the website application to transfer data to one of the personal computers for a limited duration using a receipt components and they will then be handled as separate transactions from then on. It is not possible to bid a value to be distributed between transmissions and receipt options, or a value for one that is conditional on the other. The valuations of transmissions and receipts must be explicit and independent.

2 The Bid router authenticates the bid. This is performed using existing protocols of the implementer's choice, such as RADIUS.

3 The Bid router identifies the destination Bandwidth broker and verifies that it is selling bandwidth on demand to the correspondent. It does this by forwarding the bid to the next bandwidth broker along the route to the correspondent, together with billing instructions for the session. The latter will include the following options:

Non-authenticated user. Bandwidth broker to authenticate and bill

Authenticated user for third party billing system+account details

Authenticated user for bid router's billing services: account details including credit limit.

Bid Rejection, Acceptance, Validation, and Termination

4 In the case the bandwidth broker has no bidding service for the connection, it returns a “No Service” message. In this case, or in the case that the Bid router finds no Bandwidth broker associated with the connection, it advises the application that no BOD service is available to that correspondent via a similar “No Service” message.

5 The result of the bid is either that no bid option was accepted, or that the bandwidth broker accepted one of them. There is a limit to the time that can be taken to accept or reject a bid. A bid that is not accepted within this time limit will be treated as rejected. The Bid router will monitor these time limits and will send a rejection message to the application in the case that the bandwidth broker has not sent one within the time limit. The rejection message will refer to the bid identifier and will include:

Rejection indicator for identified bid. The bid identifier will include the application's identifier as well as comprising a unique identifier for the broker.

Current minimum bid price for the connection route (if available)

Minimum time delay before rebidding (optional)

6 In the case of a bid acceptance, the bid router simply routes messages between the relevant bandwidth broker and the application and performs any protocol conversion (message reformatting) necessary. A Bid acceptance message will include:

Acceptance indicator for identified bid, including the QoS/bandwidth option which is being supplied

The server farm 50 comprises a plurality of host servers 81, 82, 83, 84, a gate controller 60, a general router 90 with an onwards connection to the Internet 100 and a local area network 70 which connects these components together. Server 81 is a general server which hosts a number of unspecified website applications. Server 82 is similar to server 81 except that it additionally hosts a website application which is hereinafter referred to as website application A; server 82 is hereinafter referred to as the website host server 82. Server 83 is similar to servers 81 and 82 except that it hosts a bid router program; thus, server 83 is hereinafter referred to as the bid router host server 83. Server 84 is similar to server 83 except that it hosts a bandwidth broker program; thus server 84 is hereinafter referred to as the bandwidth broker host server 84.

In the present embodiment, the guaranteed quality of service portion 41 of data link 40 is only used for data travelling from the gate controller 60 to DSLAM 30, whereas the best efforts portion 42 is used for carrying data travelling in both directions. Thus, when data is destined for one of the servers 81, 82, 83, 84, the gate controller 60 behaves as a conventional router device and routes the data directly to the destination host server. Otherwise, if the data is destined for an alternative device only contactable via the Internet 100, the gate controller 60 forwards the data onto router 90 which in turn routes the data to the Internet 100.

For data coming in the other direction (ie traffic destined for one of the personal computers 10), the gate controller 60 examines each block of data (hereinafter datagram) and determines whether each such examined datagram qualifies for transmission over the guaranteed quality of service portion 41 in which case it is routed over portion 41. If it does not qualify, then it is routed in a conventional manner over the best efforts portion 42.

Illustrative Example

FIG. 2 illustrates the signals which pass between various components of the data communications system 1 during an illustrative example in which website application A successfully bids for bandwidth within the guaranteed quality of service portion 41 and data is transferred from the website host server 82 to personal computer 10-1. In this example, a user of personal computer 10-1 is browsing website A hosted on website host server 82 and notices an option to download and view in realtime a new promotional audio video clip. The user selects to view the audio video clip and this causes personal computer 10-1 to generate a request signal 202 which is transmitted to the website host server 82. The route taken by the request signal 202 is via modem 20, DSLAM 30, the best efforts portion 42 of the data link 40, gate controller 60 and the local area network 70. On receipt of the request signal 202 website application A running on host server 82 processes the request and determines that the requested data should ideally be sent to the user of personal computer 10-1 at a relatively high data rate to give the user a high quality experience of the requested audio video clip. Website application A therefore generates a bid message 204 which indicates that it would like to purchase some bandwidth within the guaranteed quality of service portion 41 of the data link 40. In this example, the bid message sets out how much website application A is prepared to pay for three different quantities of bandwidth within portion 41. The bid message 204 is transferred over the local area network 70 to the bid router host server 83. When the bid router program running on the host server 83 receives the bid message 204 it establishes whether or not the website application A has an account which can be debited to pay for the cost of any bandwidth for which it successfully manages to bid. If this account exists, the bid router program modifies the bid message to include the amount of credit available within the account and forwards the modified bid message 206 on to the bandwidth broker host server 84 via the local area network 70.

On receipt of the modified bid message 206, the bandwidth broker processes it to determine if any of the prices offered in the bid message are high enough to warrant selling some bandwidth within portion 41 to website application A. In the present example in which the bid is successful, the bandwidth broker host server 84 issues an instruction signal 208 to the gate controller 60 via the local area network 70. The instruction signal 208 informs the gate controller 60 that datagrams issuing from website host server 82 and destined for personal computer 10-1 are to be transmitted over data link 40 via the guaranteed quality of service portion 41 for a fixed duration (which in the example is initially six seconds). The instruction signal 208 also informs the gate controller of the maximum amount of bandwidth within the guaranteed quality of service portion 41 which is to be set aside for the specified datagrams. Surplus specified datagrams arriving at the gate controller 60 will then be routed in a conventional manner over the best efforts portion 42. When the gate controller 60 receives the instruction signal 208 it stores the relevant details and generates an acknowledgement message 210 which it transmits back to the bandwidth broker. The acknowledgement message 210 confirms the details which the gate controller 60 has received and also confirms that it has reconfigured itself accordingly.

Upon receipt of the acknowledgement message 210 from the gate controller 60, the bandwidth broker host server 84 issues a notification message 212 to the bid router host server 83 via local area network 70. The notification signal 212 includes the amount of bandwidth allocated within the guaranteed quality of service portion 41, the guaranteed duration for which this bandwidth is available (six seconds), the current price being charged to the bidder for this bandwidth and the time when the bid will expire in the absence of a confirmation message from the bidder (ie website application A). In the present embodiment, the duration for which a bid is deemed to remain active is set at 30 seconds (ie five contract periods of six seconds each). Upon receipt of the notification message 212, the bid router examines the message and forwards it on as forwarded notification message 214 to the website host server 82 via the local area network 70. Upon receipt of the notification message 214 from the bid router host server 83, website application A determines the amount of bandwidth which it has been allocated within the guaranteed quality of service portion 41 and commences transmitting data from the website host server 82 to the personal computer 10-1 via local area network 70, gate controller 60, data link 40, DSLAM 30 and modem 20-1 at an appropriate data rate. This is indicated by data signal 216.

Six seconds after first processing the bid message 206 and issuing the notification message 212, the bandwidth broker program automatically processes the bid again and, in this example, determines that the bid is still valid and that the bidder's allocation of bandwidth should be maintained and therefore issues a new notification message 218. When the bid router receives the notification message 218 it again forwards this on as forwarded notification message 220 to the website host server 82. Meanwhile, the website host server continues to transmit data to personal computer 10-1 as indicated by data signal 222. This process of issuing notification messages is repeated a further three times as indicated by notification messages 224, 230 and 236, forwarded notification messages 226, 232 and 238 and data signals 228, 234 and 240. After issuing five notification messages 212, 218, 224, 230 and 236, the bid will have been maintained as active by the bandwidth broker for five contract periods of six seconds each and will therefore be due to expire at the end of the fifth contract unless a confirmation message is received beforehand. In this example, after five contract periods the website application A would still like more data to be transmitted using the guaranteed quality of service portion 41 and therefore, it issues a confirmation message 242 to the bid router host server 83. confirmation message 242 identifies the bid in question and reconfirms the bid so that the bandwidth broker will treat the original bid as active for a further five contract periods. Upon receipt of the confirmation message 242, the bid router program checks that website application A still has sufficient funds in its account. In the present example, this determination is positive and the bid router program forwards on the confirmation message 242 as forwarded confirmation message 244 which is then routed to the bandwidth broker host server 84.

Upon receipt of the forwarded confirmation message 244, the bandwidth broker resets the time of expiry of the bid. Subsequently, when the bid is next processed (at the end of the fifth contract period) the bandwidth broker determines that the bid is still active because it has just been confirmed and thus determines that the allocation of bandwidth to the bidder should be maintained and issues a new notification message 246 to this effect which is transmitted to the bid router host server 83. Notification message 246 is again forwarded as forwarded notification message 248 from the bid router host server 83 to the website host server 82. The website host server 82 has been continuing with transmitting data up to this point as indicated by data signal 250. However, in the present example, shortly after receipt of the forwarded notification message 248, the website application A finishes transmitting the data for the promotional audio video clip and thus wishes to terminate its bid for bandwidth allocation across the data link 40. To achieve this, the website host server 82 transmits a termination request 252 to the bid router host server 83. Upon receipt of the termination request 252, the bid router forwards on the termination request as forwarded termination request 254 to the bandwidth broker host server 84.

Upon receipt of the forwarded termination request 254, the bandwidth broker immediately generates a termination instruction 256 which is transmitted from the bandwidth broker host server 84 to the gate controller 60. At the same time, the bandwidth broker host server 84 transmits a termination notification message 258 which includes an indication that the contract has been terminated and the cost of the whole session (ie the five fully completed contracts and the sixth partially completed contract). The termination notification message 258 is transmitted from the bandwidth broker host server 84 to the bid router host server 83. Upon receipt of the termination notification message 258, the bid router stores the total cost of the session and then forwards on the notification message as a forwarded termination notification message 260 to the website host server 82. Upon receipt of the forwarded notification message 260, the website application A notes the total cost of the session for its own accounting purposes.

When the gate controller 60 receives the termination instruction 256 from the bandwidth broker host server 84, it immediately reconfigures itself to prevent datagrams according to the details of the original instruction signal 208 from being transmitted over the guaranteed quality of service portion 41 and generates an acknowledgement message 262 which it transmits to the bandwidth broker host server 84 to acknowledge that this has been done.

A more detailed description of the website host server 82, the bid router host server 83 and the bandwidth broker host server 84 will now be described with reference to FIGS. 3 to 19.

Website Host Server

FIG. 3 is a block diagram of the website host server 82. As shown, the website host server 82 includes a processor 310 which communicates with a memory 320 which stores a number of website applications including website application A 321. Website application A 321 includes a number of data files which make up the website content 322 which is available for downloading to a user remotely visiting the site; a bidding program 324 which controls how the website application bids for guaranteed quality of service bandwidth allocation; and data files which store a set of bidding preferences 326 which are values for various options used by the bidding program 324.

FIG. 4 is a flow chart illustrating the basic operation of the bidding program 324. Upon commencement of the program at step S350, step S351 determines if a request for content from the website content 322 has been received at the website host server 82 from a computer (hereinafter referred to as the requester) being used by a remote visitor to the site. If no such request is received the control loops back through steps S350 and S351 until such a request is received.

When a request for content is received, control passes from step S351 to step S352 which determines if the requested content data is “bid enabled”. In the present example, website application A includes an audio video clip data file advertising a new product being promoted by the website and this audio video clip file is marked as being bid enabled. In the event that the content data requested is not bid enabled, control passes to step S353 whereupon the requested content data is transmitted to the requester using the normal Best Efforts class of service (thus where the requester is one of the personal computers 10, the requested content data would be transmitted over the best efforts portion 42 of the data link 40). Once step S353 has been completed, control passes back to the start step S350. In the event that the content data is bid enabled, then control passes from step S352 to step S354 where a new bid is generated using the bidding preferences 326 stored in memory 320 of the website host server 82.

In this embodiment, the data contained within each bid generated by the bidding program 324 comprises:

the Website Application's bid identifier (this is a serial number and the field in which it is stored is hereinafter referred to as the Bidder's Bid Identifier);

the Internet Protocol (IP) address of the website host server 82 (this field is hereinafter referred to as the Bidder's IP address);

the IP address of the requester (this field is hereinafter referred to as the correspondent's IP address—in the present example, the requester will always be the same as the correspondent, being the device to which the data to be transmitted over the guaranteed quality of service portion 41 will be addressed; however, in later embodiments where the requester can also bid, the correspondent may be the transmitter of the data rather than the receiver);

the website Application's billing identification number (this field is hereinafter referred to as the Bidder's Billing Identifier—this is stored within the bidding preferences 326 and, in the present embodiment, is the account number supplied to the owner of website application A upon opening an account with the Internet service provider which controls server farm 50; the account is used just for permitting guaranteed bandwidth to be purchased by website application A across the guaranteed quality of service portion 41 of data link 40); and

three transmission bid options each of which includes a requested amount of bandwidth and an associated maximum offer for that bandwidth.

A typical bid might therefore have the form:

Bidder's bid identifier: 1234;

Bidder's IP address: 12. 34. 56. 78;

correspondent's IP address: 78. 56. 34. 12;

Bidder's Billing Identifier 888;

| Bandwidth | | Maximum Offer |
|---|---|---|
| 2 | Mbps | 3 cents/min |
| 1 | Mbps | 3 cents/min |
| 333 | kbps | 2 cents/min |

After generating a bid, control is passed to step S355 where the bid is transmitted to the bid router host server 83 (bid message 204 in FIG. 2). Control is then passed to step S356 where a response from the bid router host server 83 is awaited identifying whether or not the bid was successful. When the response is received control is passed to step S357 which determines from the response, whether or not the bid was successful. If the bid was unsuccessful, control is passed to step S353 and the requested content data is transmitted using conventional Internet Protocol as before. If, however, the bid was successful, control is passed to step S358 where the response received from bid router host server 83 (forwarded notification signal 214 in FIG. 2) is examined to determine how much guaranteed bandwidth has been allocated in response to the bid and transmission of the requested content data is commenced at a corresponding data rate.

The processing then proceeds to step S359 (shown in FIG. 4b) where, in the present embodiment, the website host server tests to see whether all of the requested content data has been transmitted. If it has not, then, in the present embodiment, step S360 tests whether the bid is about to expire at the end of the current contract period. If there is more than six seconds of time left before the current bid is due to expire, then control is looped back to step S359. In the event, however, that less than six seconds of time remains before the bid is due to expire, and not all of the requested content data has been transmitted, then control is passed to step S361 where a confirmation message is transmitted to the bid router host server 83 (confirmation message 230 in FIG. 2) and then the processing returns to step S359. When all of the requested data has been transmitted, control is passed to step S362 where a termination request is transmitted to the bid router host server 83 (termination request 240 in FIG. 2). Then, steps S363 and S364 determine whether a notification of termination has been received from the bid router within a reasonable period of time (in this embodiment one second). If no such notification is received control is passed back to step S362, where a new termination request is transmitted to the bid router host server 83. When the termination notification signal is received, control is passed back to start step S350 via return to start step S365 and the session is ended. Note that although it is not illustrated in FIG. 4, the bidding program 324 will additionally perform the function of monitoring notification signals as and when they arrive from the bid router host server 83, to maintain its own records of the costs associated with each session.

Bid Router Host Server

FIG. 5 is a block diagram of the bid router host server 83 which includes a processor 410 and a memory 420 which stores a bid router 421. The bid router 421 includes a bid router program 422; a data file 424 storing account details of all website applications hosted on the server farm 50 which have set up accounts; and a data file 426 storing bandwidth broker and associated destination IP addresses (which in the present case correspond to the IP address of the bandwidth broker host server 84 and of each of the personal computers 10 accessible via the data link 40).

FIG. 6 illustrates the basic structure of the bid router program 422 in terms of its functional modules and how they interact. The principal functional modules illustrated are an input module 430, a bidding messages processing module 432, a bandwidth broker's notifications processing module 434, a timing module 436 and an output module 438. The input module 430 receives messages addressed to the bid router program 422 and determines if they have come from the bandwidth broker or from a potential bidder. Messages which come from a potential bidder are passed onto the bidding messages processing module 432 and messages which come from the bandwidth broker are passed to the bandwidth broker's notifications processing module 434. When a new bid is received by the bidding messages processing module 432, it notifies the timing module 436 prior to forwarding the new bid to the output module 438 which deals with onward routing of the new bid to the bandwidth broker. The timing module 436 creates a record in respect of the new bid and waits for a predetermined period of time (in the present case ten seconds). If after this time no notification concerning this bid has been received back from the bandwidth broker, then the timing module outputs a notification to the potential bidder indicating that the bid has failed as a result of a time out. Whenever a notification from the bandwidth broker is received by the bandwidth broker's notifications processing module 434, it informs the timing module 436 which looks to see if it can be matched up with an already existing record which is in the process of timing out. If it can match the notification to one of the records, it simply deletes the record (which prevents a time out notification from being generated in respect of this bid). If no match can be found, the timing module takes no action and existing records continue to time out.

Bidding Messages Processing Module

FIG. 7 is a flow chart of the operation of the bidding messages processing module 432. After starting at step S440, control passes to step S441 where receipt of a new bidding message is awaited. When a new bidding message is received the control passes to step S442, where the billing status of the bidder sending the bidding message is assessed. After assessing the billing status of the bidder, control passes to step S443 where the bidding message processing module 432 determines whether or not the bid is billable.

If it is determined in step S443 that the bid is not billable, then control is passed to step S444 where a notification is generated for transmission back to the bidder indicating that the authentication of the bidder has failed. Furthermore, if the originally received signal was a bidding message relating to an old bid (as determined by the presence or absence of a bandwidth broker bid identification number), then a message is also prepared for sending to the bandwidth broker requesting that the bid in question be terminated. After completing step S444, control is passed back to step S441.

In the event that step S443 determines that the bid is billable, control passes to step S445 where the processing module 432 determines if the received message is a new bid or whether it is a message relating to an old bid. If it is a message relating to an old bid, then control is passed to step S446, where the message is immediately sent for forwarding to the bandwidth broker without modification. After completing step S446 control is passed back to step S441.

In the event that step S445 determines that the bidding message is a new bid (this is deemed to be the case where no bandwidth broker bid identifier is contained in the bidding message) control is passed to step S447. Step S447 determines if the correspondent's IP address (as determined from the new bid) matches up with one of the associated destination IP addresses 426 (ie the IP addresses of personal computers 10) stored within the memory 420. This is done to ensure that the content data will be routed over data link 40 such that it is appropriate for the bandwidth broker of the present embodiment to allocate bandwidth over data link 40 for this purpose. Note that if the correspondent is accessible only via the router 90 and the Internet 100, then there is no point in passing on the bid to the bandwidth broker. Therefore, if no match is found then control is passed to step S448 where a notification is generated for sending back to the bidder informing the bidder that the service is not available to the requested correspondent. Thereafter, control is returned to step S441. In the event it is determined at step S447 that the correspondent's IP address does correspond to one of the associated destination IP addresses 426, then control is passed to step S449 where the bidder's account number and credit limit is added to the new bid to generate a modified bidding message. Thereafter, control is passed to step S450 where the modified bidding message is passed to the output module 438 for routing to the bandwidth broker. At the same time, the timing module 436 is informed of the new bid so that it can initiate the above mentioned time out period for the new bid. After completing step S450, control returns to step S441.

In step S442 described above, the billing status of the bidder was assessed. The way in which this is done in this embodiment will now be described with reference to FIG. 8. As shown, upon commencement of step S442 at sub step S4421, control is passed to sub step S4422 where the account details of the bidder are looked up in the data file 424, using the billing ID contained within the bidding message if the bidding message is a new bid. If, however, the bidding message relates to an old bid, then the accounts data file 424 is accessed using the bandwidth broker's bid identifier contained within the bidding message, since (as will be explained further below) the account data for bidders in the data file 424 is continuously updated for currently active bids. Control then passes to sub step S4423 where an authenticity check is carried out for new bids in order to prevent bidders from fraudulently impersonating other bidders by quoting the wrong account details. To do this check, the IP address stored in the account details is compared with the IP address of the bidder determined by examining the origin of the bidding message. In the event that these two IP addresses do not match, then control is passed to sub step S4426 whereupon the status of the bid is set as not billable.

In the event that sub step S4423 finds that the IP addresses do match, then control is passed to sub step S4424 where it is determined if the account is active and has credit available. If the account has been closed or has a hold put on it or if the account has no credit available, then control is passed to step S4426 where the status of the bid is set as not billable as above. However, if the account is active with credit available control is passed to step S4425 where the bid has its status set as billable. After setting the status of the bid as either billable in sub step S4425 or not billable in step S4426, control is passed to sub step S4427 which marks the end of the assessment step S442.

Bandwidth Broker's Notifications Processing Module FIG. 9 is a flow chart illustrating the operation of the bandwidth broker's notifications processing module 434. Upon commencement, control passes from step S460 to step S461 where a notification from a bandwidth broker is awaited. Upon receipt of such notification, control passes to step S462 where the timing module is informed of the receipt of the notification. On completion of this step, control passes to step S463 where the cost of the session thus far is determined from the notification and stored in data file 424 with the account details of the bidder. Note that the relevant account details are identified using the bandwidth broker's bid identifier unless it is the first notification relating to a new bid in which case the account details are identified using the bandwidth broker's bid identifier contained in the notification and is stored with the account details in data file 424 for further reference. Upon completion of step S463, control is passed to step S464 where the notification message is passed to the output module 438 for onward routing to the bidder. After completion of step S464, control is passed back to step S461.

Bandwidth Broker's Host Server

FIG. 10 is a block diagram of the bandwidth broker host server 84 which includes a processor 510 and a memory 520. Stored in the memory 520 is a bandwidth broker 521. The bandwidth broker 521 includes a bandwidth broker program 522, gate controller data 526 and bid router data 528. Additionally, an area of the memory is set aside for the working memory 524 for the bandwidth broker program 522. In this embodiment, the gate controller data 526 simply comprises the IP address of gate controller 60. Similarly, in this embodiment, bid router data 528 comprises the IP address of bid router host server 83 and the domain name or virtual address of the bid router program 422 within the bid router host server 83 (the domain name or virtual address of the bid router is just used to ensure that messages intended for the bid router are conveyed successfully).

FIG. 11 is a block diagram of the general structure of the bandwidth broker program 522 and the working memory 524. As shown, the bandwidth broker program 522 includes an input/output message handling module 530, a gate performance monitor module 532, an initial processing of new bidding messages module 534, a credit management module 536, a Minimum Bid Price (MBP), Spot Price (SP) and Maximum Effective Capacity (MEC) determination module 538 and a processing of old bids module 540. Within working memory 534 there is an active bid store 544.

The input/output message handling module 530 performs the task of receiving signals from external devices and forwarding them on to the appropriate module within the bandwidth broker program 522. In the present embodiment, the bandwidth broker only receives messages from either the bid router host server 83 or the gate controller 60. Additionally, message handling module 530 also acts to receive messages from the modules within the bandwidth program 522 and to forward them to the appropriate external device.

The gate performance monitor module 532 maintains a record of the usage of the guaranteed quality of service portion 41 of the data link 40. In particular, in the present embodiment, it maintains a record of how much actual spare bandwidth is available in portion 41 and it makes this information available to other modules which need to know it (ie modules 534, 538 and 540). In this embodiment, the amount of actual spare bandwidth available is determined by keeping a record of each bid having bandwidth allocated to it. These records are maintained by monitoring instruction signals issued from either module 534 or 540, instructing the gate controller 60 to change its allocation of bandwidth over portion 41 in some way (ie either increasing or decreasing its allocation), together with acknowledgement signals from the gate controller 60 acknowledging that the instructed change in allocation has been made. Whenever a new instruction signal is made the gate performance monitor 532 makes a provisional amendment to its respective record (which is considered when calculating the amount of spare bandwidth available). Once an acknowledgement has been received from the gate controller 60 confirming a provisional amendment, the amendment is made firm. If no acknowledgement is received or if an incorrect acknowledgement is received, the gate performance monitor module 532 re-sends the instruction signal to the gate controller 60. If one of the modules 534 or 540 sends an instruction to cancel a provisional amendment, module 532 will delete its provisional amendment.

Additionally, the gate performance module 532 periodically sends general status request messages to the gate controller 60 in order to determine how bandwidth is being allocated within portion 41 (which in this embodiment always remains constant at 115 mbps), the maximum capacity of portion 41 and the spare capacity available. Upon receipt from the gate controller 60, this information can be used to update the gate performance module's internal records if necessary.

In the present embodiment, the credit management module 536 receives new bidding messages from the input/output message handling module 530 and sets up a record of the bidder associated with the bid which includes the bidder's available credit and account number and thereafter monitors costs incurred as a result of that bid by receiving notifications generated from either the initial processing of new bidding messages module 534 or the processing of old bids module 540. In the event that a bidder uses up all of the available credit the credit management module sends a warning to the processing of old bids module 540 which, as will be described in more detail below, causes the associated session to be terminated.

The active bid store 544 stores a number of bids in the order in which each bid is next due for review and each bid within the store contains the following information:

Bidder's bid identifier;

Bidder's IP address;

correspondent's IP address;

Bidder's billing identifier;

transmission bid options:

| | |
|---|---|
| bandwidth (option 1) | maximum offer (option 1); |
| bandwidth (option 2) | maximum offer (option 2); |
| bandwidth (option 3) | maximum offer (option 3); |

Bidder's credit limit;

Bandwidth Broker's (BB) bid identifier;

time-of-next-review;

time-of-bid;

time-of-last-confirmation;

current bandwidth;

MBP at start-of-session;

SP at start-of-session;

current price;

cost of guaranteed bandwidth until next review; and total cost.

Initial Processing of New Bidding Messages Module The basic functionality and detailed processing of the initial processing of new bidding messages module 534 will now be described. The basic functionality of module 534 is to perform initial processing of bidding messages when they are received by the Bandwidth broker. In the present embodiment, such messages can be any one of a new bid, a confirmation of an old bid or a termination request relating to an old bid. In the case of a termination request, it causes the corresponding session to be terminated by issuing a termination notification and an instruction to the gate controller 60 to deallocate the appropriate bandwidth. In the case of a confirmation, time-of-last-confirmation of the corresponding bid is updated. In the case of a new bid, the bidding message is examined to see if any of its bid options can be satisfied. If one of its bid options can be satisfied, a session is started and the bid is stored in the active bid store 544. Otherwise, the bid is rejected and a failure notification is generated for transmission, via the bid router, to the bidder, indicating that the bid was unsuccessful.

FIG. 12 is a flow chart of the detailed operation of the initial processing of new bidding messages module 534. Upon commencement of the operation of the module at step S550, a new bidding message is awaited at step S551. Upon receipt of a new bidding message, control is passed from step S551 to step S552 where the module 534 determines whether the message relates to an old bid or if it relates to a new bid. To determine if the message relates to an old bid, the received bidding message is examined to see if it includes a BB bid identifier. If such an identifier is present the message is deemed to relate to an old bid otherwise it is deemed to relate to a new bid.

If the message is deemed to relate to an old bid, control is passed to step S553, where the module 534 determines if the message is a confirmation message and if it can be matched to an existing active bid by matching the BB bid identifier contained within the message with one of the bids stored in the active bid store 544. If a match is found, control is passed from step S553 to step S554 where the time-of-last-confirmation field within the matched bid stored in the active bid store is reset to the current time. Upon completion of step S554, control is passed back to step S550.

If at step S553 it is determined that the received bidding message is not a confirmation message or cannot be matched to an existing bid, control is passed to step S555. In step S555 the message is examined to see if it is a termination request and if it can be matched to an existing bid in the active bid store 544. If it is a termination request, then control is passed to step S556 where a Notification of termination is generated for sending, via message handling module 530, to the bid router which, in turn, will forward the Notification on to the bidder. Also in step S556 an instruction is generated for sending an instruction, via the message handling module 530, to the gate controller 60 (and also to the gate performance monitor module 532 which makes a provisional de-allocation within its own records), instructing the gate controller 60 to terminate the current session by de-allocating the corresponding bandwidth. Finally, the terminated bid is deleted from the active bid store 544, and control is returned back to the start step S550.

If at step S555 it is determined that the received bidding message is not a termination request or cannot be matched to an existing bid, it is assumed in the present embodiment that the message is invalid, possibly because it is corrupted in some way. In such a case, control is passed to step S557 where an error message is generated for sending, via message handling module 530, back to the bid router. Upon completion of step S557, control is passed back to the start step S550.

If at step S552 the processing module 534 determines that the received message relates to a new bid, then control is passed to step S558 where a new BB bid identifier number is generated and added to the new bid. Upon completion of step S558, control is passed to step S559, where the bid options (in descending order of amount of bandwidth requested) are compared with the present Minimum Bid Price (MBP) and the spare actual bandwidth available in the guaranteed quality of service portion 41 of the data link 40. Control is then passed to step S560, where it is determined if any of the bid options are successful. In this embodiment, to be successful the ratio of the maximum offer in terms of cents per minute to the respective requested amount of bandwidth must be greater than the present Minimum Bid Price (MBP) and the requested bandwidth must be less than or equal to the spare actual bandwidth. In the event that no bid options are successful, control is passed from step S560 to step S566 where a Notification of failure is generated for sending, via the bid router, to the bidder. The Notification includes the bidder's bid identifier together with an indication that the bid has failed. Upon completion of step S566 control is passed back to the start at step S550.

If it is determined at step S560 that at least one of the bid options is successful, then control is passed to step S561 where an instruction is generated for transmission via the message handling module 530 to the gate controller 60 which instructs the gate controller 60 to allow through datagrams from the corresponding bidder to the correspondent at a rate which is less than or equal to the amount of bandwidth for the successful bid option with the highest bandwidth via the guaranteed quality of service portion 41 of data link 40. This instruction is also sent to the gate performance monitor module 532 which makes a provisional record of this allocation.

After completion of step S561, control is passed to step S562 which initiates a small delay before passing control onto step S563 where the module 534 determines if an acknowledgement message has been received from the gate controller 60 If no acknowledgement has been received, then control is passed to step S564 where the module 534 determines if less than three attempts to instruct the gate controller 60 have failed to result in an acknowledgement message being received. If the number of such attempts is less than three, then control is passed back to a step S561 and a further attempt at instructing the gate controller 60 and detecting an acknowledgement therefrom is made. If three such attempts have been made unsuccessfully, then control is passed to step S565 where a cancellation instruction is sent to the gate controller 60 and the bid is treated as having failed. Control is then passed to step S566, where a failure notification is issued as before.

If at step S563 an acknowledgement message is received indicating that the gate controller 60 has reconfigured itself to allow the requested traffic through, then control is passed to step S567. In step S567 various bid fields within the bid are initialised including the time-of-bid field which is set to the current time; the time-of-last-confirmation field which is also set to the current time; the time-of-next-review field which is set to the current time plus six seconds; the current bandwidth field which is set to the successfully bid for amount of bandwidth; the Minimum Bid Price (MBP) at start-of-session field which is set to the current value of the minimum bid price; the current price field which is also set to the current value of the minimum bid price; the total cost field which is set to zero; the cost of guaranteed bandwidth until next review field which is set to the current price multiplied by the current bandwidth multiplied by the time until next review the Spot Price (SP) at start-of-session field which is set to the current value of the Spot Price; and a Service Period Count field which is set to zero. Upon completion of step S567, control is passed to step S568, where the module 534 generates a notification message which confirms that one of the bid options has been successful and indicates the current bandwidth, the current price, the cost of the guaranteed bandwidth until the next review and the time when a confirmation of the bid will be required to prevent the bid from expiring (ie time of last confirmation plus thirty seconds). The notification message also includes both the Bidder's bid identifier and the BB bid identifier. The notification message is passed both to the credit management module 536 for monitoring the credit available to the bidder and to the message handling module 530 for onward forwarding to the bid router host server 83 and from there, in the present example, back to the website host server 82.

Upon completion of step S568, control is passed to step S569 where the bid is stored in the active bid store 544. In the present embodiment, all bids which are stored in the active bid store 544 have their time-for-next-review set at the current time plus six seconds, so that all newly processed bids go to the end of the queue of bids to be reviewed and work their way upwards as bids ahead of them are processed. After completion of step S569, control is passed back to the start step S550.

Processing of Old Bids Module

The basic functionality and detailed processing of the processing of old bids module 540 will now be described. The basic functionality of module 540 is to periodically process each of the bids within the active bid store 544 and to adjust the allocations of bandwidth within the guaranteed quality of service portion 41 of the data link 40, in order to dynamically account for changes in demand. In particular, in the present embodiment, module 540 periodically examines each bid and determines if the allocation of bandwidth associated with that bid can be maintained or whether the current Spot Price (which, as will be described in more detail below, is representative of the current level of demand) has increased to the point that the allocation of bandwidth for the bid must be reduced by stepping to a new lower bandwidth option associated with the bid or that the bid should be terminated altogether in the event that none of the bid options has a sufficiently high price associated with it compared to the current Spot Price.

FIG. 13 is a flow chart illustrating the detailed operation of the processing of old bids module 540. Upon commencement at step S587, control passes to 5588 where the module 540 waits for any one of the bids within the active bid store 544 to become due for review. This is done, in the present embodiment, by comparing the current time with the time-of-next-review field of the first bid in the queue of bids in the active bid store 544. When the time-of-next-review is less than or equal to the current time, then the bid which has just been found ready for review is selected and control is passed to step S589. Otherwise, control loops back to step S587 until a bid becomes ready for review.

In step S589 the service period count of the bid is incremented by one and then control is passed to step S590. Steps S590 to S593 are used to determine what price will be used in assessing the success or failure of the bid options and the price that the user will be charged for the next contract period if one of the options is successful. The overall effect is that a new bid will have to deal with the Minimum Bid Price (which may be higher than the Spot Price) whilst an established bid gets to use the Spot Price. In between these two extremes, the price charged to a bid is slowly lowered from the Minimum Bid Price (MBP) to the Spot Price (SP) over a number of contracts (up to a maximum of ten contracts or “service periods”). Clearly, if the MBP was equal to the SP at the start of the session no transition is required.

Thus in step S590 it is determined if the MBP at start-of-session for the selected bid is greater than the SP at start-of-session. If the determination of step S590 is positive then control is passed to step S591, where the module 540 determines if the service period count is less than or equal to ten. If the determination in either step S590 or step S591 is negative, then control is passed to step S592 where an intermediate variable named “Token Price” is set to the current value of the Spot Price. If at step S591 it is determined that the Service Period Count is less than or equal to 10 then control is passed to step S593, where the intermediate variable Token Price is set to the larger of either the current Spot Price or the current-price (as stored in the current price field of the bid) minus ten per cent of the difference between the MBP and the SP at the start-of-session. After setting the value for the intermediate variable Token Price in either step S592 or step S593, control is passed to step S594.

In step S594 the module 540 determines whether the Token Price is greater than the maximum offer contained in the currently serviced bid option of the selected bid. In the present embodiment, this will only be the case when the current Spot Price has risen from the value which it had the last time the bid was reviewed six seconds earlier. If the Token Price is not greater than the maximum offer for the current bandwidth in the currently serviced bid option, then control is passed to step S595 where the current price is set to the Token Price. Upon completion of step S595, control is passed to step S596 where the time-of-next-review is adjusted to the current time plus six seconds; the total cost is incremented by the value currently stored in the cost of guaranteed bandwidth until next review field and then the cost of guaranteed bandwidth until next review is reset to the product of the current bandwidth, the current price and the time until next review. Upon completion of step S596, control is passed to step S597 where a notification message is generated which includes the BB bid identifier, the Bidder's bid identifier, the current bandwidth, the current price, the cost of guaranteed bandwidth until next review and the time by which a confirmation message will be required to prevent the bid from expiring. This notification message is passed to the credit management module 536, the gate performance monitor module 532 and the message handling module 530 for onward routing to the bid router host server 83. Upon completion of step S597, control is passed to step S598 where the bid is stored back in the active bid store 544. Upon completion of step S598 control is passed back to the start step S587 via the return to start step S599.

In the event that the module 540 determines at step S594 that the Token Price is greater than the maximum offer for the current bandwidth included in the currently serviced bid option of the selected bid, then control is passed from step S594 to step S600. Note that such a positive determination is indicative of the Spot Price having risen above the threshold which the bidder has indicated it is prepared to pay for the currently serviced allocation of bandwidth. Therefore, in step S600, an attempt is made to find the next lowest requested amount of bandwidth, if any, for which the bidder has indicated it is prepared to pay a price above the Token Price. Upon completion of step S600, control is passed to step S601 where the module 540 determines if at least one bid option was found to be acceptable in step S600.

In the event that no bid option is found to be acceptable, then control is passed to step S602 where the total cost is incremented by the value currently stored in the cost of guaranteed bandwidth until next review field. Upon completion of step S602 control is passed to step S603 where a notification of termination message is generated. The notification of termination message includes the bandwidth broker bid identifier, the Bidder's bid identifier, an indication that the session has ended and the total cost. The notification of termination message is passed to the credit management module 536 (which can now delete its records of the bid) and the message handling module 530 for onward routing to the bid router host server 83 (and from there to the server hosting the bidder—eg the website host server 82).

Upon completion of step S603, control is passed to step S604 where an instruction message is generated for transmission to the gate controller 60. The instruction message is also passed to the gate performance monitor 532 which makes a provisional deallocation from its record of the allocation of bandwidth within the guaranteed quality of service portion 41 and awaits confirmation in the form of an acknowledgement from the gate controller 60) that the bandwidth has been deallocated whereupon the provisional deallocation is made permanent. The instruction message includes the bandwidth broker's bid identifier and an indication that the allocation made in respect of this bid should be terminated. Upon completion at step S604, control is passed to step S605 where the bid is deleted from the active bid store 544 and then control is returned to the start step S587 via the return to start step S606. Note in the present embodiment the bandwidth broker does not await receipt of an acknowledgement message from the gate controller 60 before deleting the bid and issuing a notification of termination to the bid router host server 83 for onward transmission to the website host server 82, so that if there is a problem with reconfiquring the gate controller 60, the user does not suffer additional costs.

If at step S601 the module 540 determines that at least one of the bid options of the selected bid is acceptable, then control is passed to step S607, where a message is generated for transmission via the message handling module 530 to the gate controller 60 instructing the gate controller 60 to reduce the allocation of bandwidth within the quality of service portion 41 to the new lower amount for appropriate datagrams (ie the datagrams specified in the selected bid option). Upon completion of step S607, control passes to step S608 where the current bandwidth field of the selected bid is adjusted by setting it to the accepted bandwidth (ie the bandwidth bid for in the selected acceptable bid option). Upon completion of step S607 control is passed back to step S595 described above.

MBP, SP and MEC Determination Module

The basic functionality and detailed operation of the MBP, SP and MEC determination module 538 will now be described. The basic functionality of module 538 is to periodically review the relationship between the current level of demand and the utilisation of the available bandwidth in order to attempt to establish a suitable price for the bandwidth available over the guaranteed quality of service portion 42 in such a way that, in general, the highest value bids are serviced in preference to lower value bids. The basic principle applied is to establish a clearing price such that all bids offering a price equal to or higher than the clearing price are given bandwidth at the clearing price and such that the sum of the bandwidths of all such cleared bids is maintained as close as is practicable to the available bandwidth for guaranteed quality of service with an appropriate amount of stability.

This concept will now be described in more detail with reference to FIG. 14 which shows a typical demand curve exhibiting price elasticity. The vertical axis represents the value of the resource to be auctioned, which in this case is bandwidth. The value is determined by what a bidder is prepared to pay for it and is expressed in terms of value per unit of bandwidth (in this case cents per min per Kbps). The horizontal axis represents cumulative bandwidth demand ranked by value. The curve illustrates the way in which the demand will vary with the price. Therefore, if the price is high, the demand will be low and if the price is low, then demand will be high. In the case that there is a fixed amount of bandwidth to be auctioned (indicated by the line RL) it is possible to determine a market clearing price, P where the resource limit intersects with the demand curve. By charging this market clearing price, the demand to the left of the line RL (indicated by area SD) exactly matches the amount of bandwidth available and will therefore be accepted. Extra demand that would have existed had the price been lower (indicated by the area RD) is effectively outpriced and therefore rejected.

As those skilled in the art will appreciate, such a precisely defined demand curve represents perfect knowledge of the instantaneous demand. In practice, it is not feasible to obtain perfect knowledge of demand and, in the present embodiment, there is a certain amount of short-term variability in demand. Short-term demand is therefore better characterised by defining a curve-shaped area over which demand is experienced rather than a single line. This is illustrated in FIG. 15. The area STV can be thought of as a single line UD representing the underlying demand curve and a blurring factor which represents the short-term variability and which causes the line to be widened in each direction transverse to the line (represented by the dashed lines STVH, STVL). Therefore, if the market clearing price is set according to the underlying demand (as illustrated in FIG. 15 by the value per unit of demand P) demand will often exceed the Resource Limit RL (as represented by hatched area ED).

The change in the demand area brought about by a change in the underlying demand UD is illustrated in FIG. 16. Note that in this illustration, the thickness of the area STV does not change indicating that the short-term variability has remained constant. Such a change in underlying demand is typical of telecommunications networks where demand varies according to the time of day and other events beyond the control of the network operator.

The system of the present embodiment overcomes the problem of short-term variability by setting a price (the Spot Price) which is sufficiently high that the underlying demand is reduced to a level sufficiently far below the resource limit that most short-term variations will still be able to be accommodated. This is illustrated in FIG. 17. Note that the mean demand at price P (represented by the line MD) is somewhat lower than the resource limit RL. FIG. 17 also shows a bell-shaped curve (STD) which indicates that although the instantaneous demand at price P could lie anywhere over the intersection of the line marked P and the demand curve-shaped area STV, it will most probably fall at the mean value MD with diminishing probability of it falling either side of the mean with an approximately normal distribution.

In the present embodiment, a Maximum Effective Capacity (MEC) is set which tries to match to the mean demand MD which the system can cope with, to enable short-term variations in demand to be accommodated without exceeding the resource limit (at least, no more than a predetermined small fraction of bids or bid reviews should be refused service because they would otherwise cause the resource limit to be exceeded). The price charged is varied to try and keep the underlying demand approximately equal to the MEC.

The MBP, SP and MEC determination module 538 also sets a value for the Minimum Bid Price (MBP) which acts as a dampening mechanism to prevent demand from rising so quickly as to exceed the Resource Limit and to reduce the rate at which the Spot Price must change to account for changes in demand. The aim is to try and prevent the Spot Price from changing in response to short-term variations in demand where the underlying demand has not changed.

The detailed operation of the MBP, SP and MEC determination module 538 will now be described with reference to the flow chart shown in FIG. 18. Upon commencement of the operation of the module at step S650, a number of variables which will be required by the module are initialised in step S651. The variable MAX is set to equal 115; this represents the maximum amount of bandwidth available for allocation to bidders over the guaranteed quality of service portion 41 of the data link 40, which in the present example is assumed to be fixed at 115 Mbps. The variable MEC is set to equal 80; MEC represents the Maximum Effective Capacity within the guaranteed quality of service portion 41. For the reasons explained above, this is set to be somewhat lower than the maximum amount available, MAX, to provide a buffer which can accommodate new bids. The general aim of the system is to dynamically vary the Spot Price and the Minimum Bid Price charged to bidders to maintain the average bandwidth allocation reasonably close to the Maximum Effective Capacity. The variable HITHRESH is a variable which is used to trigger an increase in the Minimum Bid Price when an increase in demand causes allocation of bandwidth within portion 42 to increase beyond this threshold. In this embodiment, HITHRESH is set to a value of 88. The variable LOWTHRESH is similar to HITHRESH except that it is used to trigger a reduction in the Spot Price when the fall in demand causes the allocation of bandwidth within data portion 40 to fall below this threshold. In this embodiment, LOWTHRESH is set to a value of 68.

In this embodiment, MEC, HITHRESH and LOWTHRESH are varied, in a manner described below, between a number of distinct permitted values. In the present embodiment, there are three such distinct permitted vales associated with each of MEC, HITHRESH and LOWTHRESH. In the present embodiment these permitted values are set according to the following table:

| | | |
|---|---|---|
| MEC1 = 70 | HITHRESH1 = 80 | LOWTHRESH1 = 56 |
| MEC2 = 80 | HITHRESH2 = 88 | LOWTHRESH2 = 68 |
| MEC3 = 90 | HITHRESH3 = 96 | LOWTHRESH3 = 80 |

Note that the initial values of MEC, HITHRESH, and LOWTHRESH described above correspond to MEC2, HITHRESH2, and LOWTHRESH2 respectively.

The constants W, N, M, K, Z and V are also initialised in step S651. In the present embodiment they are initialised with the following values: W=50, N=4, M=30, K=0.4, Z=1, V=0.6. These constants are used by Module 538 in various formulae as described in greater detail below. All one hundred and fifty members of an array SP are set to equal 100. The SP array holds the value of the Spot Price charged to bidders at any particular sample time. Actually, one of the elements of the array stores the current Spot Price and the other elements store the values of the Spot Price during the preceding one hundred and forty nine sample periods. Once the number of Spot Price values exceeds 150, new values of the Spot Price are cyclically written over old values. Similarly, an array MBP has all of its one hundred and fifty members initialized to the value 100. The array MBP indicates the Minimum Bid Price charged to bidders over the previous one hundred and fifty sample periods. similarly, an array UTIL has all of its one hundred and fifty members set to the initial value 85. The array UTIL expresses the actual amount of bandwidth allocated within the guaranteed quality of service portion 42 of the data link 40 at any sample time. The arrays SP, MBP and UTIL are used in order to keep a historical record of the values adopted by each of these variables over the preceding one hundred and forty nine sample periods (which, in the present embodiment, corresponds to a half hour period).

The following parameters are also initialised; MINSP, THRESHTOOMANY and THRESHTOOFEW. In the present case they are initiated with the following values: MINSP=0, THRESHTOOMANY=50, THRESHTOOPEW=10. MINSP indicates the minimum value to which the Spot Price is allowed to fall to by the system. THRESHTOOMANY and THRESHTOOFEW are used by the system to determine whether the Maximum Effective capacity (MEC) is set too high or too low. Note that a large Short-term variability will require a relatively low MEC whilst a low short-term variability should permit a higher MEC to be used. An index variable, SAMPLECOUNT, used for counting sample periods is also initialised to SAMPLECOUNT=0 and a variable SAMPLETIME is initialised to the current time. A parameter MINMBP is also initialised. In the present case it is initialised to 0.5. The MINMBP prevents MBP from getting stuck at zero if SP ever drops to zero. This is described in greater detail below.

Upon completion of step S651, control is passed to step S652 where the variable SAMPLETIME is incremented by two seconds. The processing then proceeds to step S653 where the next sample period is awaited. When the next sample period is reached (ie when the current time is greater than or equal to SAMPLETIME) control passes to step S654. In step S654 SAMPLECOUNT is incremented by one and a value for UTIL for the current sample period is determined by subtracting the spare actual capacity available from MAX. In this embodiment, the spare actual capacity available within the portion 41 is provided to the module 538 by the gate performance monitor module 532. Upon completion of step S654, control is passed to step S655 where module 538 determines if UTIL for the current sample is greater than or equal to HITHRESH. If it is not, then control is passed to step S656 and if it is then control is passed to step S657. At step S656 the module 538 determines if UTIL for the current sample is greater than LOWTHRESH. If it is then control is passed to step S664 and if is not then control is passed to step S670.

At step S657 a variable, C, is set according to the following formula:

C=(K×(MAX-HITHRESH)/(MAX-UTIL))^{z}

The value of C calculated in this way is then used in the following step S658 in order to determine an initial value for the Minimum Bid Price (MBP) for the current sample period, according to the following formula:

MBP (SAMPLE COUNT)=MAX [SP(SAMPLE COUNT-1)×(1+C); MINMBP]

As those skilled in the art will appreciate the above two formulas essentially combine to cause the Minimum Bid Price for the current sample period to take a value which is greater than the Spot Price determined during the preceding sample period, by an amount which depends on how much the utilisation has exceeded the high threshold relative to the maximum amount by which the threshold can be exceeded before exceeding the actual amount of bandwidth available, provided that, in cases where SP is zero or very small, MBP is set to at least MINMBP (where UTIL>HITHRESH—note that MBP is allowed to fall below MINMBP when UTIL<HITHRESH).

Upon completion of step S658, control is passed to step S659 where the module 538 determines if the minimum bid price during the preceding N sample periods (in this case N has been set to 4) has exceeded the Spot Price determined in the preceding sample period. If it is not, then control is passed to step S660. Such a negative determination essentially means that the Minimum Bid Price has only recently increased above the Spot Price and thus there is no need to alter the Spot Price at this time as the increase in demand might simply be a result of Short-term variability. Therefore, in step S660 the Spot Price for the present sample period is set to the same as the Spot Price for the preceding sample period and control is then passed to step S677.

In the event that it is determined in step S659 that the Minimum Bid Price (MBP) has been greater than the Spot Price (SP) for the preceding N sample periods, then control is passed to step S661. Such a positive determination here essentially means that the Minimum Bid Price has been greater than the Spot Price for a sufficiently long period that it is indicative of a change in the underlying demand as opposed to just short-term variability and thus the Spot Price (SP) is raised to try to reduce the demand. Therefore, in step S661 the new value of the Spot Price for the current sample period is set as the weighted average of the mean value of the Minimum Bid Price (MBP) over the last N sample periods and the Spot Price (SP) determined during the preceding sample period. The weighting used for this weighted average is given by V which in the present case is set at 0.6 such that 60% of the weighting is with the mean value of the Minimum Bid Price over the last N sample periods and 40% of the weighting is with the Spot Price during the preceding sample period. After completion of step S661, control is passed to step S662 where the module 538 checks that the Minimum Bid Price (MBP) is not lower than the new value of the Spot Price (as determined in step S661). If it is not, then control is passed to step S677 and if it is, then control is passed to step S663, where the Minimum Bid Price (MBP) is raised to be equal to the new Spot Price and then control is passed to step S677.

Returning to step S656, if it is determined that UTIL is greater than LOWTHRESH, then this indicates that the actual allocation of bandwidth within portion 41 lies between the high threshold and the low threshold, which is taken as an indication that the underlying demand is stable. Therefore, in this case the Minimum Bid Price (MBP) can be slowly reduced to come into line with the Spot Price or to keep it equal to the Spot Price if it already is, since if the demand is stable then the Spot Price should be stable and there is no need for the dampening action provided by the Minimum Bid Price. Thus in step S664, the Minimum Bid Price for the current sample period (MBP(SAMPLECOUNT)) is set to the preceding value of the Minimum Bid Price (MBP (SAMPLECOUNT-1)) minus the greater of (i) the fraction (W) of the difference between the Minimum Bid Price and the Spot Price for the last sample period (W×(MBP(SAMPLECOUNT-1)−SP(SAMPLECOUNT-1))); or (ii) the reduction in minimum bid price at the last sample period (MBP(SAMPLECOUNT-2)−MBP (SAMPLECOUNT-1)); provided that the Minimum Bid Price is not set to less than the Spot Price at the previous sample period (since the Spot Price for the current sample period has not yet been set). This can be expressed by the following formula:

MBP(SAMPLECOUNT)=max [SP(SAMPLECOUNT); MBP(SAMPLECOUNT-1)−max [Wx(MBP(SAMPLECOUNT-1)−SP(SAMPLECOUNT-1)); MBP(SAMPLECOUNT-2)−MBP(SAMPLECOUNT-1)]]

Upon completion of step S664, control is passed to step S665 where the module 538 again checks whether or not the Minimum Bid Price has been consistently higher than the Spot Price for the preceding N sample periods. Again if it has not, then this is an indication that no change in the Spot Price is required and control is passed to step S660 where the Spot Price for the current sample period is set to equal the value of the Spot Price for the preceding sample period and then control is passed to step S677. If it is determined in step S665 that the Minimum Bid Price has been consistently higher than the Spot Price for the preceding N steps then control is passed to step S667 where the Spot Price for the current sample period is raised. This is again done by determining the weighted average of the mean value of the Minimum Bid Price over the preceding N sample periods and the value of the Spot Price in the preceding sample period. As before, the weighting used is given by V which in the present case is set to equal 0.6. Upon completion of step S667, control is passed to step S668 where the module 538 again checks that the Minimum Bid Price for the current sample period is not less than the Spot Price for the current sample period. If it is not, then control is passed directly to step S677 and if it is, then control is first passed to step S669 here the value of the Minimum Bid Price for the current sample period is increased to equal the value of the Spot Price for the current sample period.

If at step S656, it is determined that UTIL is less than or equal to LOWTHRESH (ie that the allocation of bandwidth in portion 41 has fallen below the lower threshold indicating that the Spot Price should be lowered in order to increase demand), then control is passed to step S670 where the module 538 first determines if the Minimum Bid Price in the preceding sample period was greater than the Spot Price in the preceding sample period. If it was, then control is passed to step S671 where the Minimum Bid Price is reduced to bring it towards the Spot Price using the same formula used in step S664. Upon completion of step S671, control is passed to step S672, where the Spot Price for the current sample period is set to equal the Spot Price of the preceding sample period (ie it is kept constant). Upon completion of step S672, control is passed to step S677.

If at step S670 it is determined that the Minimum Bid Price in the preceding sample period was not greater than the Spot Price in the preceding sample period, then this is taken as an indication that the underlying demand may have fallen and thus that the Spot Price may need to be reduced. Therefore, in this case control is passed to step S673 where the module 538 determines if the utilisation has consistently been below the lower threshold for the preceding N sample periods. If it has not, then this is taken as an indication that the low demand might just be due to short-term variations and control is passed to step S674, where the Spot Price and the Minimum Bid Price for the current sample period are set to the value of the Spot Price in the preceding sample period (ie they remain unchanged). Upon completion of step S674 control is passed to step S677.

If the utilisation has consistently been below the lower threshold for the preceding N sample periods, then control is passed from step S673 to step S675. This positive determination at step S673 is taken to be an indication that the underlying demand has actually fallen and that the Spot Price should be reduced in order to stimulate more demand. Thus in step S675, the Spot Price is set to the smaller of (i) 90% of its preceding value; or (ii) the value obtained by reducing the spot Price by the same amount it was reduced last time (if it was reduced during the preceding sample period); provided always that the Spot Price is not allowed to fall below the minimum allowed value of the Spot Price which is defined MINSP (which in the present embodiment is set to equal zero). Upon completion of step S675, control is passed to step S676 where the Minimum Bid Price for the current sample period is reduced to equal the Spot Price for the current sample period and then control is passed to step S677.

Step S677 is the junction step at which all of the three main branches corresponding to the three different possible situations concerning the utilisation of bandwidth which can occur at each sample period (ie the utilisation being greater than the upper threshold, the utilisation residing between the upper and lower thresholds or the utilisation being lower than the lower threshold) converge. At step S677, the module 538 determines if the-Spot Price has remained unchanged for the preceding M samples (in the present case M has been set at thirty). If it has, then this is taken as an indication that the system is too stable and therefore, that the Spot Price is too high. In this case, control is passed to step S678 where the Spot Price for the current sample period is reduced to the greater of (i) 90 per cent of its preceding value or (ii) the minimum value which it can take (MINSP). Upon completion of step S678 control is passed to step S679.

If in step S677 it is determined that the Spot Price has not been constant for the preceding M samples, then control is passed directly to step S679. In step S679 the module 538 determines whether or not an evaluation of whether to adjust the Maximum Effective Capacity (MEC) should be made. This is done by determining if SAMPLECOUNT is exactly divisible by 150. In other words, MEC is evaluated every one hundred and fifty samples or every five minutes. If the determination at step S679 is negative, then control is passed via step S680 back to step S652.

If it is determined in step S679 that the Maximum Effective Capacity (MEC) should be reviewed, then control is passed to step S681 where the module 538 determines if the utilisation has exceeded HITHRESH more than a predetermined number of times set by the variable THRESHTOOMANY (which in the present case has the value fifty) during the preceding one hundred and fifty sample periods. If it has, then this is taken as an indication that MEC is too high (on the basis that a high short-term variability is causing demand to spill over too often). Therefore, in this case control passes to step S682 where MEC is reduced if possible by setting it to the next lower permitted value of MEC (eg if MEC was equal to MEC2, the MEC is reduced to MEC1). Also in step S682, HITHRESH is reduced to the next lower permitted value of HITHRESH and LOWTHRESH is reduced to the next lower permitted value of LOWTHRESH. After completion of step S682, control is returned to step S652 via the return step S683.

If the utilisation has not exceeded HITHRESH more than THRESHTOOMANY during the preceding one hundred and fifty sample periods, then the control passes from Step S681 to step S684 where module 538 determines if UTIL exceeded HITHRESH fewer than THRESHTOOFEW times during the preceding one hundred and fifty sample periods. If it has not, then this is taken as an indication that MEC has the correct value for the short-term variability experienced by the system and control is passed, via a return step S685, to step S652. A positive determination in step S684, however, is taken as an indication that MEC is too low. That is, the short-term variability is sufficiently low to permit the Maximum Effective Capacity (MEC) to be raised without risking pricing instability and frequent occurrences of demand exceeding the maximum amount of bandwidth available. As a result, control is passed to step S686 where MEC is raised to the next higher permitted value of MEC (eg if MEC was equal to MEC2 it is raised to MEC3) and HITHRESH and LOWTHRESH are also raised to their next higher permitted values. Note that MEC, HITHRESH and LOWTHRESH will always move up and down together. Also, as MEC is raised, the differences between LOWTHRESH, MEC and HITHRESH are reduced (ie the band between LOWTHRESH and HITHRESH is narrowed). This means that as MEC is raised, the system becomes more sensitive to changes in utilisation. Upon completion of step S686, control is returned to step S652 via return step S687.

FIG. 19 illustrates the gate controller 60 in more detail. As can be seen, gate controller 60 has an interface 196 which is connected to the LAN 70. Instructions from the bandwidth broker are sent from the interface 196 to the controller 192 which stores the instructions in a memory 194. Also, acknowledgements from the controller 192 are sent back to the bandwidth broker via interface 196 and LAN 70. The other principal element of the gate controller 60 is a controllable router 190. The router 190 receives datagrams from LAN 70 via the interface 196 and routes them onto portion 41 or 42 under the control of the controller 192.

General Comments on the First Embodiment

An alternative algorithm for determining whether the MEC should rise or fall is as follows:

The MBP is a means for dampening out short-term (i.e. over time-spans of tens of seconds) volatility in demand. Under conditions of low volatility MBP will not differ much from the SP, whilst under conditions of high volatility the MBP will often rise well above SP as instantaneous demand shoots up (and threatens to reach MAX), before returning back to the same level as SP when instantaneous demand subsides. Therefore we can use the difference between MBP and SP as a measure of the volatility and hence whether we have set MEC too high or too low.

The procedure is as follows: If step S679 determines that a review of MEC is required, the 150 most recent values of MBP and SP are used to calculate 150 values of (MBP-SP). The sum of these 150 values is then calculated. (Alternatively the sum of the squares of these 150 values may be used if we want to give more weight to large values of (MBP-SP).) This sum is compared to two thresholds, HITHRESH2 and LOTHRESH2. If the sum is more than HITHRESH2 it indicates that volatility is high and hence MEC should be lowered to the next lowest level (e.g. MEC1 and MEC2). If the sum is less than LOTHRESH2 it indicates that volatility is low and hence MEC should be raised to the next highest level (e.g. MEC2 or MEC3). It will be apparent from the above description that the data communication system 1 of the first embodiment provides a system by which bandwidth over a single constraining link (or bottle neck) is allocated to various bidders in a dynamic manner in dependence upon the maximum price which they are prepared to pay for the bandwidth which they wish allocated. An important aspect of the system is that the allocation of bandwidth is not performed so dynamically that massive instability arises. Also, by ensuring that the system is not too dynamic it prevents excessive data solely concerned with informing different components of the system about the status of bids and allocations, from significantly impairing the ability to transfer the wanted data (ie keeping the amount of signalling overhead as low as possible).

An important mechanism by which the system is prevented from being too dynamic is the use of a contract period which in the first embodiment was set at six seconds of course, different length contract periods may be used depending on the circumstances. Furthermore, the contract period length could be adjusted periodically by an operator of the system to try and establish an optimum value for any particular system. Alternatively, this process could be automated by periodically assessing a measure of the stability of the system (eg the frequency with which the rate of change of Spot Price alternates between positive and negative, or the ratio of the amount of data sent concerning bidding information in proportion to the amount of data sent in total—ie the signalling overhead) and adjusting the contract period accordingly. Another important feature in keeping the system relatively stable is the use of a Minimum Bid Price which is set to equal to or higher than the Spot Price. This acts as a form of hysteresis by which, in times of increasing demand, only bids which are likely to continue to be successful for a relatively long period of time, in view of the increasing Spot Price, are initially allocated bandwidth. This effect tends to dampen short term variations in demand to some extent.

In the above described embodiment, a simple algorithm is used to decide whether the Minimum Bid Price and the Spot Price should change at any particular time. The algorithm simply relies on the use of a threshold level of demand to cause the Minimum Bid Price to be raised higher than the Spot Price if the threshold is exceeded. The Minimum Bid Price should be raised in response to an increase in the underlying demand (and subsequently the spot Price should be raised slowly, following the Minimum Bid Price in response to an increase in the underlying demand). Thus the simple algorithm of the first embodiment essentially assumes that an increase in absolute demand above a certain threshold is indicative of an increase in the underlying demand. However, as has been mentioned above, it is expected that short-term variability will have a normal distribution above some underlying mean demand. Therefore, it is always possible that a measurement of demand in excess of the threshold is due to short-term variability rather than a change in the underlying demand (unless the threshold is set many. standard deviations higher than the mean demand which would be inefficient as lots of bandwidth would very rarely be used).

A number of alternative algorithms for determining the Spot Price and the Minimum Bid Price will now be described.

Algorithm B

A slightly more sophisticated algorithm which could be used in place of that described above will now be described which performs some averaging or integration of the instantaneous utilisation to enable short term fluctuations to be ignored. In this algorithm, the demand (ie UTIL) is sampled at frequent intervals as before (eg every 2 seconds as before) and the difference between the instantaneous utilization and the Maximum Effective Capacity (ie UTIL-MEC expressed in terms of standard deviations—i.e. the standard deviation of (UTIL-MEC) measured over long time periods or calculated from historical records) is measured. A threshold value for the sum of such measurements (of UTIL-MEC) over a predetermined number, n (e.g. n=5), of consecutive sample periods is then used to determine if the underlying demand has increased. In this way, a one off large measurement of UTIL-MEC will be ignored if it is simply due to short-term variability and other measurements of UTIL-MEC on either side of the large measurement are sufficiently small to avoid the sum of all n measurements from exceeding the threshold value. A similar lower threshold (e.g. the negative of the higher threshold) can also be used to detect a fall in underlying demand. When underlying demand is detected as having increased, MBP is set higher than SP and SP may be raised as was done before (i.e. it is treated as though UTIL≧HITHRESH had been determined in step S655). Similarly, when underlying demand is detected as having decreased, MBP (and possibly SP) is reduced as before (i.e. UTIL<LOWTHRESH is detected at step S656).

As before, certain permitted values of Maximum Effective Capacity (MEC) are predetermined and a measure of the number of times that the higher threshold value is exceeded over a long period (i.e. 1500 sample periods) is taken as a measure of whether the Maximum Effective Capacity is too high (in which case it is lowered to the next lower permitted value of the Maximum Effective Capacity) or too low (in which case it is raised to the next higher permitted value of Maximum Effective Capacity). As before, each permitted value of MEC has corresponding permitted values of the higher and lower thresholds, the general rule being that the higher threshold increases as the Maximum Effective Capacity reduces.

Algorithm B is slightly more sophisticated than the algorithm described in the first embodiment, however, it does not account for the fact that if demand is sampled at intervals which are short in relation to typical session lengths (ie the typical time that a bid is active), then even short-term demand cannot be expected to be very accurately captured by a Normal distribution (since the number of samples over which the instantaneous utilisation is being averaged is small compared to the typical session lengths). This is because most of the utilisation at one sample time will be the same as that for the previous sample time.

Algorithm C

Algorithm C can be used to generate values for an instantaneous high threshold and low threshold which can then replace the values of HITHRESH and LOWTHRESH used in the algorithm described in the first embodiment. In this case, HITHRESH and LOWTHRESH can vary in each sample period and therefore historical values of these should be stored in an array as was done with the Minimum Bid Price, the Spot Price and the sampled actual utilisation (ie UTIL).

Algorithm C relies upon the results that would be obtained from the long term behaviour of data transmission attempts with respect to a limited resource (e.g. bandwidth). It is assumed that such data transmission attempts or calls, have:

(i) a random distribution of call lengths about a stable mean;

(ii) a random distribution of bandwidth requirements within predefined limits and about a stable mean; and

(iii) a Poisson rate of arrival with a stable average.

The above set of assumptions results in a system in which mean capacity utilisation is stable, although instantaneous capacity utilisation fluctuates in a random fashion.

A model which simulates such behaviour is referred to below as a call model. Such call models are used for computing values of HITHRESH and LOWTHRESH in algorithm C. Each call model shares a number of predetermined parameters. The predetermined parameters are:

(i) the maximum capacity available;

(ii) the average call length;

(iii) the range of bandwidth requested and the average bandwidth requested with each call; and

(iv) the time between samples (e.g. 2 seconds).

These values are changed only occasionally by an operator. In order to fully specify the call model, two further parameters are required. However, the partially specified model with the four parameters as specified above held fixed, is referred to as the current generic model.

Computer simulations of the current generic model are run many times over with the value for each of the two additional parameters determined from the preceding sample period. The two additional parameters required to fully specify the call model are:

(v) the averaged capacity utilisation; and

(vi) the actual utilisation in the preceding sample period.

The network operator creates a generic model with appropriate values for the first four parameters mentioned above, intended to reflect the actual parameters of the system being modelled, if possible drawing upon relevant historic experience. The network operator then runs call models derived from this generic model at each sample time, using the current value of the Maximum Effective Capacity as the value for the fifth parameter and the sampled value for the actual utilisation (ie UTIL) for that sample. Each run of the model simulates a two second period and generates a simulated end utilisation, ie the simulated utilisation at the end of the simulated period. The operator also determines a confidence range (for example, 90%, by running, for example, 100 simulations and removing the highest 5% and the lowest 5% of the individual simulation results). The highest remaining end utilisation corresponds to HITHRESH and the lowest remaining end utilisation corresponds to LOWTHRESH. In the event that the actual utilisation (ie the value of UTIL) for the following sample period exceeds HITHRESH determined in this way, it is taken as an indication that the underlying demand has increased above the Maximum Effective Capacity. Similarly, in the event that the measured utilisation at the next sample period is lower than the LOWTHRESH this is taken as an indication that the underlying demand has moved below the Maximum Effective Capacity. To account for any such assumed variation in underlying demand the Minimum Bid Price and/or Spot Price are varied in the same way as was done in the first embodiment.

Note that none of the above described algorithms make use of the full amount of information contained within the active bids to calculate a demand curve (ie how demand would vary with changes in price). An algorithm can be used which considers all of the information contained both within active bids which are being serviced and within recently received and failed bids. To achieve this, however, a new store is required to store such failed bids for a short time after they were received—e.g. approximately 10 or 20 seconds. The algorithm described below (algorithm D) uses the information contained within all of the bid options of both active bids and recently received and failed bids, to determine a value (which is hereinafter referred to as MECPRICE) which is indicative of the price which would cause the demand (at least according to the currently active bids and the recently received and failed bids) to equal the current value of the Maximum Effective Capacity. MECPRICE can then be used to adjust the Spot Price. In this way, the system is trying to find a value for the spot Price which does in fact ensure that the underlying demand equals the Maximum Effective Capacity.

Algorithm D

Algorithm D is an enhancement to any of the above described algorithms. Algorithm D is activated whenever the general algorithm indicates that a Spot Price change is required (ie steps S661, S667 and S675 in FIG. 18). When a Spot Price change is required, the algorithm ranks all bids stored within the active bid store and within the recently received and failed bid store. In all cases, the algorithm initially considers only the first choice value bid by the user as the bid price (ie option 1 of each bid)—whether or not this choice is the one currently being served. Each of these first choice bid options is ranked in descending order of value (ie highest price per kbps (or other measure of capacity) first) and the algorithm computes the aggregate bandwidth sought from the highest bid option to any other bid option. From the resulting list of aggregate capacities, the bid option which causes the sought aggregate capacity to equal or exceed MEC is identified and referred to as LASTBID.

For all bids whose first choice maximum offered price falls below that of LASTBID in the ranked list of bid options, the second choice bid option is examined to see if it has a higher maximum offer price than that of LASTBID. Using the new, higher second choice bid options the bid options are then re-ranked to identify a new LASTBID. This process is repeated until an equilibrium is reached. During subsequent iterations of this process, bids whose options are ranked below LASTBID may move to their second, third, fourth, etc. options until an option ranking above LASTBID is found. Once they have run out of options (i.e. have only options ranking below LASTBID) bids are discarded from the process. Once equilibrium has been reached, the maximum offer associated with the bid option currently selected as LASTBID is used as the current value for the variable MECPRICE.

The above process for determining MECPRICE with a given set of bids is illustrated below with reference to the following tables 1 to 6. Table 1 shows 5 bids, A to E, each having 3 bid options. Note that each bid option includes a quantity of bandwidth sought and a maximum price in terms of 1000 ths of a cent per minute per kilobit per second. This is derived from the requested bandwidth field and the maximum offer field associated with each option within a bid by dividing the maximum of fer by the bandwidth (expressed in kilobits per second) and multiplying by 1000.

TABLE 1
(The Five Bids)

| | OPTION 1 | | OPTION 2 | | OPTION 3 | |
|---|---|---|---|---|---|---|
| BID | kbps | PRICE/kbps | kbps | PRICE/kbps | kbps | PRICE/kbps |
| A | 250 | 2 | 100 | 4 | 64 | 8 |
| B | 384 | 1.9 | 250 | 2.7 | 200 | 5 |
| C | 196 | 1.7 | 100 | 3.3 | 64 | 6 |
| D | 500 | 1.5 | 300 | 2 | 150 | 4 |
| E | 300 | 1 | 200 | 2 | 100 | 3 |

Table 2, which is given below, sets out the first round of the algorithm in which the first options of each bid are ranked according to price per kbps. The column marked agg.kbps indicates the aggregate capacity sought from the highest bid option to any other bid option. In the present example, MEC is 800 kbps. The LASTBID is therefore bid C.

TABLE 2
(Round 1)

| Bid | kbps | agg · kbps | Price/kbps |
|---|---|---|---|
| A (1) | 250 | 250 | 2 |
| B (1) | 384 | 634 | 1.9 |
| C (1) | 196 | 830 | 1.7 |
| D (1) | 500 | 1330 | 1.5 |
| E (1) | 300 | 1630 | 1 |

In Table 2, the number in the parenthesis following the letter identifying each bid indicates the currently selected bid option. Since the LASTBID determined on the first round was bid C (since it was C's request for an additional 196 kbps which pushed the aggregate capacity sought over MEC), for the next round the second options for both bids D and E are selected and the bid options are re-ranked. The result is shown in Table 3 below.

TABLE 3
(Round 2)

| Bid | Kbps | agg · kbps | Price/kbps |
|---|---|---|---|
| A (1) | 250 | 250 | 2 |
| E (2) | 200 | 450 | 2 |
| D (2) | 300 | 750 | 2 |
| B (1) | 384 | 1134 | 1.9 |
| C (1) | 196 | 1330 | 1.7 |

LASTBID in this round is therefore B. For the next round option 2 for bid C is selected and the bid options are re-ranked. The result is shown in Table 4 below.

TABLE 4
(Round 3)

| Bid | Kbps | agg · kbps | Price/kbps |
|---|---|---|---|
| C (2) | 100 | 100 | 3.3 |
| A (1) | 250 | 350 | 2 |
| D (2) | 300 | 650 | 2 |
| E (2) | 200 | 850 | 2 |
| B (1) | 384 | 1234 | 1.9 |

LASTBID in round 3 is therefore E. For the next round the option 2 for bid B is selected and the bid options are re-ranked. The result is shown in Table 5 below.

TABLE 5
(Round 4)

| Bid | | kbps | Price/kbps |
|---|---|---|---|
| C (2) | 100 | 100 | 3.3 |
| B (2) | 250 | 350 | 2.7 |
| A (1) | 250 | 600 | 2 |
| D (2) | 300 | 900 | 2 |
| E (2) | 200 | 1100 | 2 |

LASTBID for round 4 is therefore bid D. For the next round, option 3 is used for bid E and the bid options are re-ranked. The result is shown below in Table 6.

TABLE 6
(Round 5)

| Bid | | kbps | Price/kbps |
|---|---|---|---|
| C (2) | 100 | 100 | 3.3 |
| E (3) | 100 | 200 | 3 |
| B (2) | 250 | 450 | 2.7 |
| A (1) | 250 | 700 | 2 |
| D (2) | 300 | 1000 | 2 |

LASTBID at the end of round 5 is therefore bid D. Since there are no lower ranked bids, an equilibrium has been reached. MECPRICE is therefore set to D's currently selected price per kbps, ie 2.

Having determined a value for MECPRICE in the above described manner, the value of the Spot Price may then be modified (increased or decreased as determined by steps S665, S673 or S677 in FIG. 18) in the following manner:

i) when increasing the Spot Price calculate:

Spot Price=last Spot Price+the greater of

(a) (W % of (MECPRICE−last Spot Price), or

(b) the increase in Spot Price at the last sample period; and

ii) when decreasing the Spot Price calculate:

Spot Price=last Spot Price−the greater of

(a) W % of (last Spot Price−MECPRICE), or

(b) the decrease in Spot Price at the last sample period.

Provided that the Spot Price is not allowed to fall lower than some fixed minimum (MINSP).

Apart from the above described modifications to how the Spot Price is modified, the algorithm described above with reference to FIG. 18 may be used as indeed may the algorithms B or C described above.

Further General Comments About Embodiment 1

The first embodiment describes an example in which existing bids cannot be modified. However, in general, it is possible to modify a bid. One way of doing this is to allow bidders to send a modified bid which includes the bid identifier of the original bid (in the same way as a confirmation or termination request does) but which modifies the bid options in some way (e.g. by raising or lowering the requested amount of bandwidth or the maximum offer in some way). On receipt of such a modified bid, the bandwidth broker amends its record of the bid in the active bid store. When the bid is next reviewed, the modified bid options are considered. The price (i.e. token price) used when reviewing such modified bids will be the same as it would have been had the bid remained unchanged in some cases. However, in other cases, the network operator can use an alternative price (e.g. the MBP) to prevent abuses occurring when the MBP is higher than the SP (e.g. by a bidder initially requesting only a small quantity of bandwidth until he has been charged the SP and then modifying the bid to request a much larger quantity of bandwidth for which he would never have to pay the MBP).

Also, in the first embodiment, the maximum amount of bandwidth available is considered to be fixed. In many cases, this will not be so and in those cases the gate controller, or a network operator, will inform the bandwidth broker accordingly. In general, the gate performance monitor will receive status checks from the gate controller informing about the general status of the control data link (i.e. to confirm that it has not gone down).

The first embodiment allowed only bidders within the same domain as the bid router and the bandwidth broker to place bids. This meant that a simple security mechanism was suitable. However, in general this will not be the case. Therefore, the system can preferably be extended to accomplish any of the following security functions:

i) securing the confidentiality of commercially sensitive user data;

ii) authenticating the user as the proper user of an account either with the operator of the bid router and/or bandwidth broker or with a third party billing organisation (eg a credit card company or an Internet payment provider) and checking the status of such an account; and

iii) authenticating that bids came from the user they claim to have come from.

(i) above may be achieved using commonly available encryption techniques such as Hyper Text Transfer Protocol Secure; (ii) may be achieved using challenge and response techniques (possibly involving the use of digital signatures); and (iii) may be achieved using encryption techniques involving digital signatures and Private/Public key encryption techniques.

In the above described system, only a single party to each data communication session, namely the transmitter of data (which, in the example, was website application A) was able to bid for bandwidth over the constraining data link 40. The second embodiment to be described below however enables either or both of the transmitter of the data (eg the website application) and the receiver of the data (e.g. Personal Computer 10-1) to bid for bandwidth allocation across the constraining data link.

Also, in the system of the first embodiment, only a single mechanism was described by which the bidder could be billed for procured bandwidth allocation. In alternative embodiments, many different mechanisms for billing bidders are supported. Typically, either the bid router or the bandwidth broker takes responsibility for ensuring that billing is performed. In general, this will involve obtaining authorisation from a separate entity (e.g. a billing centre of an ISP or a third party such as Visa) to spend up to a certain small amount.

When the small amount is used up the bid router or bandwidth broker issues a bill to the separate entity and requests authorisation to spend up to a further authorised small amount. Note that in many cases, business user accounts might be operated (by say an ISP billing centre) on open limits and then no real-time credit checking takes place. Thus, in the second embodiment described below, it is additionally possible for any of the bidders (either transmitters or receivers of data) to employ third party services (eg. a credit card company such as Visa).

The second embodiment described below illustrates a number of further improvements to the first embodiment. These include allowing the website application's bidding program to consider a Class of User field when determining what bid options to use. A Class of User field is a well-known feature found in website applications by which each user (ie visitor to the website) is assigned to one of a number of different classes in dependence on the user's previous behaviour with respect to the website—eg how much money the user has spent previously, how many times he has visited the website, etc. Another improvement described in the second embodiment is the extension of the information contained within the bid options, to include a type of service field. Type of service is a feature of Internet Protocol which enables datagrams requiring different types of service to be routed over one or more networks in different ways. This feature can be useful in systems where different constraining bottle necks occur for different types of service.

### SECOND EMBODIMENT

The structure of the system of the second embodiment is identical to that of the first embodiment. The differences between the first and second embodiments lie: (i) in the personal computer 10-1 which in the second embodiment has stored in its memory a bidding program and bidding preferences associated with the bidding program; (ii) in the bid router which does not in this embodiment require all bidders to have an account set up with it for the purpose of procuring bandwidth across data link 40; and (iii) in the bandwidth broker which is adapted to allow cost sharing of the session and in that it includes means for billing a third party (eg Visa) to obtain payment from bidders not having an account with the bid router.

Bid Enabled Personal Computer

Referring now to FIG. 19, the personal computer 10-1 in the present embodiment comprises a processing unit 1010; a monitor 1020 connected to the processing unit and having a screen 1022 adapted to display a bidding program interface display area 1024; a memory 1030 including a bidding program 1031 and an associated data store of bidding preferences 1032; a keyboard 1040; and a mouse 1042. As before, the personal computer 10-1 has a connection leading to modem 20-1 and this is shown as being connected to the processing unit 1010.

The bidding preferences 1032 stores data which is required by the bidding program 1031. In particular, it includes the following items of data:

1) Default Mode Field. This field is used to indicate whether the bidding program should automatically generate bids as appropriate or alternatively if it should prompt the user at appropriate times.

2) The Bidder's Billing Identifier. In the present example, this field holds the Visa card number, expiry date and the card holder's name of the Visa card used to pay for procured bandwidth.

3) The last used Bidder's Bid Identifier. This field holds the last used serial number. This is updated every time a new bid is created.

4) A Number of Default Sets of Bid Options. This field holds a number (in the present case 3) of different sets of bid options which can be used in different circumstances together with data indicating the circumstances under which a particular set should either be used automatically or offered as a highlighted suggested set when prompting the user depending on the value of the first field above.

Three example sets are listed below

a) set one (e.g. for Internet telephone)

| Bandwidth | Type of Service | Maximum Offer |
|---|---|---|
| 100 kbps | #3 | 1 cent/min |

payment options: other party may contribute; own contribution 0-100%

protocol: UDP

Circumstances when this set should be used: when setting up an Internet telephone conversation.

b) set two (e.g. Internet video phone)

| Bandwidth | Type of Service | Maximum Offer |
|---|---|---|
| 2 Mbps | #3 | 2 cents per min |

payment options: other party must contribute, own contribution 0-50%

protocol: UDP

| | | |
|---|---|---|
| 1 Mbps | #3 | 2 cents per min |

payment options: other party must contribute, own contribution 0-50%

| | | |
|---|---|---|
| 333 kbps | #3 | 1 cent per min |

payment options: other party must contribute, own contribution 0-50%

Circumstances for use: when setting up an Internet video phone session.

c) set three (e.g. general)

| Bandwidth | Type of Service | Maximum Offer |
|---|---|---|
| 2 Mbps | #3 | 2 cent per min |

payment options: other party must contribute, own contribution 0-33%

| | | |
|---|---|---|
| 1 Mbps | #3 | 1 cent per min |

payment options: other party must contribute, own contribution 0-100%

| | | |
|---|---|---|
| 333 kbps | #3 | 0.5 cents per |
| | | min |

payment options: other party may contribute, own contribution 0-100%

protocol: unspecified

Circumstances for use: when neither set one nor set two is applicable.

The type of service field can contain one of three possible different codes: 1) #1 representing normal service, 2) #2 representing low jitter service, and 3) #3 representing low latency service.

5) The bidder's private encryption key.

6) The bid router's address details.

7) A record of previous sessions including time and date, duration and total cost.

The detailed operation of the bidding program 1031 is illustrated in FIG. 21. Upon commencement at step S1052, control flows to step S1053 where it is determined if a request to download data from a source connected via the modem 20-1 has been generated. If no such request has been generated, control loops back to step S1053 until the generation of such a request is detected. When such a request has been detected, control passes to step S1054 where the default mode field of the bidding preferences is interrogated to determine whether the user should be prompted or whether a bid should be generated automatically. In the event that it is determined that the user should be prompted then control is passed to step S1055.

In step S1055 the bidding program causes an interface display to be displayed on screen 1022 in the bidding program interface display area 1024 and the user is prompted within the display area as to whether or not he or she would like a new bid to be sent for the proposed download of data. The interface lists all of the sets of bid options available for the user to chose from and the appropriate one is highlighted in accordance with the circumstances for use fields. In this way, if the user does want to send a bid, the relevant bid set to use is established and control is passed to step S1056. In the event that the user does not wish to send a bid control is passed back to step S1053. If the user does select to send a bid, control is passed to step S1056 in which the associated bid options for whichever set was selected by the user are obtained from the bidding preferences 1032 and then control is passed to step S1058. If it is determined, at step S1054, that the bid is to be generated automatically, then control is passed to step S1057 where the appropriate bid details are obtained by interrogating the bidding preferences table to determine firstly which is the correct bid set to chose given the prevailing circumstances and then the associated bid options are read from the bidding preferences 1032. Thereafter, control is passed to step S1058 in which a new bid is generated. The bid will have the form given below:

1. Bidder's Bid Identifier.

This is obtained by reading the last used Bidder's Bid Identifier from the bidding preferences table and incrementing it by one (when this is done the last used Bidder's Bid Identifier field within the bidding preferences is also updated to the newly incremented value).

2. Correspondent's Bid Identifier.

This field is left blank in the present embodiment. A value will be stored in here by the Bandwidth broker if it finds a matching bid (this is described in greater detail below).

3. Bidder's IP Address and Port Number.

This information is obtained from the request to download data generated by the part of the personal computer's operating system dealing with the communication.

4. The correspondent's IP address and port number.

These details are obtained from the request to download data.

5. Protocol type. This is also obtained from the request to download data.

6. Bidder's billing identifier. This information is obtained from the bidding preferences.

7. Bidders digital signature. This is generated using the bidder's bid identifier and the bidder's private key obtained from the bidding preferences.

8. Set of Bid Options

These are chosen from the bidding preferences in the manner described above.

The bid thus generated is then transmitted as a bidding message to the appropriate bid router in step S1058 using the bid router's address details also stored within the bidding preferences.

Upon completion of step S1058, control is passed to step S1059 where it is determined whether or not a response has been received. When a response has been received control is passed to step S1060 where it is determined if the bid has been successful. If the bid was not successful, then control is returned to the start, via step S1068 and a new triggering event is awaited in step S1053. If the bid was successful then control is passed to step S1061 where the bidding program 1031 determines whether or not a termination condition has been met.

In the present embodiment, the termination conditions include a direct instruction from the user via the bidding program interface to terminate the session or to reduce the maximum offer for all possible bidding options to zero. Alternatively, a termination condition can be set and stored in the bidding preferences. An example of such termination condition might be to determine if the modem link has been idle for more than a predetermined length of time such as 30 seconds. In the event that the termination condition has not been met, control is passed to step S1062 where the bidding program 1031 determines if the bid has more than 12 seconds left before expiry. In the event that it does, then control is passed back to step S1061 otherwise, control is passed to step S1063 where a confirmation message is transmitted to the bid router and then control is passed back to step S1061. Note that in this embodiment, the personal computer 10-1 allows 12 seconds for the confirmation to reach the bandwidth broker since it is more distant than the website host server.

In the event that it is determined in step S1061 that a termination condition has been met, control is passed to step S1064. In step S1064, a termination request is generated and transmitted to the bid router. The termination request includes the bandwidth broker's bid identifier (this is obtained from one of the notifications transmitted by the bandwidth broker and forwarded to the personal computer 10-1 by the bid router). Note that instead of requesting termination of the session, the bidding program can alternatively reduce its maximum offer for all bid options to zero. This will not always result in the session being terminated, since the user's bid may be part of a shared bid and the other contributor to the bid may have a maximum offer sufficiently high to permit the session to be maintained or possibly reduced to a lower bandwidth allocation greater than zero. Alternatively, the Spot Price charged to the user for the bandwidth might actually be zero in any case. Upon completion of step S1064, control is passed to step S1065 where the flow is delayed for a short while before passing control onto step S1066 where it is determined if notification of termination has been received. If it has not, then control is returned to step S1064 and the termination request (or the request to modify the bid to offer a maximum price of zero for all bid options) is re-transmitted and then after a further small delay (of for example 10 seconds) control is passed on again to step S1066. Once the notification of termination has been received, control is passed to step S1067 where a record of sessions stored within the bidding preferences is updated to include the details of the presently ended session, including the length of the session and the total cost of the session. Upon completion of step S1067, control is returned via step S1068 to the start step S1050.

The bidding program 1031 also includes software (not shown) for permitting the user to modify various details stored within the bidding preferences 1032.

In the present embodiment, the bandwidth broker is modified slightly compared to the bandwidth broker of the first embodiment to enable the bandwidth broker in the second embodiment to deal with the possibility of cost sharing. One such modification is the inclusion of a matching bid store which is used, in the present embodiment, to store bids (hereinafter referred to as potentially matching bids) which either have included in their payment options field that they require at least some contribution from another party (see for example, set two (internet video phone session) of the sets of bid options described above with reference to FIG. 21), or which allow some contribution from another party and for which no matching bid can be found when the bid is first received. Once a bid has been stored within the matching bid store for a predetermined waiting period without being matched to a matching bid, it is processed to determine if it can support a bid for bandwidth on its own. If it cannot, a failure notification is generated and sent back to the bidder. After the bid has been processed (successfully or unsuccessfully), it will be deleted from the matching bid store. However, if a matching bid is received by the bandwidth broker before the earlier bid is deleted from the matching bid store, then the two bids will be matched up and processed together in the manner described in greater detail below.

Another important modification is the inclusion of a matched bids store. This store keeps a record of all bids which have been matched together and the resulting composite bid set (this is described in greater detail below).

Another important modification is the inclusion of a cost sharing function module. This checks all new incoming messages and processes those which concern cost-sharing. Its basic function is to match up bids relating to the same session (ie matching bids) where possible and to generate and maintain composite bids in which two or more parties are sharing the cost of the session.

An example of the operation of the cost sharing function module is shown in FIG. 22. The operation commences at step S1080 and thereafter, control is passed to step S1081 where the bandwidth broker determines if a new bidding message has been received. If it has not, then control is passed back to the start step S1080. Once a new bidding message has been received, control is passed from step S1081 to step S1082, where the bandwidth broker determines if the bidding message relates either to a new bid which indicates the possibility of cost sharing or to an old bid currently being managed by the cost sharing function module as described below. If the bidding message does not relate to either such bid, then control is passed to step S1083 where the processing of the bidding message is carried out as was described above in the initial processing of new bidding messages module 534 of the first embodiment.

In the event that the determination of step S1082 is positive, control is passed to step S1084. If the bidding message is a new bid indicating the possibility of cost sharing, the cost sharing function module searches for a potential contributing bid. To do this, the program searches through the active bid store 544 and the matching bid store (not shown). If no matching bid is found after searching these stores, the bid is itself stored in the matching bid store in case a matching bid is subsequently received. In the present embodiment, the bid is stored in the matching bid store for up to two seconds, after which the processing of the bid moves to step S1085. If, in the meantime, a matching bid is found, both bids are passed to the next step S1089 for joint processing. If a matching bid is found in the active bid store 544, the process is suspended until the active bid is due for review and then both matching bids are passed to step S1089.

In step S1084 the bandwidth broker determines whether a matching bid has been located. If it has not, then control is passed to step S1083 and the bid is processed normally. To determine if one bid matches another, the cost sharing function firstly determines if the bid contains a non-null value in its correspondent's bid identifier field and if so, it simply searches all other bids to see if it can find a matching value in the bidder's bid identifier field is one of those other bids. similarly, it will check that the Bidder's bid identifier field of the bid to be matched does not correspond to the value held in the correspondent's bid identifier field of any of the other bids. Secondly, the cost sharing function module attempts to match the bids by reference to the parameters which identify what is commonly referred to as a flow. These parameters are the source and destination IP addresses, the source and destination port numbers (if given) and the type of protocol used (e.g. TCP or UDP) (if given). These details can be found in the Bidder's IP address and port number field, in the correspondent's IP address and port number field, and in the protocol type field.

If a matching bid is found in step S1084, then control is passed to step S1089 where the bid options are examined to determine if there is a possibility of forming at least one matching bid option where both parties between them are prepared to contribute 100% of the cost of the session or alternatively if there is a possibility of forming an individual bid option where one party is prepared to contribute 100% of the cost of the session individually. If, at least one such bid option can be found, control is passed to step S1090, otherwise control is passed to step S1087, where a failure notification is generated and sent to the or each bidder. The notification includes the current value of the Minimum Bid Price, an indication of how soon a new bid from the bidder for the same session will be processed and an indication that the bid failed. After generating and sending this notification, the or each new bid is deleted (from the matching bid store). After completing step S1087, control is returned to the start step S1080. If the determination of step S1089 is positive, then control is passed to step S1090 where a composite bid set is compiled. An attempt is made firstly to match bid options in terms of the amount of bandwidth bid for. A bandwidth match is considered to exist if the respective bandwidths are equal within a certain tolerance (e.g. ±10%). Also, each pair of the percentages of “own contribution” of both bid options within the pair are examined to see if they can be added to 100%. Such bid options are hereinafter referred to as matching bid options. Each pair of matching bid options is used to generate a joint bid option in which the maximum total offer of the joint bid option is the sum of the maximum offers from each individual matching bid option where possible. This may not be possible where the individual maximum offers are not in an appropriate ratio to one another to correspond to the permitted ranges of the percentage of “own contributions” indicated in each bid. In such a case, the maximum offer of the joint bid option is formed by determining the maximum contribution from each matching bid option which enables the requirements of the “own contribution” percentages to be met, and summing these maximum contributions together. In the event that there are some non-matching bid options, the payment options of each non-matching bid option is examined to see if it is prepared to contribute 100% to the cost. Such bid options are hereinafter referred to as viable individual bid options. The composite bid set may include joint bid options, viable individual bid options or both.

The thus formed composite bid set is stored in the matched bids store together with the original bids. Any messages concerning the original bids are processed accordingly by the cost sharing function module which may modify the composite bid set accordingly and resubmit the modified bid set when appropriate (e.g. as and when a bid is confirmed). Upon completion of step S1090, control is passed to step S1091 where the composite bid set is sent for processing as a normal bid except that whenever a notification is issued it is directed to the cost sharing function module where it is further processed into two notifications, one for each party, in which the contribution of each party is calculated and included in the notification. Upon completion of step S1091, control is passed back to the start step S1080.

As an illustration of bid matching, the bid options of two matching bids are set out below together with the resulting composite bid set.

| | |
|---|---|
| First Bid | |
| 2 Mbps | 2 cents/min |
| payment options: | other party may contribute; |
| | own contribution 0-100% |
| 1 Mbps | 2 cents/min |
| payment options: | other party may contribute; |
| | own contribution 0-100% |
| 0.5 Mbps | 2 cents/min |
| payment options: | other party may contribute; |
| | own contribution 0-100% |
| Second Bid | |
| 1 Mbps | 2 cents/min |
| payment options: | other party may contribute; |
| | own contribution 0-33% |
| 333 kbps | 1 cents/min |
| payment options: | other party may contribute; |
| | own contribution 0-67% |
| 112 kbps | 0.5 cents/min |
| payment options: | other party may contribute; |
| | own contribution 0-100% |

Composite Bid Set

| Bandwidth | | Maximum Offer | Party 1:Party 2 |
|---|---|---|---|
| 2 | Mbps | 2 cents/min | 100:0 |
| 1 | Mpbs | 3 cents/min | 67:33 |
| 0.5 | Mbps | 2 cents/min | 100:0 |
| 112 | kbps | 0.5 cents/min | 0:100 |

When trying to match up the different quantities first of all, the 112 kbps quantity (the third option of the second bid) cannot be matched to any option in the first bid, but since the second bid is prepared to pay up to 100% for this bid option, this bid option can stand on its own and so it does appear in the composite bid set as a viable individual bid option. The 333 kbps quantity (the second bid option in the second bid) cannot be matched to any option in the first bid and since this bid option requires a contribution it cannot stand on its own and so this bid option does not appear in the composite bid set. The 0.5 Mbps option in the first bid cannot be matched to an option in the second bid but can stand alone, thus it appears in the composite bid set as a viable individual bid option. The 1 Mbps options in both bids do match and are thus combined. In this case, however, the maximum which the second bidder is prepared to contribute is 33% of the total and therefore the maximum amount offered by the second bidder is 1 cent per minute giving a total maximum offer of 3 cents per minute for the joint bid option with the acceptable contribution ratio of 2/3 to the first bidder and 1/3 to the second bidder. Finally, only the first party has made an offer for the quantity 2 Mbps, but since the first party is prepared to pay 100% contribution, this bid option survives as a viable individual bid option and is therefore added to the composite bid set.

The other significant extension to the functionality of the bandwidth broker program in the present embodiment compared to the first embodiment is in the credit management module 536 which, in addition to the functionality described for it in the first embodiment is extended to be able to cope with third party billing systems. For example, in the present embodiment, the user of the personal computer 10-1 has set his bidding preferences to include his Visa card details in every new bid generated. When a new bid is received by the bid router with third party billing details, such as Visas, the bid router takes no billing action of its own. Instead, when the new bid arrives at the bandwidth broker, the credit management module 536 determines that the bid includes third party payment details and it directly contacts the third party involved (e.g. Visa) to check that the third party will authorise payment from the account identified in the billing identifier field. The credit management module 536 seeks authorisation from the third party billing system to charge up to a predetermined small sum (e.g. $10). If the request is authorised the credit management module 536 monitors the cost of the session and, in the event that all of the authorised amount is used up, it will automatically seek further authorisation for a further small sum of money from the third party billing system. At the end of the session, the third party billing system is sent a bill for the total cost of the session.

Referring now to FIG. 23, the website bidding program of the second embodiment is modified slightly from that of the first embodiment, primarily to enable an invitation to share a bid to be transmitted to a personal computer requesting content data from the website. Additionally, the website bidding program of the second embodiment includes an additional enhancement by which different users may be categorised into one of a plurality of different user classes and the amount which the bidding program is prepared to bid for a different bandwidth option may be varied in dependence on the user class for any particular user.

The method commences at step S1100 thereafter control is passed to step S1101 in which a request for content data is awaited When such a request has been received control is passed to step S1102 where the user class of the user requesting data is determined. The ways in which a user may be categorised into one of a plurality of different user classes are well-known in the art and will not be described here in detail. However, as an illustrative example, the website bidding program of the present embodiment has only two different user classes, known or unknown. New users are invited to register with the website and users which have already registered with the website on a previous visit are invited to “log-on”. After logging on to the website, the user is categorised as belonging to the known class while those users who do not register and/or do not log on even if they have previously registered are categorised into the unknown user class.

Upon completion of step S1102, control is passed to step S1103 where it is determined if the requested content data is bid enabled for the previously determined class of user. To do this, each item of content data available for download to a user includes a field which indicates whether or not it is bid enabled for each of the user classes. If it is not bid enabled, then control is passed to step S1104 where the requested content data is transmitted to the user using best efforts only. Upon completion of step S1104 control is returned to the start step S1100 and a new request for content data is awaited. If it is determined in step S1103 that the content data is bid enabled for the respective user class, then control is passed to step S1105 where a new bidder's bid identifier is generated. Upon completion of step S1105, control is passed to step S1106 where the bidder's bid identifier is made available to higher level applications running in conjunction with the bidding program in case a higher level application wishes to generate and transmit an invitation to contribute to the cost of the session to the correspondent (ie the personal computer which initially requested the content data). Such an invitation may then include the bidder's bid identifier (ie the bid identifier of the website bidding program) which can then be used by the personal computer 10-1 if it generates a bid in response to the invitation. As those skilled in the art will appreciate, including the website's bid identifier in the new bid from the personal computer makes the search for a matching bid from the website bidding program faster and more reliable. Upon completing step S1106, control is passed to step S1107 where a small delay occurs before passing control onto step S1108. In the present example, a small delay of approximately 2 seconds is used. In step S1108, a new bid bidding message is generated and transmitted to the bid router for onward transmission to the appropriate bandwidth broker. Note that the new bid will include the same bidder's bid identifier as was transmitted to the correspondent (e.g. personal computer 10-1) in the invitation.

Upon completion of step S1108, control is passed to step S1109 where a response to the bidding message is awaited from the bandwidth broker. Upon receipt of a response, control is passed to step S1110 where the website bidding program determines if the bid was successful. If the bid was not successful, then control is passed to step S1104 and the requested content data is transmitted to the correspondent (personal computer 10-1) using best efforts. If, however, the bid was successful, then control is passed to step S1111, where the guaranteed bandwidth allocated for the session is determined and data is transmitted to the correspondent (personal computer 10-1) at a corresponding rate. After commencing transmission, and while transmission continues, control is passed to step S1112 where the website bidding program determines if all of the requested content data has been transmitted or if some other termination condition has been met (e.g. a general time out or the maximum cost of the session being exceeded). In the event that no termination condition has yet been met, control is passed to step S1113 where it is determined if the bid has more than six seconds left before it is due to expire without a confirmation being received. If the bid does have more than six seconds left, then control is passed back to step S1112 until either a termination condition is met or the bid has less than six seconds left before expiry. When the bid has less than six seconds left before expiry, then control is passed to step S1114 where a confirmation signal is transmitted to the bid router for onward transmission to the bandwidth broker. Upon completion of step S1114, control is returned to step S1112.

If it is determined at step S1112 that all of the content data has been transmitted or some other termination condition has been met, then control is passed to step S1115 where a termination request is generated and transmitted to the bid router for onward transmission to the bandwidth broker. Upon completion of step S1115, control is passed to step S1116 where a small delay is generated before passing control onto step S1117 where the website bidding program determines if a notification of termination has been received back from the bid router. If no such notification has been received, then control is returned to step S1115 and a further termination request is generated and transmitted to the bid router for onward transmission to the bandwidth broker. This continues to happen until the notification of termination has been received, where upon control is returned to the start step via step S1118.

General Comments on the Second Embodiment

The above described second embodiment illustrates how more than one party can contribute to the cost of a data transmission session (in particular the transmitter of the data and the receiver of the data). The concept can be extended to permit three or more interested parties to contribute towards the cost of a data transmission session. In each case, the interested party submits a bid with an indication that it is prepared to form a contribution towards a larger bid for the same data transmission session. These bids are then assimilated by the bandwidth broker into a composite bid. There are numerous ways in which the parties wishing to store the costs of a session can co-ordinate their actions to assist the bandwidth broker. One option is to permit one party to indicate that he is prepared to pay a certain maximum amount of money (e.g. 1 cent/min) for whatever bandwidth. Such a bid can then be used to form joint bid options with all bid options submitted by the other party or parties.

The basic structure of the system described in the second embodiment is still restricted to allocating bandwidth across a single bandwidth constraining link or bottleneck. The third embodiment to be described below illustrates a case in which a bandwidth is allocated across two such bottlenecks. Such a system involves two gate controllers and two bandwidth brokers (one associated with each gate controller). In this embodiment, a single bid router is responsible for routing bidding messages which it receives to the most appropriate bandwidth broker and the functionality of each bandwidth broker needs to be extended to permit single bids to be split up into two bids for data transmission sessions where data is to be transmitted through both bottlenecks in order to allow bandwidth allocation within both bottlenecks.

### THIRD EMBODIMENT

The architecture of the data communication system according to the third embodiment is illustrated in FIG. 24. For purposes of clarity, this third embodiment does not permit bidding contributions from more than one party of a communication. Similar items to those in FIG. 1 have been given like reference numerals in FIG. 24. Thus the basic structure is the same with a PC 10-1 connected via a modem 20-1, a multiplexing arrangement 30 and a data link 40 having a best efforts portion 42 and a guaranteed quality of service portion 41 to a single domain 51 (i.e. a network or combination of networks which are controlled by a single party such as an Internet service provider). In this embodiment, the single domain 51 is much larger than the server farm 50, with many servers connected over a wide area via a Wide Area Network 71 (WAN “A”). In this embodiment, the single domain 51 also has a second data link 43 with a guaranteed quality of service portion 44 and a best efforts portion 45 which is connected to a server farm 52. Note that any system in which bandwidth or quality of service generally can be allocated over more than a single constraining data link such as in the present embodiment is hereinafter referred to as a multi-node system. Similarly, a bandwidth broker which is adapted to communicate with other bandwidth brokers to ensure bandwidth allocation over more than a single constraining data link is referred to as a multi-node enabled bandwidth broker.

Also illustrated in FIG. 24 is a website B 95, which is connected to the single domain 51 via a local area network 72 and the data link 43. Within the single domain 51, there is a wide area network 71 and three gate controllers 61, 62, 63 connected to the wide area network 71.

The gate controllers 62; 63 control the amount of data travelling over the wide area network 71 so that it behaves predictably. To do this, at any one time, the network operator (not shown) will dictate how much data each gate controller can allow onto the wide area network 71. The gate controllers 61, 62, 63 are referred to as first, second and third Gate controllers respectively. The first gate controller 61 controls data travelling over the data link 40 to the PCs 10, as before. The second Gate controller 62 controls data travelling over the data link 43 from the server farm 52. The third gate controller 63 controls data travelling from the internet 100.

Also connected to the wide area network 71 is a first bandwidth broker 93 and a second bandwidth broker 94. In the present embodiment, the first and second bandwidth brokers 93, 94 are hosted by separate servers (not shown) each having a direct link to the first and second gate controllers respectively as well as links to the wide area network 71. Also connected to the wide area network 71 is a first bid router 91. The first bid router 91 is similar to the bid router of the first embodiment except that it stores details of both the first and second bandwidth brokers and is able to route bidding messages which it receives to the appropriate bandwidth broker as is described in greater detail below. The first bid router 91 also has a direct link to both the first bandwidth broker 93 and the first gate controller 61 as well as a link to the wide area network 71. Server farm 52 also includes a second bid router 92 connected to the local area network 72 which also includes a connection to a second Wide Area Network 73 (WAN “B”). The second bid router 92 can route bids for both WAN A71 and WAN B73.

FIG. 25 is a signal flow diagram illustrating the signals which flow between the various elements of the data communication system illustrated in FIG. 24 during a single example of a data transmission session.

In the present example, a user of personal computer 10-1 is visiting website B 95 and decides to download a promotional audio video clip by clicking on an associated icon displayed on his screen. This action causes a request signal 265 to be generated and transmitted to website B. The path taken by the request signal 265 is via modem 20-1, multiplexer arrangement 30, the best efforts portion 42 of data link 40, first gate controller 61, wide area network 71, second gate controller 62, local area network 72 and finally to website B. Upon receipt of the request signal 265, the website B bidding program determines that the requested content data is bid enabled and therefore generates a new bid 266 which it transmits to the second bid router 92. When the second bid router 92 receives the new bid, it determines that website B 95 has a genuine account with it and that the account has funds available. The bid router 92 modifies the bid to include the bidder's account details (ie those of website B) and forwards the bidding message onto the second bandwidth broker 94. In order to know which bandwidth broker to forward the new bid onto, the bid router 92 examines its bandwidth broker and associated destination IP addresses store 46 from which it determines that data travelling from website B 95 to personal computer 10-1 must travel first through data link 43 controlled by the second gate controller 62 which is controlled by the second bandwidth broker 94.

Thus, modified bid 267 is transmitted from the bid router 92 to the second bandwidth broker 94. Upon receipt of modified new bid 267, the second Bandwidth broker 94 processes the new bid in a manner described in greater detail below and determines that the bid must be apportioned so as to bid for allocation both over data link 44 and data link 41. As a result of this determination, the second Bandwidth broker 94 apportions the bid and transmits a provisional bid 268 to the first Bandwidth broker 93 which controls the allocation of bandwidth in data link 41. Upon receipt of the provisional bid 268, the first Bandwidth broker 93 processes the provisional bid and returns a provisional response 269 which indicates that at least one of the provisional bid options would be accepted. Upon receipt of the provisional response 269, bandwidth broker 2 determines which bid option to choose so as to ensure matching bandwidth allocations across both data link 44 and data link 41 and then transmits a definitive bid 270 to the first Bandwidth broker 93. At the same time, the second Bandwidth broker 94 issues an instruction 271 to the second Gate controller 62 instructing it to allow datagrams from website B to be transmitted through the guaranteed quality of service portion 44 of the data link 43. Upon receipt of the definitive bid 270, the first Bandwidth broker 93 processes the bid and issues a similar instruction 272 to the first Gate controller 61 instructing it to allow the transmission of datagrams from website B to personal computer 10-1 at the appropriate rate. Shortly after receiving the instruction 271, the second Gate controller 2 issues an acknowledgement 273 back to the second bandwidth broker 94 informing it that the requested allocation has been made. Similarly, shortly after receiving the instruction 272, the first gate controller 61 transmits an acknowledgement 274 back to the first bandwidth broker 93 confirming that the requested allocation has been made. On receiving acknowledgement 274, the first Bandwidth broker 93 sends a definitive response 275 indicating that the definitive bid 270 has been successful. Upon receipt by the second Bandwidth broker 94 both of the definite response 275 from the first Bandwidth broker 93 and the acknowledgement 273 (which causes an internal definitive response from the part of the second bandwidth broker dealing with allocation of its own resource to be sent to the part of the second Bandwidth broker dealing with bid apportionment), the second bandwidth broker generates a notification 276 which is transmitted from the second Bandwidth broker 94 to the second bid router 92.

On receipt of the notification 276, the second bid router 92 forwards the notification on as forwarded notification 277 to website B 95. Upon receipt of the forwarded notification 277, website B determines that it has been allocated bandwidth to personal computer 10-1 as requested, it notes the amount of bandwidth thus allocated and commences transmitting content data to the personal computer 10-1 at an appropriate rate as indicated by data signal 278.

After completion of the first contract period, the bid from website B is reviewed again by the bandwidth broker 94 which again generates a provisional bid 279 which it transmits to the first bandwidth broker 93. The part of the second Bandwidth broker 94 dealing with apportionment will also internally pass a provisional bid to the part of the second bandwidth broker dealing with allocation of its own resources but this is not shown. Upon receipt of the provisional bid 279, the first Bandwidth broker 93 will process the provisional bid 279 and issue a provisional response 280 back to the second Bandwidth broker 94. The provisional response 280 will be processed by the second Bandwidth broker 94 and in response it will generate and transmit a definitive bid 281 for transmission to the first Bandwidth broker 93 (again, an internal definitive bid will also be sent from one port of the second bandwidth broker to another port). In response to the definitive bid 281, the first Bandwidth broker 93 will issue a definitive response 282. In this example, the definitive bid 281 is substantially identical to definitive bid 270 and the price charged by both Bandwidth brokers has not been increased and thus no change in the bandwidth allocated for the current data transmission session is required. Therefore no instructions need to be sent to either of the gate controllers 61 or 62. Therefore, in this example, the definitive response 282 confirms that the allocation has remained unchanged from the previous contract.

Upon receipt of the definitive response 282, the second bandwidth broker 94 generates a notification signal 283 which recombines the costs associated with each allocation of data (ie the costs associated with the second Bandwidth broker's resources and the first Bandwidth broker's own resources). This notification 283 is then passed to the second bid router 92 which forwards the notification as forwarded notification 284 to website B, which continues to transmit data as indicated by a data signal 285.

Shortly after receiving the forwarded notification signal 284, website B, determines that a termination condition has been met (e.g. it has finished transmitting the requested data) and thus it generates a termination request 2B6 which is forwarded to the second bid router 92. Upon receipt of the termination request 286, the second bid router 92 forwards it as a forwarded termination request 287 to the second bandwidth broker 94. Upon receipt of the forwarded termination request 287, the second bandwidth broker 94 generates and transmits a termination request 288 which is forwarded to the first bandwidth broker 93 and also generates a termination instruction 289 which is forwarded to the second gate controller 62 instructing it to block further access to portion 44 by datagrams from website B to personal computer 10-1. When the first bandwidth broker 93 receives the termination request 288, it generates a termination instruction 290 which is forwarded to the first gate controller 61 instructing it to block further access to portion 41 by datagrams from website B to personal computer 10-1. At the same time, the second Bandwidth broker 94 also generates a notification signal 291 which indicates the termination of the session and the total cost of the session and this is forwarded to the second bid router 92. The second bid router 92 receives the notification signal 291 and forwards it on as forwarded notification signal 292 to website B. Upon receipt of the forwarded notification 292, website B makes a note of the total cost of the session for its own records. Shortly after receiving the instruction 289, the second gate controller 62 generates an acknowledgement 293 which is transmitted to the second Bandwidth broker 94 to inform it that the allocation of bandwidth over portion 44 for datagrams from website B 95 to personal computer 10-1 has been stopped. Similarly, shortly after receiving instruction 290, the first gate controller 61 generates an acknowledgement signal 294 which is forwarded to the first bandwidth broker 93 informing it that the allocation of bandwidth over portion 41 for datagrams from website B to personal computer 10-1 has been stopped. Upon receipt of the acknowledgement signal 294, the first bandwidth broker 93 generates and forwards a notification 295 which is forwarded to the second bandwidth broker 94 informing it that the deallocation has been successfully made.

Turning now to FIG. 26, the overall architecture of the second bandwidth broker 94 is shown. This architecture is typical of a multi-node enabled bandwidth broker 94. The bandwidth broker 94 is divided functionally into two halves 940 and 949. The first half 940 deals with bid apportionment matters (i.e. the apportionment of a single bid into multiple bids for securing bandwidth over multiple constraining data links) while the second half 949 deals with broking of its own resources (ie a data bottleneck under its own control). Within the first 940, there is included a bid routing module (next hop) 941 which deals with all routing aspects (ie determining which further bandwidth broker, if any, needs to be dealt with in order to secure guaranteed bandwidth across the whole connection desired by the bidder. The bid routing module 941 includes a store of address details of bandwidth brokers and the associated IP addresses of onward destinations.

The first half 940 of bid router 94 also includes a bid apportionment module 942 which comprises three elements 943, 944 and 945. The three elements are a broker's broking details store 943 which stores details of various broking details including its own broking details and the broking details of any bandwidth broker with which it is able to communicate for bid apportionment purposes. This data includes the Minimum Bid Price and Spot Price charged by both its own resource broking module 946 described below and by any other broker with which it is in communication. The apportionment module 942 also includes an active multi-broker bid store 944 which is used for storing all bids for which bandwidth broker 94 is responsible for apportioning between more than one bandwidth broker. The bid apportionment module 942 also includes an apportionment program 945 which is used to apportion bids when necessary between its own resources and those of a bandwidth broker with which it is in communication. The details of the operation of the apportionment program 945 are described in greater detail below.

The second half of the bandwidth broker 94 includes an own resource broking module 946 which is basically similar to the bandwidth broker described in the first embodiment above. The second half 949 also includes a provisional bid processing module 947 which processes provisional bids and determines which bid options within each provisional bid would have been accepted had the bid been a definitive bid. Such provisional responses are sent back to whoever sent the provisional bid (ie either its own bid apportionment module or the bid apportionment module of a distant bandwidth broker).

Referring now to FIG. 27, the operation of the apportionment program 945 of FIG. 26 will now be described. After commencement at step S1200, control passes to step S1201 where, when a new bid is received, the apportionment program 945 determines if the requested connection requires bandwidth in a bottleneck controlled by a further bandwidth broker. If no such further broker is required then control is passed to step S1202 where the new bid is processed as a normal bid as was described in respect of the first embodiment. Alternatively, if it is determined that bandwidth from a further bandwidth broker is required, then the apportionment program 945 determines which bandwidth broker should be contacted for the extra bandwidth by referring to the bid routing module 941 together with the information about the Internet protocol addresses of the bidder and correspondent as identified in the new bid. Control is then passed to step S1203 where the new bid is subdivided to generate two provisional bids according to the currently held broking details. To do this, the apportionment program 945 consults the brokers broking details store 943 to determine the current Minimum Bid Price both for its own resource (as determined by its own resource broking module 946) and for the further bandwidth broker from which it requires bandwidth. The details of its own Minimum Bid Price will be very accurate however the record of the Minimum Bid Price offered by the further bandwidth broker may be a little bit out of date since the further bandwidth broker only broadcasts its current Minimum Bid Price periodically (eg every 10 seconds). Having established the relevant Minimum Bid Prices (or in the case of old bids being reprocessed, the appropriate intermediate price between the Minimum Bid Price and the spot Price) the bid options of the bid are divided in the same ratio as the ratio of the Minimum Bid Prices. For example, if the first bandwidth broker 93 has recently advertised a Minimum Bid Price of 1 thousandth of a cent per minute per kbps, and the Minimum Bid Price offered by the second bandwidth broker is 2 thousandths of a cent per minute per kbps, then one bid option (e.g. of 6 thousandths of a cent per minute per kbps) is divided into two subdivided bid options the first having as a maximum offer (e.g. of 2 thousandths of a cent per minute per kbps) half that of the maximum offer (e.g. of 4 thousandths of a cent per minute per kbps) for the second subdivided bid option.

Upon completion of step S1203 a timer is commenced which will time out after one second in the present embodiment and control passes to step S1204 where the subdivided bid options are sent to the provisional bid processing modules of the respective bandwidth brokers as provisional bids. Control is then passed to step S1205 where the apportionment program 945 determines if a provisional response has been received in respect of the provisional bids sent in the preceding step. When the provisional responses have been received, the apportionment program 945 then determines whether the highest accepted bandwidth choices at each broker match in terms of the amount of bandwidth. If they do, then control is passed to step S1206 where definitive bids corresponding to the provisional bids are submitted. If, however, there is a mismatch in the provisional responses (indicating that one bandwidth broker is prepared to offer to service a higher bandwidth bid option than another bandwidth broker), then control is passed to step S1207 where the subdivision of bid options is recalculated.

The provisional response includes an updated version of the Minimum Bid Price (or intermediate or Spot Price as appropriate) which the respective bandwidth broker is charging. Therefore, the recalculation of the subdivided bid options may result in different subdivided maximum offers in respect of each subdivided bid option. Upon completing step S1207, control is passed to step S1208 where the apportionment program 945 determines if the recalculated subdivided bid options are different to the previously calculated subdivided bid options. It is also determined whether or not the timer commenced in step S1203 has timed out. If the timer has not yet timed out and if the subdivided bid options have changed, then control is returned to step S1204 and the new subdivided bid options are sent as part of new provisional bids and the above process is repeated. If however it is determined in step S1208 that either the subdivided bid options have remained unchanged or that the timer has timed out, then control is passed to step S1209 where a definitive bid is submitted only using the highest bid option (ie the bid option requesting the most amount of bandwidth) which was provisionally accepted by all bandwidth brokers. The definitive bids are sent both to its own resource broking module 946 and to the further bandwidth broker (e.g. bandwidth broker 1) and control is then passed to step S1210.

In step S1210, all of the definitive responses (ie from the further bandwidth broker and from its own resource broking module 946) are examined to determine the cost associated with each allocation of data and these costs are combined to generate a conventional notification which is sent, via the appropriate bid router (in this example the second bid router 92), to the bidder informing the bidder that the bid has been successful, how much bandwidth has been allocated and how much the cost will be for the guaranteed contract period to which the notification relates. Upon completion of step S1210, control is passed to step S1211 where the original bid is placed in the active multi-broker bid store 944 until the current contract period expires, at which time the bid will be reprocessed and a new round of provisional bids and provisional responses will be issued as before.

FIG. 28 illustrates the operation of a possible enhancement to the algorithm for calculating the Spot Price and Minimum Bid Price which is applicable to the single domain multi-node data communication system of the third embodiment. The algorithm is used to determine when the Spot and Minimum Bid Prices are to be reviewed (ie when a sample time occurs) and it coordinates all bandwidth brokers within the same domain. The purpose for doing this is to enable fluctuations within the determinations of the Spot Price and Minimum Bid Price due to the apportionment of bids between different bandwidth brokers within the same domain to be given a chance to settle to an equilibrium state. To control the procedure, a single bandwidth broker within the single domain is nominated as a master broker and all of the other bandwidth brokers within the same domain are designated as slave brokers.

Upon commencement of the algorithm at step S1220, control passes to step S1221 where the brokers determine if a Spot Price review has been triggered. In the case of the master broker, a Spot Price review is triggered upon the elapsement of a certain time out period (e.g. four seconds). In the case of a slave broker, a Spot Price review is triggered upon receipt of a signal from the master broker to initiate a Spot Price review. When such a Spot Price review trigger is detected, control is passed to step S1222 where the broker suspends the acceptance of definitive bids or ordinary bids which do not need to be apportioned between more than one bandwidth broker. Acceptance of definitive bids are suspended when the SP, MBP is being calculated. If the bid apportionment module (BAM), has discovered an apportionment of the bid which satisfies all bandwidth brokers (i.e. S1208 of FIG. 26b has just answered “yes”) it will then send out a definitive bid. By the time this is processed the prices may have changed and the bid may fail at one or more bandwidth brokers, but because it is a definitive bid the user will be charged money for the successful bids even though he does not have end-to-end service. The solution is that when a BAM realises prices have been recalculated (the bandwidth broker may inform the BAM of this explicitly or the BAM may infer this from the fact that acceptance of its definitive bid has been suspended), it should check to see if the bid is still OK (by sending provisional bids) before sending another definitive bid.

Upon completion of step S1222 control passes to step S1223 where the master broker signals all the slave brokers to review its Spot Price. Then, in step S1224, each bandwidth broker performs a review of its Spot Price and Minimum Bid Price (and if appropriate, it may be also review its Maximum Effective Capacity) in the same way as was done in the first embodiment. Upon completion of step S1224, control passes to step S1225 where the results of the review in the preceding step are set as provisional results are broadcast to all brokers within the single domain. Control then passes to step S1226, where the master broker awaits all of the provisional results of the Spot Price and Minimum Bid Price to be broadcast from the other bandwidth brokers and determines if any Spot Price or Minimum Bid Price (including its own) has changed by more than 5%. If at least one change is greater than 5%, then control is passed to step S1227 where the master broker checks that the review process has not been in process for more than a predetermined maximum review time which in the present embodiment is set to one second. If it has, then control is passed to step S1228 where the master broker broadcasts a signal to the other brokers informing them to end the Spot Price review. If the review is not to be ended, control passes to stages where each bandwidth broker firstly waits for all of the provisional results of the Minimum Bid Prices and Spot Prices to be received from each bandwidth broker within the single domain.

Once all of these results have been received (in the present embodiment, all bandwidth brokers assume that all results have been broadcast within 50ms of broadcasting their own results), each bandwidth broker examines all of the bids contained within its active multi-broker bid store 944 and generates respective provisional bids which are sent to the respective bandwidth brokers. The bandwidth brokers also accept provisional bids from other bandwidth brokers. The transmission and reception of provisional bids is performed for a short period (e.g. 50 milliseconds). The provisional values of the Spot Price and Minimum Bid Price broadcast by each of the bandwidth brokers is used to determine how the multi-broker bids within the active multi-broker bid store are apportioned. Upon completion of step S1231, control is passed back to step S1224 and a new provisional Spot Price and Minimum Bid Price is calculated and broadcast to the other bandwidth brokers and the process is repeated until either an equilibrium position has been reached (as determined by step S1226 or the master broker determines that the review process has run out of time in step S1227). When the end of the review process is triggered in step S1228, control is passed to step S1232 in which the latest provisional values of the Spot Price and the Minimum Bid Price of each bandwidth broker are set as the current definitive values. Control is then passed to step S1233 where each bandwidth broker recommences accepting definitive bids and ordinary bids. Upon completion of step S1233, control is returned to the start of the algorithm at start step S1220.

General Comments About the Third Embodiment

The third embodiment gives an example of how the system may be extended to deal with more than a single bottleneck. There are other ways in which more than a single bottleneck could be dealt with. For example, a single bandwidth broker could control a number of different gate controllers each being associated with a particular bottleneck. Such a bandwidth broker could then determine which bottlenecks a particular data transmission session or connection will require access through and calculate a proxy price which approximately accounts for the cost associated with each bottleneck. New bids which exceed this proxy price will then be accepted and the bandwidth broker will control all necessary gates to ensure that the desired amount of bandwidth is allocated across each bottleneck.

Another aspect of the third embodiment is that both bandwidth brokers were located within the same domain. The network operator was thus able to ensure quick communications between different bandwidth brokers and this feature was used to coordinate the review of the Minimum Bid Price and Spot Price performed by each bandwidth broker. This allowed a certain amount of iterations concerning internal apportionments of value for bandwidth at different bottlenecks to be performed giving a chance for instabilities to settle down to a reasonable equilibrium.

It is possible to extend the system to cover more than a single domain and the fourth embodiment described below is an example of such a system. In such a system there is no guarantee of quick communications between different bandwidth brokers located in different domains and therefore the algorithm illustrated in FIG. 27 may not be used. However, it is anticipated that the instabilities caused by bidder apportionments between different domains are less severe than within a single domain.

### FOURTH EMBODIMENT

FIG. 29 is a schematic illustration of a multi-domain communication system. Five interconnected domains are shown, two of which, ISP A, ISP B are in location region one and two of which, ISP C, ISP D, are located in region two. The fifth domain, ISP E spans both region one and region two with a constraining data link 46 enabling data to flow from one region to the other. An example of the two different regions could be Europe and North America with the constraining data link representing a limited amount of capacity within a cross Atlantic fibreoptic cable. A first user 11 is connected to the domain controlled by ISP B in which there is located a first bandwidth broker 97. A second user 12 is connected to the domain controlled by ISP D in region two. The domain controlled by ISP D includes a second bandwidth broker 98. If the first user 11, wishes to set up a data transmission session with the second user 12, then data must flow through the domain controlled by ISP B the domain controlled by ISP E and the domain controlled by ISP D. Therefore, data must also flow through the constraining data link 46 connecting region one to region two. Such a connection is likely to involve passing through a large number of separate data bottlenecks. However, by employing the techniques described above in a hierarchical fashion, the complexity as far as any one single data transmission session is concerned can be reduced to requiring only two bandwidth brokers, the first bandwidth broker 97 and the second bandwidth broker 98.

To do this, the first bandwidth broker controls, inter alia, access between any ingress point (e.g. ingress point 13) up to and including use of data link 46. Similarly, the second bandwidth broker 98 controls what data may pass between any egress point to its domain (e.g. egress point 14) from and including use of constraining data link 46. To do this, each bandwidth broker determines a proxy price to account for all of the bottlenecks between an ingress or egress point and the data link 46 (e.g. for BB1 a proxy price covering the ingress point 13, the gateway 15 between ISP B and ISP E and within the data link 46. Similarly, the second bandwidth broker determines a proxy price for all data bottlenecks between data link 46 and egress point 14, including use of link 46, the gateway between ISP D and ISP E and ingress point 14).

When the first user 11 makes a bid for a connection to the second user 12, the first bandwidth broker 97 apportions the bid between its own resources and those of the second bandwidth broker 98. The first bandwidth broker then ensures that any qualifying datagrams between the first and second users have clear passage between the ingress point 13 up to and including use of link 46. Similarly, the second bandwidth broker ensures that all qualifying datagrams have clear passage between the data link 46 and the egress point 14. To ensure that qualifying datagrams have clear passage through the data link 46, it is necessary for both ISP B and ISP D to purchase allocation of bandwidth across data link 46 from ISP E. This could be done using the dynamic bidding mechanism of the present invention if ISP E has a suitable bandwidth broker associated with data link 46. Note that such allocations of bandwidth would be for much larger (ie bulk) quantities of bandwidth sufficient to permit a large number of individual data transmission sessions to pass from ISP B through data link 46. Alternatively, ISP B could buy a fixed static bulk quantity of bandwidth across data link 46.

As those skilled in the art will appreciate, the above bidding system is applicable to any system where there is a finite resource shared by a number of people where a user of the resource may be prepared to pay a different price to another user for a certain quantity of the shared resource. For example the resource may be bandwidth processing power on a shared server, data storage in a shared data store of the position in a buffer queue. The above examples have mostly focussed on computer network environments where data transmission bottlenecks exist such that bandwidth across the bottlenecks becomes a scarce resource. A fifth embodiment will now be described which concerns a mobile data network where there is usually a similar bandwidth bottleneck between a base station and a number of mobile stations being serviced by the base station.

### FIFTH EMBODIMENT

A schematic illustration of a mobile data network is shown in FIG. 30. The network includes a first group of base stations 601 to 607 controlled by a first base station controller 600, a second group of base stations 611 to 617 controlled by a second base station controller 610, a core network or backbone 630, a collection of network servers 640 and a collection of external gateways 650. A mobile station 620 may communicate with any other user connected to the core network 630, possibly via one of the external gateways 650.

As an example, consider the situation where the mobile station 620 wishes to download some data from one of the network servers 640. To do this, the mobile station 620 will initiate a call with one of the closest base stations (e.g. base station 601 or base station 603) and will transmit a request signal which will travel via whichever base station is serving the mobile station (e.g. base station 601). The first base station controller 600 and the core network 630 to the collection of network servers 640, where it is routed to the appropriate server. The appropriate network server within the collection of network servers 640 then transmits the requested data via the core network 630, the first base station controller 600 and the appropriate base station to the mobile station 620. If a large number of mobile stations are being serviced by base station 601, then there will be a restriction on the amount of data which can be transmitted between the base station 601 and each of the mobile stations being serviced by it. In a conventional arrangement, this could result in some mobile stations being refused service simply in dependence on when they happen to try to initiate a connection with the base station or in degradation of the best efforts service. However, in the present embodiment, each mobile station is permitted to place a bid for bandwidth over the air-interface and this bid is processed by the bandwidth broker 660. A portion of the bandwidth available between the base station 601 and all of the mobile stations 601 serviced by the base station is divided into two portions a conventional best efforts portion and a guaranteed quality of service portion as before. Any mobile station may bid for allocation of bandwidth within the guaranteed quality of service portion. Such bids are passed to the bandwidth broker 660 which processes the bids and, if successful will control the configuration of the appropriate base station controller 600 to allow data destined for the mobile station in question to be carried in the guaranteed quality of service portion of the air-interface.

Enhancements to the Fifth Embodiment

Within a mobile network, traffic (ie data) travelling over the air-interface can be classified into a number of different classes using the following parameters:

(1) the maximum peak to average required bandwidth ratio (hereinafter referred to as the contention ratio);

(2) the maximum permitted delay (typically an operator will guarantee that such a maximum delay will be exceeded only a small percentage such as 5% or less of the time);

(3) A mobility indicator having three possible values representing low mobility—e.g. for indoor use—, medium mobility—e.g. for pedestrian use—, and high mobility—e.g. for use within vehicles.

The basic processing performed by bandwidth broker 660 might be enhanced to include the following steps when bids specifying a particular class of traffic type (using the above described three parameters) for which they require guaranteed quality of service are processed.

Upon receipt of a new bid, the bandwidth broker initially determines if the requested traffic type is using the same resource (e.g. designated capacity at the air-interface) as traffic of a different type. If this is not the case (e.g. each traffic type has its own resource) then the bid can be processed in a normal manner. Otherwise, the requested amount of bandwidth for the particular traffic type is converted into a common measurement of effective bandwidth requested. The maximum price offered for this effective bandwidth is then calculated and compared with the Minimum Bid Price to determine if the bid will be accepted or rejected. If all of the bid options are rejected the bid is marked as having failed, a notification is sent to the user informing the user that the bid was unsuccessful and after a predetermined time the bid will be deleted. If however the bid is accepted, then the appropriate base station controller is instructed to allow through the appropriate traffic and the bidder is notified of the success of the bid. Furthermore, where the class of traffic type is for either medium or high mobility, then the bandwidth broker informs the relevant base station controller to make some provision for the traffic in adjacent cells in case the mobile station moves into such an adjacent cell.

When an accepted bid is due for review, it is determined whether or not the connection can be maintained (on the basis of the Minimum Bid Price first charged to the bid, and the current value of the Spot Price for the particular resource currently being used—namely the designated bandwidth within the air-interface from the base station and the mobile station). Where the traffic type is for a class having medium or high mobility, some provision for the traffic will have been made in adjacent cells; thus, when a mobile station moves into one of the adjacent cells the effect on the utilisation of bandwidth within that cell is judged according to the net effect of the transition. For example, if a reservation of 20% of the requested effective bandwidth has been reserved in an adjacent cell and the mobile station in question moves into that adjacent cell, then the increase in utilisation of bandwidth given in that cell is deemed to be 80% of the effective requested bandwidth.

As an example, consider table 7 below.

Effective Demand as Percentage of Peak
(Current Cell)

| Traffic | Contention | | | |
|---|---|---|---|---|
| Type | Ratio | Indoor | Pedestrian | Vehicular |
| A | 1:1 | 100% | 100% | 100% |
| B | 5:1 | 20% | 20% | 20% |
| C | 20:1 | 5% | 5% | 5% |

Effective Demand as Percentage of Peak
(Expected Next Cell)

| Traffic | Contention | | | |
|---|---|---|---|---|
| Type | Ratio | Indoor | Pedestrian | Vehicular |
| A | 1:1 | 0% | 50% | 100% |
| B | 5:1 | 0% | 5% | 10% |
| C | 20:1 | 0% | 0% | 0% |

Each bid option specifies the requested traffic type by means of a contention ratio which can take one of three values namely 1:1; 5:1; 20:1; and one of three types of mobility namely indoor, pedestrian, or vehicular. Table 7 then illustrates how to calculate the effective requested demand on the basis of the actual requested demand both within the current cell and within an adjacent cell designated as the expected next cell (this can be done using historical information about the direction of movement of the mobile station). As an example, consider a bid option requesting 100 kbps (peak) of traffic having a contention ration of 5:1 with pedestrian type mobility and with a maximum offer of two cents per minute. This can be converted into an effective requested bandwidth by multiplying 100 kbps by 20% for the current cell and by 5% for the expected next cell. This therefore corresponds to an effective demand in the current cell of 20 kbps and an effective demand in the expected next cell of 5 kbps per second.

Instead of using a single bandwidth broker for controlling all of the bottlenecks, a different bandwidth broker could be associated with each cell. In this case, the bid option could be apportioned between the bandwidth broker for the current cell and the bandwidth broker for the expected next cell, in which case, the bid will be apportioned according the ratio of the effective bandwidth requested within each cell multiplied by the Minimum Bid Price at each cell. Thus if the Minimum Bid Price for the expected next cell in the above example was twice that of the Minimum Bid Price at the current cell, the bid will be apportioned according to the ratio of 20 kbps multiplied by one to 5 kbps multiplied by 2 which is equal to 2:1 ie 6.7 cents for 20 kbps in the current cell and 3.3 cents for 5 kbps at the next cell.

Users of a data network may be offered assured bandwidth across the network with different costs associated with different classes of traffic type. However, traffic of different classes may share use of the same resource. For the sake of efficiency, the operator of the data network may not wish to segment the capacity of that resource between different classes of traffic type in a fixed manner. Instead, he may want each traffic type or at least certain traffic types to have access to the full capacity of the resource with dynamic allocation of the resource to the different types of traffic. Nevertheless, he may also wish to limit the extent to which certain traffic types can utilise the capacity (e.g. to ensure that certain other traffic types always have at least some access to the shared resource).

An example of different traffic types is differences in the ratio of the guaranteed maximum peak bandwidths supported to the average bandwidth (ie contention ratio). services could be offered at contention ratios such as 1:1, 2:1, 10:1 and 20:1.

An operator can manage these different traffic types over the same resource by converting them into an equivalent effective requested bandwidth which can be derived from the peak demand requested together with the contention ratio. An example of suitable conversion factors is given in Table 8 below.

Conversion Factors

| | | Effective Demand |
|---|---|---|
| Class | Contention Ratio | (as % of peak) |
| A | 1:1 | 100% |
| B | 2:1 | 50% |
| C | 10:1 | 10% |
| D | 20:1 | 5% |

The operator may also wish to limit utilisation of the resource by certain traffic classes without limiting others. For example, he could require that the sustained usage (though not necessarily all usage) of the resource by classes A and B combined does not exceed 50% of the total capacity of the resource available. To achieve this, a bandwidth broker can be employed which requires that any bid options requesting bandwidth for traffic of classes A or B must be offering a maximum price higher than both a first Minimum Bid Price in respect of the resource as a whole (ie which is offered to all classes of traffic) and the 50% portion of the entire capacity (which traffic belonging to classes A and B cannot exceed (in total).

To deal with such a situation, a bandwidth broker can therefore process a newly received bid set as follows:

(1) On receipt of a bid set, the bandwidth broker can determine if the bids are requesting bandwidth for a type of traffic which shares a single resource with one or more other types of traffic. If this is not the case the bid set can be processed in the normal way; otherwise

(2) the requested bandwidth is converted to the effective requested bandwidth according to a suitable algorithm such as that described above;

(3) it is determined if there is a constraint on the percentage of the total resource available for traffic of the type specified in the bid set. If there is no such constraint then the bid is processed on the basis of the effective demand calculated above; Otherwise

(4) the Minimum Bid Price (or in the case of subsequent processing of a bid of this type, the appropriate intermediate price or Spot Price for long established bids) is examined in respect of all markets relevant to the specified traffic type and the market with the highest Minimum Bid Price is identified. Bid options within the bid set are accepted or rejected on the basis of the highest identified price and the capacity available in that market (bearing in mind that if some capacity is allocated to the bidder as a result of the successful bid option, then the utilisation of the resource is taken into account for all of the markets relevant to the type of traffic specified in the bid).

Single Quality of Service (Qos) Level Offered

The above described embodiments have focussed on the provision of reserved bandwidth to bidders offering a sufficiently high price per unit of bandwidth (ie those bidders offering to pay above the instantaneous spot price or minimum bid price). However, the same principle can be applied to the provision of capacity through a network at a minimum quality of service level as determined by some predetermined metric or parameter of quality of service such as packet loss or delay.

### SIXTH EMBODIMENT

FIG. 31 is a schematic representation of a single seller's network 730 connected via a Local Area Network (LAN) 710 with four potential buyers of his service (which is capacity for the transmission of data over his network 730 to a user 750). The buyers are named A, B, C, and D. In the present embodiment only traffic flowing from the buyer to the seller is considered. The buyer's traffic (ie packets of data to be transmitted over the network—for example to the user 750) enters the LAN 710 through buyer's ports 701a, 701b, 701c, 701d at which the maximum rate of transmission can be controlled and enters the seller's network via a seller's port 720 which has a maximum effective bandwidth or transmission rate before quality of service starts to suffer as the port becomes congested. Typically, the sum of the maximum transmission rates of all buyers A, B, C and D exceeds the maximum effective bandwidth that the seller can support without congestion, i.e. without either delay or loss of packets. As mentioned above, there is an ability to control the maximum rate of transmission of each buyer at the buyer's ports 701a-701d, and this can be done dynamically.

In the present embodiment, the network performs continuous quality testing of its performance between a first measurement point and a second measurement point. The first measurement point is chosen to be a point in the local area network downstream from the point at which the buyer's rate of transmission is controlled (ie the buyers ports 701a-701d). This ensures that the quality measure is unaffected by congestion in the buyer's network caused by the limit of his rate of transmission. In the present embodiment, the measurement is in the form of packet delay (latency) most of the time, but it is also possible to measure packet loss, or ECNs (Explicit Congestion Notifications). In the present embodiment, the second measurement point is a single point in the seller's network 730 downstream of the first measurement point. However, a user may request the network to provide a weighted average of the measure to a number of downstream second measurement points in the network. Where various measures are used, they are consolidated into a single numeric metric.

In this embodiment the seller aims to supply service to as many buyers as possible, at the highest possible transmission rate consistent with maintaining a quality measure better than some minimum threshold level. The minimum threshold level is well advertised and, in the present embodiment, is a trigger for financial penalties (incurred by the seller if the minimum threshold is not maintained) under contracts with the buyers. For example, the level might be set (for a contractually agreed period of say 6 months) to 100 milliseconds round trip delay. The Seller therefore aims to keep the round trip delay below 100 milliseconds (Max delay) and, in the present embodiment, has a lower target for the average delay (target mean delay). The seller then operates a pricing regime, consisting of a spot price and a minimum bid price, analogous to the pricing of reserved bandwidth described above in relation to the earlier embodiments.

Max delay and target mean delay under this regime are equivalent to Max capacity and mean effective capacity when selling reserved bandwidth capacity. Thus, when the current delay rises above the target mean delay, then a minimum bid price for new transmissions into the seller's network will rise above the spot price. In the present embodiment, prices are defined as dollars per Mbps per hour for the maximum transmission rate over a predetermined duration which in this case is 5 minutes. The use of a charge based on the maximum transmission rate over a predetermined duration provides an incentive to the buyers to minimise the burstiness of their transmissions as much as possible. In the present embodiment, the minimum bid price applies to any requests for additional capacity by existing buyers or to any request for capacity from a new buyer.

The algorithms used for changing both spot and minimum bid prices are, mutatis mutandis, the same as those used for selling reserved bandwidth described in detail in relation to the first embodiment.

In the present embodiment, each buyer has at any time a set of preferences for the maximum rate of transmission consistent with a ceiling price. An example is given below in Table 9. As described for reserved bandwidth in respect of the first embodiment, a buyer periodically sends his preferences to the appropriate bandwidth broker 740 in the form of bids. The broker 740 periodically changes prices as a result of the relationship between the current delay, Max delay, and mean effective delay. The current prices are compared with buyers' bid to determine the maximum transmission rate for each buyer. For example, an increase in delay might raise the price from $0.8 to $1.3 per Mbps per hour. This would have the effect of changing the maximum transmission rate for the buyer whose bid is set out in Table 9 below from 10 Mbps to 5 Mbps.

TABLE 9

| Max transmission | Ceiling Price |
|---|---|
| rate (Mbps) | ($/Mbps p hr) |
| 10 | 1 |
| 5 | 1.5 |
| 3 | 2.5 |

Rational buyers reduce their rate of transmission as prices rise. This reduces congestion in the seller's network and hence tends to reduce the current delay. To make sense of reducing his transmission rate as prices rise, each buyer A, B, C and D benefits from having mechanisms to prioritise his own traffic so that it is only low value traffic that suffers from the reduced rate of transmission. This is achieved in the present embodiment through each buyer becoming in effect a seller of his own internal network service to his own clients or applications, using the same systems as are described here.

Wholesale vs. Retail

Since there are wholesale applications of latency-based (and other QoS-based) services, it is worth commenting on some implementation differences that might apply between wholesale and retail applications, regardless of whether these are for reserved bandwidth or based on other QoS measures.

In the retail case there is likely to be a billing record for each session between two parties. In the case that there is an increase in the bandwidth reserved or allowed for a session it is not practical to bill separately for the pre-existing portion (at the spot price) and the additional portion (at the minimum bid price). Hence in this case the whole session may be advantageously billed initially at the MBP and then billed at a price which falls to the spot price over a short period of time. In the wholesale case, the same rule could apply but the alternative of billing only the additional bandwidth at the MBP may be worth the effort to do so.

In the retail case, sessions between individual parties are continually being set up and closed down. i.e. a characteristic of the services being sold is that they are intermittent. They are also liable to be very significantly affected by unexpected denials of service or changes in QoS resulting from the actions of other users. Hence there is value in providing some protection from transient changes to existing service contracts. In the wholesale case and a single network service seller, there is likely to be a permanent connection through the seller's network. Variability in rate of transmissions, however, by the buyer is implicit in the variability of the seller's price. As already noted, the buyer is able to adjust his usage of the seller's network in response to signs of congestion in the latter. Typically he will do this by passing the effects of congestion onto those of his customers whose contracts allow this one consequence of wholesale buyers' tolerance of service variability is that the protection of existing service capacity provided by the MBP is less valuable than in the retail case. Also congestion can be caused by increase in traffic levels within users' current peak transmission rates, although pricing by peak transmission rate will encourage users to keep their peak transmission rates close to their effective throughput. In the case of congestion arising without increases in peak rates, raising the MBP will not stop congestion getting worse. Spot prices will need to change quickly in the case that MBP changes do not stem congestion. Thus, the stabilising effect on existing traffic of the MBP is also somewhat reduced in this scenario. In certain circumstances, therefore, it may be appropriate to equate the MBP with the spot price at all times—i.e. in effect maintain only a variable spot price.

In the case that there is a single spot price applicable to all traffic, a highly simplified implementation is possible in which the bandwidth broker advertises the current price to users and users apply their own bandwidth restrictions. In this case there would be no network policing of user transmission rates and so pricing would be according to actual bandwidth usage (whether peak rates or volume transmitted) rather than mutually agreed ceilings.

Multiple Service Levels

The above described embodiments only discussed the possibility of having two levels of service, namely best efforts and an assured quality of service level. However, a number of different levels of service may be provided as described below with reference to the seventh embodiment.

### SEVENTH EMBODIMENT

FIG. 32 shows a similar set up to FIG. 31, but with three service levels, gold, silver, and best efforts, now being sold by the Seller. In this embodiment, the buyers A, B, C, D are all connected via a Local Area Network (LAN) 810 and a seller's port 820 to a seller's network 830 having a number of users 850 connected thereto; a bandwidth broker 840 controls the maximum amount of traffic which each buyer can place onto the LAN 810. In the seller's network 830 of this embodiment, gold traffic has priority over silver traffic, and silver traffic has priority over best efforts traffic. Nevertheless, gold traffic is only allowed use of a proportion of the resources in the network 830, which, in the present embodiment is set at 50 per cent, as are gold and silver together, whose proportion is set at 75 per cent in the present embodiment. The seller sets separate minimum quality measures for the different service levels. He also sets spot and minimum bid prices separately for each of the service levels, based on the quality measures for each.

Each service level is accessed by marking traffic with an appropriate marker (in the present embodiment, the traffic or data packets may be marked either using DiffServ Codepoints or IP Precedence markers ie the existing three bit precedence field in the Internet Protocol header). Each buyer therefore has a set of preferences for service indicating the maximum transmission rate for each service level associated with price ceilings of his choice. In this case buyers need to be conscious that there is interdependency between the performance of the different service levels, e.g. when the gold service becomes relatively congested then it is likely that other services will also. Table 10 below illustrates a possible preference table.

TABLE 10

| | Max transmission | Ceiling Price |
|---|---|---|
| Service Level | rate (Mbps) | ($/Mbps p hr) |
| Gold | | |
| Preference 1 | 10 | 1 |
| Preference 2 | 5 | 1.5 |
| Preference 3 | 3 | 2.5 |
| Silver | | |
| (Where Gold ≦ 1) | | |
| Preference 1 | 20 | 0.5 |
| Silver | | |
| (Where 1 < Gold ≦ | | |
| 1.5) | | |
| Preference 1 | 25 | 0.5 |
| Preference 2 | 5 | 1.0 |
| Silver | | |
| (Where 1.5 < Gold) | | |
| Preference 1 | 27 | 0.5 |
| Preference 2 | 7 | 1.0 |
| Preference 3 | 2 | 1.5 |
| Total | | |
| Preference 1 | 45 | |
| Preference 2 | 45 | |
| Preference 3 | 45 | |

In the example above, traffic which drops out of silver (or traffic which drops out of gold without going into silver such as the final 3 Mbps to be dropped from gold) goes to a best efforts service having no guaranteed, or even target, quality measure. This allows it to be used as a service of last resort when the price of the other (premium) service levels exceeds the value of protecting quality for those communications normally using the premium service levels. Hence there is no usage-based price for the best efforts service. Also, the buyer has a maximum transmission rate for all traffic of 45 Mbps (including traffic going via best efforts). The example shows that as the price of Gold service rises, the buyer segments his use of Gold. He protects the most valuable segment as Gold traffic and downgrades the remainder to Silver. Because under these conditions silver can be expected to be high priced (and relatively congested) as well, he helps to make way for the downgraded Gold traffic by moving what was Silver traffic to the best efforts level when the price of Silver rises above a certain threshold.

All buyers' preference tables are submitted to the bandwidth broker 840, which in this embodiment enforces both the maximum transmission rate and the appropriate marking of traffic on devices at the edge of each buyer's network. It is also responsible for setting the spot and minimum bid prices.

Multi-Node Networking

Multi-node networking for services based on quality measures other than reserved bandwidth operates like those for reserved bandwidth. Once the relevant bandwidth brokers have been identified, the first bandwidth broker splits the user's bid between the relevant brokers, based on current prices at each node, and submits as a definitive bid the highest bandwidth option with acceptable bids at each node. The differences between working in a multi-node, single domain and multiple domains also remain unchanged.

Multiple Sellers

The above described embodiments deal with only a single network or set of networks being used for desired connections, with dynamic use of such connections and in particular bandwidth or other quality measures for such connections. However, similar principles may be used in selecting which of a plurality of different networks should be used where there is a choice of competing networks which are able to carry the required data between the relevant parties. The eighth embodiment described below illustrates such a situation.

### EIGHTH EMBODIMENT

FIG. 33 is a schematic diagram of a service centre where multiple buyers A, B, C and D can get access to multiple sellers' networks X, Y, Z for the connections that they wish to make. As in the sixth and seventh embodiments, each buyer has a buyer's port 901a-901d at which the maximum rate of transmission of data onto a LAN or switched network 910 can be controlled by a bandwidth broker or bandwidth manager 940. Each seller's network X, Y, Z operates a spot and a minimum bid price just as in the single network case. Logically, each such network X, Y, Z has a bandwidth broking function which is setting these prices and controlling access to its services in response to bids made by users and this informs the bandwidth broker 940 which controls the rate at which data is placed onto the switched network 910 accordingly. In addition, there is an initial bid filtering process which is performed in the present embodiment by the bandwidth broker 940, which ensures that each buyer's bid is transmitted to the service X, Y, or Z offering the best option to the buyer. Table 11, below, illustrates this. The filtering process checks if the buyer has an acceptable bid at any of the alternative services X, Y or Z at his highest bandwidth/quality option. The bid is sent to the lowest priced qualifying service. In the event of no qualifying option, the process is repeated for the next highest level of bandwidth/quality in the bidder's table. In table 3, the best option would be a 5 Mbps peak transmission rate with Service X. The buyers' bid is therefore sent to (or processed as) a bid to service X. Once the bid has been accepted, the higher level broking function signals the switching function in the switching network 910 to direct the buyer's traffic to the seller's network. In the case of a change in service provider, this will imply sending the requisite routing instructions. When there is no change, it implies an affirmation of existing routing if any such is needed by the switching network.

TABLE 11

| | |
|---|---|
| User's bid table | Minimum Bid Price (Entry price) or |

| Max | | Spot Price (Existing service) | | |
|---|---|---|---|---|
| trans- | Ceiling | ($/Mbps p hr) | | |
| mission | Price | Service X | | |
| rate | ($/Mbps | (existing | | |
| (Mbps) | p hr) | service) | Service Y | Service Z |
| | | 1.3 | 1.5 | 1.8 |
| 10 | 1 | | | |
| 5 | 1.5 | P | | |
| 3 | 2.5 | | | |

Any change in service supplier implies buying new bandwidth from the new supplier. In this case, therefore, the MBP plays an important role in dampening oscillatory swings in traffic from one service provider to another in response to changing prices which themselves are responding to the swings in traffic. A price cut by one supplier and not others will attract traffic to that supplier. If that results in capacity utilisation in the cheaper supplier exceeding his target, then the first price to rise is the MBP. This has the effect of deterring additional bandwidth demands on the service in preference to causing existing users to switch service or reduce bandwidth. If traffic levels remain above target levels (i.e. new demand at least equals service terminations), then the spot price will rise to accelerate service terminations.

Because of price competition between alternative suppliers, demand will be very sensitive to price when there is no network congestion. In these circumstances there will be strong downward pressure on prices and the switching of traffic from one service provider to another has little detrimental affect on service since networks are not congested. In the case that there is potential congestion, MBPs will be higher than Spot prices and there is therefore a financial penalty to switching service providers when that could lead to avoidable congestion.

Adjusting Price through Service Category

It has been suggested that the use of congested IP network resources could be prioritised according to user values by using priority schemes for IP networks, and giving end users budgets. The present inventors, however, are not aware of any suggestions as to how users can be sure of receiving adequate service levels for purchased services or how they could automatically adjust their requirements to changing network conditions. The suggested prioritised technique can however be combined with the use of users' bidding preferences and the quality testing aspects of a bandwidth broker, intelligent bidding agent, resource management agent or a network service quality testing means in a manner described below, to allow users' to perform self regulation of their network usage—consistent with expected performance—and a very simple network implementation of prioritised access to network resources in accordance with end user values.

An example of this kind of implementation is a multi-level service as described above (see FIG. 32), but with a fixed price per service level—at least for predetermined times of day. These prices are known to user's bidding agents or resource management agents. Also, there is no target service level which the network provider undertakes to maintain or approximate. Instead the user associates his own target service level with each service option (bid). The network (possibly in conjunction with information from the bidder on the application type) provides up to date information on the performance of the network along the path used by the bidder. This is described in more detail below. The network performance data can be used by the bidder to form a forecast of application performance for each service level (or, if the network is given sufficient information by the bidder as to the type of application of interest, the network could, in some embodiments, provide these forecasts automatically). The bidder (or rather the network service buyer, since no actual bidding is performed in this case) uses these forecasts, price data, and his bid options (or rather his indications as to how much resource and at what price the buyer is interested in buying some resource from the network) to select the best option available to him at any time. Table 12, below, illustrates an example only Preference 2 is supportable at acceptable prices. Silver service is selected as the cheaper of 2 viable options for it.

TABLE 12

| Pref Table for Application X and User | | | | | |
|---|---|---|---|---|---|
| class K | | | Network Service level | | |
| Forecast Application | | | Gold | Silver | Bronze |
| Performance (kbps) | | | 850 | 600 | 150 |
| | Price | ($/Gbyte) | 1.3 | 0.75 | 0.4 |
| Preference | Performance | Price Cap | | | |
| 1 | 700 kbps | $1/Gbyte | | | |
| 2 | 300 kbps | $1.5/Gbyte | | P | |

The bidding agent also checks actual application performance where possible and uses this to recalibrate forecast application performance forecasts that are based on network performance or usage indicators.

This implementation has the benefit of very simple implementation by the network provider. He simply provides a prioritised service and bills all traffic sent in each class of service according to separate, fixed prices. Since he takes no responsibility for service levels provided, he does not have to intervene with price changes or admission control. He can also price by volume sent and need keep no record of individual sessions for billing purposes. The user takes responsibility for deciding when a service is worth using, which service to use, and what constraints should apply to his transmission rate. Traffic is prioritised by value by being driven up the service levels to achieve the desired quality when demand increases. This is equivalent to a price change at a constant service quality. Lower value buyers will drop their transmission rates and ultimately abandon use of premium services if none of them offers an acceptable application performance at an acceptable price.

More Detail on self-regulation of bids according to one specific example of the operation of a resource management agent:

1. For each service level (G, S, B) test the network for performance by one or more measures, e.g.: ECNs, Ping tests, packet loss, and throughput per flow.

2. For each application (X, Y, Z—e.g. voice, game, adaptable video) derive forecasts of performance based on the network performance measure for each service level. The application performance measure to be in a metric appropriate to the application.

3. The Forecast Performance for each service is used to decide the most preferred application: network service level pair, based on the buyer's preference table. These forecast performance levels in the table are continually updated by the resource management agent.

4. Actions on application output and network service choice are taken to implement the best option (this involves setting the maximum rate of transmission and ensuring that the traffic is appropriately marked).

5. For a short time, t, periodically test the performance of the application directly to assess if forecast performance is being achieved. If application performance is below the desired level or suggesting signs of being about to go below the desired level, go to (7). If application performance still OK after time, t, go to (6).

6. Test to see if the forecast application performance for a cheaper service level than the current level is at least as good as the current application performance? If yes, go to (3). Else, go to (5).

7. If possible, go to the next higher priority service for which the forecast application performance is at least as good as required to maintain application performance for the current service level and which is within the price ceiling dictated by the preference table; then go to (5). If not possible, go to (3), eliminating all options in the preference table with an application performance at least as high as that which has just failed; providing that, if no options with a lower application performance remain take action as indicated by preference table in the case no premium service is available (e.g. send best efforts or send unavailable message) for a short time, t, and then go to (3) with only the lowest application performance option or options treated as valid.

Note that markers need to be set to record performance history as this affects use of the preference table.

Variant in case that the application performance test can test separately for network performance and application platform performance.

7. (Alternative)

7.1. If test at (5) indicates a network performance deficiency, then check if this is consistent with current forecast application performance based upon network conditions. If so, go to (3). Else, discount (recalibrate) forecast application performance derived from given network performance by some amount/percentage (various algorithms could apply) and go to (3).

7.2. If test at (5) indicates no network performance deficiency but nevertheless an application performance deficiency, then go to (3) but—for as long as the current destination IP address is associated with the active user profile—eliminate all options in the preference table with an application performance at least as high as that which has just failed for communications with that IP address.

7.3. Periodically, reset application performance forecasts for given network performance data to the default values or alternatively increase them using an appropriate algorithm. This will create an upward trend in the forecast values to counter the downward trend of 7.1.

Note that to prevent undesirable oscillations between adjacent service levels, some form of hysteresis should be used. For example, at step 6 the decision to go to step 3 could be made only if the measured network performance at the lower level is a predetermined margin such as 15% better than the forecast required network performance to maintain the desired application performance. Alternatively, the network could inflict some sort of penalty onto new flows of data within any service level to minimise excessive changing between different service levels such as, for example, inflicting a one off charge on new flows; applying an MBP to new flows which quickly falls to the standard price or initially inflicting a deliberately worse service level on new flows for a short initial period. However, all of these last three options have the disadvantage of significantly increasing the complexity of monitoring the flows of data which the network needs to perform.

General Variations

The above examples have generally placed the functions performed by the bid router in a separate piece of hardware to those performed by the bandwidth broker and the gate controller. However, these functions can be performed in many different combinations of hardware (e.g. all within a single processing device such as a server or an enhanced router or gate controller device).

In the first embodiment, if the Spot Price fell no action was taken to upgrade an active bid to a higher quality of service. However, it is envisaged that such upgrading could be performed if the Spot Price falls to allow it. Final points

1. The Value of a Set of Bidding Preferences

1.1 Having a prestored set of bidding preferences or general preferences concerning desired amounts of a resource depending on its cost and other factors permits automatic use when a user or computer application wishes to perform a certain class of communication—as illustrated in the first and second embodiments—or when a user wishes automatic cost sharing to be negotiated by the network—per the second embodiment.

1.2 In combination with 1.1 above, it is useful to have a prestored set of bidding preferences because it allows the generation of a single set of bid preferences for a class of communications to be applied:

1.2.1 in many network conditions; and

1.2.2 in many different networks, having between them different network conditions, different services available, and different pricing regimes. This can apply, e.g., to the support of many separate transmissions to a user in the same class but reached over different but unique networks; or, e.g., to the dynamic selection of network service where there is a choice of network service to use for communications with a user or class of users.

The bidding preference therefore has the benefit of:

a) ease and speed of use for negotiating a user's preferred quality of communications under different conditions; and

b) a practical means of establishing automatic negotiations with many networks and hence a practical means of purchasing quality for communications with users who are reached over many networks, which would otherwise require knowledge of services and pricing policies for all possible networks and a complex procedure for selecting the most appropriate service for a given class of communications at any time.

Note that this has benefits whether or not networks are applying any dynamic pricing of resources (let alone the particular system described with respect to the first embodiment for use by bandwidth brokers, which system can in any case be configured to work with fixed prices). I.e. there is a general benefit from the proposed schema that would apply in any negotiation of service quality from networks using one of:

a. the bidding protocol as described in the above embodiments

b. any other formal negotiation or signalling protocol; and

c. ad hoc arrangements for (i) communicating service availability and pricing and (ii) any necessary admission control between the network and the server responsible for data transmission and/or receipt on behalf of the service buyer.

This benefit is enhanced significantly by:

1. The ability to support bidding for communications between end-user and cache servers (see 2 below), and

2. The ability to generate bids on behalf of buyers based on a limited informational input from the buyer (see 3 below)

2. Bidding in a Cached Environment

A typical use of either the first or second embodiments described above would be for negotiating quality services in an access network for communications between end users and web servers as indicated in FIG. 1. While content and complete web applications could be located adjacent to “last mile” networks as illustrated in FIG. 1, the more general case is that the application is hosted at a remote hosting site (accessed either via the general Internet or via private networking arrangements between the server farm in FIG. 1 and the application host) with the more network quality sensitive data cached at the kind of server farm shown in FIG. 1. Typically, user log-on and similar aspects of the applications will require communication with the remote host.

In this more general case, the application owner would benefit from being able to set bid preferences for classes of user and classes of content valid for use globally or perhaps regionally. This is achieved by:

1. caching the bidding preference tables (ie tables setting out how much bandwidth and at what quality communications should be established for a selection of different price ceilings) along with the appropriate content at servers in server farms adjacent to “last mile” networks; and

2. Providing a range of means for the bidding program in the invention to:

a. associate a table of preferences with particular sub-tables for the transmission of particular sets or types of content; and

b. associate an IP address with a recognised class of user.

3. The Value of Additional Bidding Information

In the first to fifth embodiments the bandwidth broker processes a user's bids in descending order of bandwidth (or other measure of service quality). In many cases this will unambiguously ensure that the bandwidth broker acts in the best interests of the bidder. However there are cases where benefit can be obtained by incorporating further information in the bid to be acted on by either the bandwidth broker of, for example, the first to eighth embodiments or by the bidding program (otherwise referred to as a bidding agent) which is pre-processing bid tables, in particular in cases where pricing and bandwidth brokering are not only implemented as in the bandwidth broker elements described above with reference to the earlier embodiments.

In particular, the following 4 functions can be valuable:

a) Use of an explicit order of preference among the options. This can allow processing of bids in the appropriate order when, e.g.:

a. The order would otherwise be indeterminate because more than one quality measure is in use (e.g. the choice between 700 kbps at no worse than 70 ms delay and 1000 kbps at no worse than 100 ms delay)

b. The bid results from an aggregation of value flows, with some of the flows being supported through the selected service type at some prices but not at others. An example is the bidding table for Silver service in a multiple quality of service network (in Table 10 above). In this case the bids do not represent user benefits but just a set of responses to price, with decisions being made on switching flows between quality levels based on information (or assumptions) additional to the price of the silver service itself.

b) Use of a marker to indicate that the bidding table may be used to infer user benefit for the purpose of computing the right price caps in the face of changing service availability. This marker would firstly indicate that the table was a true reflection of user benefits and would give the receiving bidding program or bandwidth broker (which might be operated by another party) the authority to construct appropriate bids or service selections based upon the implied benefits to the user. The function could apply even in the case of service options of equal value but different in their service quality parameters. The bid table could indicate the user's order of preference (for the avoidance of problems of indeterminacy of a solution). The recipient bidding program or broker then notes if there are 2 or more adjacent bids with equal price caps (in terms of gross spend rather than unit price—since the units purchased could be different). The program infers from any such equality that the user benefit is equal in those cases. It can then construct appropriate bids for either service in the case of a limitation on service options. It could do this by assuming for computational purposes any service is available for which an equal benefit service is available. (See e.g. No. 4 of the final points below).

c) Indicator and associated processes to signal that separate flows should be processed as requiring simultaneous support in order to be valuable. An example would be an audio channel, a video channel, and an application control channel in a streaming video application. Either a bidding program or a broker could thus be instructed, for example, to proceed with bids only in the case that at least the lowest assured quality of service in the options for each service type was available within indicated price constraints for such a service. Another example would be preferred associations of quality for the respective flows (i.e. what range of combinations would be acceptable). Then the user could bid values for the combination of flows and the bidding program or broker could seek to find the highest valued combination by allocating the bid price as appropriate between the different flow types. This would be done on an analogous fashion to finding the highest bandwidth solution that is valid across multiple nodes.

4. Examples of Hierarchic Bidding with Simple Algorithms Processing for Automation of Higher Level Bidding

The fourth embodiment describes the case of a hierarchy of services, with the bidding for resources by end users limited to bidding into each of the two access networks for resources to access through to (or from) the midpoint between the 2 networks. The instantaneous treatment of the backbone resource between the access networks as constant means that such resource is in effect under the medium term control of the access network owner and can be treated as lying in his domain. This makes it more feasible for the access operator to either implement a multi-node, single domain solution or to have a useful proxy measure for the resource available to all end users in a given location to access the mid-point of a higher level operator—i.e. the point at which traffic is effectively handed off to the recipient's access network. In particular, in the case that each access network uses a single, proxy measure of available resource under his control, then end to end service quality can be negotiated with the 2-node version of the bandwidth broker as described. This greatly aids the speedy identification of the best solution available at all nodes in the path and the subsequent stability of that solution because it is not necessary to try to find a clearing price at each node in the path. Alternative wide area solutions require the user's bid value to be split between each relevant node along the path, with the result that finding a satisfactory solution is time and resource consuming and is inherently unstable, since a change in conditions at one node changes bids to all nodes. It also implies a solution where bidding and brokerage per flow must be possible all along the communications path. The present hierarchical embodiments do not require this—thus permitting them to be implemented in a greater range of cases—and seek to avoid active bidding except to the ingress and egress networks relative to the bidder.

Backbone networks operate with such large capacities and at such high levels of performance that it is either not possible or not economic to implement precise quality control per individual flow in the backbone, let alone a market clearing activity among thousands or millions of different flows each, almost certainly distributing its value among a number of different wide area resources. Hence any dynamic management of resources in the backbone needs to be performed at a high level of aggregation.

There follows an example of this with reference to the details of the fourth embodiment. In the example already given with reference to the fourth embodiment, it is shown how user 11 bids for a transmission to user 12 with, in effect, a 2 node solution, using, firstly, access to a proxy resource to reach the mid-point of ISP E's network (under ISP B's control), and, secondly, to another such resource from the mid-point of ISP E's network to User 12 (under ISP D's control). For this purpose, ISP B is using a fixed capacity of resource from his network to the mid-point of ISP E's network.

If one considers the case where ISP E offers dynamic network capacity to its customers, ISP B can monitor the implied value of the marginal use of this resource. In particular ISP B could continuously monitor how much demand there would be if he were to offer a spot price based on the current spot price of E's service plus necessary additional costs and an acceptable margin. He could also note the difference in the revenue to him from offering such a service and the current rate of revenue generation. He then needs to arrive at a bidding policy for E's resource based on this and other information. Using this information alone, he could derive a bidding preference table, as discussed above, to maximise short-term margins (gross revenue less direct cost). He is unlikely to do this unless he is an unconstrained monopolist. More likely, he will be guided by target margins, current market prices for equivalent services, and/or by representations or obligation to clients regarding medium-term performance as regards either price or first preference denial rates or both.

In the case that ISP B aims for a dynamic price, which gives him a 50% margin on revenues, he continuously compares his current, market clearing price for reselling access to the mid-point of ISP's network with the wholesale price of that service plus the appropriate target mark-up. In the case that ISP B's spot price exceeds the wholesale price+mark-up, he could in principle bid for the amount of bandwidth indicated as desired by his users from his monitoring of their bids at E's current spot price and for lesser amounts of bandwidth at higher prices (also in accordance with indicated end user demand) in case the highest volume bid fails.

However ISP B needs to consider that not only is he taking risk on such bids but he will also be introducing instability to multi-node bidding by changes to the price and volume of resource into E's network. Hence he will seek to establish that the current demand from his customers is sufficiently stable to merit a change in the wholesale bandwidth purchases he makes and to make such changes over a longer time frame than changes in his users' connections. For example, while he might be operating with 6 second time periods with his user, it might be advantageous to deal with periods of 5 minutes or more in purchasing bandwidth from ISP E.

At the very least, therefore, ISP B compares his (offered) spot price over the last 5 minutes with the ISP E's price plus mark-ups. Alternatively, for example, he might take the moving average of those prices over the last three 5 minute periods. In addition it may be advantageous to require the difference in the price to exceed some minimum threshold before making a change. This has the advantage that it should reduce the cases where there is a swift reversal of extra bandwidth acquired due either to a price change by E or a price decline in B's network. If ISP E is operating a Minimum Bid price, ISP B might rely upon that to provide some stability of service. In particular, if a change in bid triggers use of the Minimum Bid price, then it is advantageous if ISP B requires a significant change in indicated bids in order put the change into effect. So one example of such an arrangement has B using the following procedure in addition to maintaining spot and minimum bid prices for the resource brokered at First BB 97.

1. For each of the last three 5 minute periods for purchase of resource from ISP E, note, from incoming bids from his customers, the bandwidth demanded at:

a. E's price plus the relevant mark up

b. 20% above (a) above

c. 40% above (a) above

d. 60% above (a) above

2. Compute an indicated Bid as the lower of:

a. The weighted average of demand at each price coupled with the weighted average of the related price over the three periods, and

b. The most recent of the three demand and price cases.

3. If the result suggests that there should be a reduction in price offered at the current volume supplied, then implement the indicated bid immediately; else implement the indicated bid only if the indicated bid for the volume currently supplied (or implied bid via interpolation) exceeds the minimum bid price by 15%—otherwise the ISP B's bid table remains unchanged.

An alternative procedure is illustrated by the following example in which B has a target of twice the cost charged by E to B for the cost of bandwidth sold by B to his customers:

1) At a particular time, B is charging a spot price of $5/Gbps/hr to its customers for bandwidth over routes which go through E; however, E is only charging B $1/Gbps/hr (spot price) with an MBP of £1.5/Gbps/hr;

2) B tests to see if its current spot price to its customers is substantially different from its target price (eg ±20%); thus in the present case, B determines if the current spot price to customers ($5/Gbps/hr)>target price (2×$1.5/Gbps/hr×1.2) and determines that it is (note that the MBP is used in calculating the target price since this is what B will be charged initially if he successfully submits a new bid);

3) In order to determine his bid options at different prices, B tests the demand from his customers for bandwidth along routes through E at different process charged by B; in the present example, B tests for demand at 1.5, 2, 3 and 4 $/Gbps/hr in addition to knowing the demand at $5/Gbps/hr; B then generates bid options at 0.75, 1, 1.5, 2 and 2.5 £/Gbps/hr with the amounts requested at each price corresponding to the demands of his customers in aggregate at 1.5, 2, 3, 4 and 5 $/Gbps/hr.

One general advantage of each potential purchaser of the services of a network (eg a content provider) setting a policy or table of preferences which indicates the benefit which he ascribes to various levels of quality of service for the transmission of data over a network for a particular type of transmission (eg as determined by the class of data being transmitted and the class of receiver and/or transmitter of the data) is that this information may then be passed on to parties higher up in the architecture of the network and used to help other parties determine how much resource they themselves should try to secure and at what cost. This makes it easier to provide stable solutions for the allocation of resources to the most valuable traffic even where the precise operation of the networks involved is not known.

General Comments

The above embodiments have been described with reference to a fairly complicated network set-up in which the network seeks in one way or another to attempt to allocate a congested resource such that the most valuable traffic is carried in preference to less valuable traffic. However, even where the network is relatively dumb an equivalent mechanism to that of the bandwidth broker can be provided for allocating the resource on a simple first come, first served admission control basis with fixed prices? In such cases there is still value in providing mechanisms for bid creation and intelligent bidding because the environment in which they may be employed (eg the Internet) is a heterogeneous environment and it is useful for a content provider or similar purchaser of network services to be able to set in advance and to indicate to the network or other parties what value he ascribes to various transmissions over networks.

In the second embodiment we give an example where only three types of service can be specified. However, this is not the full range of what is possible. There are other measures of service, such as those indicated above, and a service could be specified with more than one defining parameter (e.g. max 70 ms latency and max 3% packet loss).

In the fourth embodiment, reference is made to a proxy price for a combination of resources needed to access the mid-point of E's network. This is intended to express the concept that the operator uses a single, proxy measure of the resource available to users for this purpose and establishes real spot and minimum bid prices for access to the combination of resources represented by the proxy measure.

The above described embodiments have concerned apparatus and methods for allocating resources of a communications network. However, the invention is also applicable to software for carrying out any of the above described methods either when stored on a suitable medium such as a magnetic medium or when stored within the memory of a processing device such as a server or a router, etc. The software may also be carried as a signal over a data communications network such as the Internet. The software may be in source code form or in a fully or partially compiled form.

1. A shared resource access or utilisation system comprising:
a shared resource;
a plurality of devices operable to access or use an amount of the shared resource;
means for obtaining from one or more of the devices an indication of one or more desired amounts of the shared resource which the device wishes to use and of how much the device is prepared to pay for the or each desired amount of the shared resource;
means for accessing or determining a current cost for accessing or using a unit amount of the shared resource;
means for determining the amount of the shared resource which the or each device may access or use in accordance with its indication and the current cost; and
means for informing the or each device of the amount of the shared resource which it may access or use.

2. A system according to claim 1, wherein the shared resource is split into a plurality of different types of sub-resource, which have different properties and/or costs per unit amount.

3. A system according to claim 1 or 2, wherein the shared resource is a resource required during the transmission of a signal over a communications network.

4. A system according to claim 1, 2 or 3, wherein the shared resource is one of: bandwidth over a communications network between two or more users of the network; processing power of a shared processing device connected to a communications network; or data storage capacity within a data storage device connected to a communications network, or any combination of these three resources.

5. A system according to any preceding claim wherein each indication further includes an indication as to a quality measure of the resource associated with the or each desired amount of the resource and the amount which the device is prepared to pay for that amount.

6. A system according to claim 5 wherein the quality measure is one of: a minimum acceptable latency or round-trip packet delay; a minimum level of packet jitter; a minimum assured continuous bandwidth throughput; or another measure of network performance.

7. A system according to any preceding claim wherein each indication comprises a preference table setting out a plurality of bid options each of which includes a requested amount of the resource and an associated ceiling price.

8. A system according to claim 7 wherein the preference table comprises a plurality of groups of bid options, each group being associated with a type of content, whereby different groups of bid options may be used for different types of content to be transmitted.

9. A system according to claim 7 or 8 wherein the preference table comprises a plurality of groups of bid options, each group being associated with a class of user, whereby different groups of bid options may be used for different classes of user to whom or from whom data is to be transmitted or received.

10. A system according to claim 7, 8 or 9 wherein the preference table comprises a plurality of groups of bid options, each group being associated with a type of application, whereby different groups of bid options may be used for different types of application controlling data to be transmitted over a network to which the device is attached.

11. A system according to any of claims 7 to 10 wherein the preference table includes an explicit preference order for the bid options.

12. A system according to any of claims 7 to 11 wherein the preference table comprises one or more groups of bid options, each group containing a plurality of bid options setting out a requested amount of the resource and a price offered for that amount, wherein the price offered per unit of the resource in each bid option is set to equal the difference in benefit to the device divided by the difference in the amount of the resource in going to the respective bid option from the next lowest bid option.

13. A system according to any of claims 7 to 12 wherein the preference table includes a marker for indicating that the bidding table reflects the benefit to the device of each amount of the resource included in the bid options.

14. A system according to any of claims 7 to 13 wherein the preference table includes an indication that one or more different requests for an amount of the resource are related in some way such that the benefit associated with one request being successful is dependent on the success of the or each other related request.

15. A system according to any preceding claim including a first network and a second network connected to said first network, said first network including purchasing means for purchasing an amount of a second network shared resource from the second network for onward sale to one or more of the devices as part of the shared resource requested by the or each device, the purchasing means including means for estimating the aggregated amount of demand for the shared resource at a plurality of different costs of the shared resource desired by the or each device on the basis of the indications from the or each device.

16. A system according to claim 15 wherein the purchasing means is operable to determine the desired amount of the second network shared resource to purchase on behalf of the first network on the basis of the estimated level of demand for said shared resource from the or each of said devices.

17. A system as claimed in claim 15 or 16 wherein the purchasing means is operable to review the desired amount of the second network shared resource to purchase with a frequency which is greater than once every hour but less than once every minute.

18. A system according to any preceding claim wherein the indication obtaining means comprises a bid generation means for generating and transmitting a bid to a resource allocation means, the bid including at least one requested amount of the resource and an associated price.

19. A system according to claim 18 wherein the current cost accessing or determining means comprises a resource allocation means for receiving one or more bids from one or more of the devices, for determining a current price per unit of the resource available in dependence on the received bids and for determining the amount of the resource which can be used or accessed by each device in dependence on the received bids and the current price per unit of the resource available.

20. A system according to claim 19 wherein the resource allocation means includes the informing means for informing the or each device of the amount of the resource which it can use or access.

21. A system according to any preceding claim further comprising controlling means for controlling access to or use of the resource by the or each device, and wherein the resource allocation means further comprises means for instructing the controlling means to restrict the amount of the resource which the or each device may access or use to the amount determined by the resource allocation means.

22. A system according to any of claims 19, 20 or 21, wherein the allocation means includes means for determining a first price per unit of the shared resource and means for allocating the requested amount of the shared resource in response to bids whose price offered per unit of the resource is equal to or greater than said first price.

23. A system according to claim 22, wherein the allocation means further includes means for varying the first price according to the level of demand for the shared resource as determined by the received bids so as to maintain the utilization of the resource approximately equal to a predetermined percentage of the maximum utilization of the resource possible.

24. A system according to claim 22 or 23, wherein the allocation means further includes means for determining a second price per unit of the resource and means for allocating a requested amount of the shared resource in response to a new bid if the price offered per unit of the resource is equal to or greater than said second price.

25. A system as claimed in claims 23 and 24 wherein the allocation means further includes means for varying the second price according to the level of demand as determined by the received bids, at a rate which is greater than the rate at which the first price is varied.

26. A system as claimed in claim 25 wherein the allocation means further comprises means for setting the second price to a value higher than said first price in response to the level of demand as determined by the received bids being greater than a predetermined threshold.

27. A system as claimed in claim 25 wherein the allocation means further comprises means for setting the second price to a value higher than said first price in response to a measure of the quality of the resource falling below a predetermined threshold.

28. A system as claimed in any of claims 1 to 17 wherein the indication obtaining means is formed as part of a resource management agent which also includes the current cost accessing or determining means and the informing means, each device having an associated resource management agent.

29. A system as claimed in claims 2, 5 and 28 wherein the resource management agent of an associated device is adapted to receive a notification from a current price storing means of the current price per unit amount of resource for each of said sub-resources, and to determine how much resource, and of which sub-resource or sub-resources, the device should access or use in accordance with a measurement of the quality of service associated with each sub-resource and the respective indication from the device as to the amount of the shared resource desired, at what quality and at what price.

30. A resource allocation device for allocating access to or use of a shared resource amongst a number of devices which are operable to use the resource, said resource allocation device comprising:
receiving means for receiving a plurality of bids from one or more devices adapted to access or use the shared resource, which bids indicate a requested amount of the shared resource and a price offered for the requested amount;
allocation means for determining an allocation of access to or use of the resource by the devices, which are operable to use the resource, in dependence on the bids received; and
instruction means for instructing a controlling device to control access to the shared resource in accordance with the determined allocation.

31. A resource management agent for controlling the use, by a device connected to a data network, of a resource or sub-resources required by the device to transmit or receive data over the data network, the resource management agent comprising:
means for interfacing with a set of preferences associated with the device, said set of preferences including at least one set of indications as to what amounts of the resource or sub-resources are desired by the device for given levels of quality of service associated with the resource or sub-resources and for given ceiling prices under a given set of properties of an associated flow of data to or from the device over the network;
means for interfacing with the network to determine properties of the resource or sub-resources including the associated level or levels of quality of service, and the associated cost or costs; and
processing means for determining an appropriate amount or amounts of the resource or sub-resources for the device to use for an associated flow of data in dependence upon said set of preferences and said properties of said resource or sub-resources.

32. A resource management agent as claimed in claim 31 wherein the processing means includes conversion means for generating estimated indications, on the basis of said set of preferences associated with the device, as to what amounts of the resource or sub-resources are actually desired by the device for levels of quality of service associated with the resource or sub-resources and for the cost or costs of the resource or sub-resources actually available from the network for a given flow of data to or from the device over the network, where the actually available levels of quality of service and cost differ from those included in the set of preferences.

33. A bid router device comprising:
means for receiving bids from users of a shared resource which bids indicate a requested amount of the shared resource and a price offered for the requested amount;
data storage means for storing address data of one or more allocating devices operable to allocate portions of the shared resource to bidding users together with data indicating the nature of the shared resource which is able to be allocated by the or each allocation device;
means for processing each bid using said stored data to determine whether the bid should be forwarded to an allocation device and if so to which allocation device it should be forwarded; and
forwarding means for forwarding bids to allocation devices.

34. A bidding device operable to communicate with a correspondent device over a communications network, said communications network including at least one shared resource, access to which is required by both the bidding device and the correspondent device in order for a communication between the bidding and correspondent devices to occur, said device including:
detection means for detecting the initiation of a communication between the bidding device and the correspondent device; and
bid generation means for generating a bid indicating a requested allocation of the shared resource and a price offered for the requested allocation in response to detection by the detection means of the initiation of a communication.

35. A device according to claim 34, further comprising termination detection means for detecting the termination of the communication; and
termination request generation means for generating a termination request requesting that the allocation of the shared resource in connection with the communication be terminated.

36. A device according to claim 34 or 35, further comprising quality of service determination means for determining a desired quality of service for the communication and wherein the bid generation means is operable to generate a bid which requests sufficient allocation of the shared resource to achieve the desired quality of service.

37. A device according to any of claims 34 to 36, wherein the bid generation means is adapted to generate bids having a plurality of different bid options, each bid option including a requested allocation of the shared resource and a price offered for the requested allocation.

38. A controlling device for controlling access to, or use of, a shared resource by one or more devices operable to access or use the shared resource, the controlling means including:
instruction receiving means for receiving instructions about how much of the shared resource should be allocated to the or each device;
storage means for storing data indicating how much of the shared resource should be allocated to the or each device; and
controlling means for controlling access to or use of the shared resource by the or each device operable to access or use the shared resource in accordance with said stored data.

39. A method of controlling access to or utilisation of a shared resource amongst a plurality of devices operable to access or use the shared resource, said method comprising the steps of:
obtaining from one or more of the devices an indication of one or more desired amounts of the shared resource which the device wishes to use and of how much the device is prepared to pay for the or each desired amount of the shared resource;
obtaining or determining a current cost for accessing or using a unit amount of the shared resource;
determining the amount of the shared resource which the or each device may access or use in accordance with its indication and the current cost; and
informing the or each device of the amount of the shared resource which it may access or use.

40. A method according to claim 39, wherein the shared resource is split into a plurality of different types of sub-resource, which have different properties and/or costs per unit amount.

41. A method according to claim 39 or 40, wherein the shared resource is a resource required during the transmission of a signal over a communications network.

42. A method according to claim 39, 40 or 41, wherein the shared resource is one of: bandwidth over a communications network between two or more users of the network; processing power of a shared processing device connected to a communications network; or data storage capacity within a data storage device connected to a communications network, or any combination of these three resources.

43. A method according to any of claims 39 to 42 wherein each indication further includes an indication as to a quality measure of the resource associated with the or each desired amount of the resource and the amount which the device is prepared to pay for that amount.

44. A method according to claim 43 wherein the quality measure is one of: a minimum acceptable latency or round-trip packet delay; a minimum level of packet jitter; a minimum assured continuous bandwidth throughput; or another measure of network performance.

45. A method according to any of claims 39 to 44 wherein each indication comprises a preference table setting out a plurality of bid options each of which includes a requested amount of the resource and an associated ceiling price.

46. A method according to claim 45 wherein the preference table comprises a plurality of groups of bid options, each group being associated with a type of content, whereby different groups of bid options may be used for different types of content to be transmitted.

47. A method according to claim 45 or 46 wherein the preference table comprises a plurality of groups of bid options, each group being associated with a class of user, whereby different groups of bid options may be used for different classes of user to whom or from whom data is to be transmitted or received.

48. A method according to claim 45, 46 or 47 wherein the preference table comprises a plurality of groups of bid options, each group being associated with a type of application, whereby different groups of bid options may be used for different types of application controlling data to be transmitted over a network to which the device is attached.

49. A method according to any of claims 45 to 48 wherein the preference table includes an explicit preference order for the bid options.

50. A method according to any of claims 45 to 49 wherein the preference table comprises one or more groups of bid options, each group containing a plurality of bid options setting out a requested amount of the resource and a price offered for that amount, wherein the price offered per unit of the resource in each bid option is set to equal the difference in benefit to the device divided by the difference in the amount of the resource in going to the respective bid option from the next lowest bid option.

51. A method according to any of claims 45 to 50 wherein the preference table includes a marker for indicating that the bidding table reflects the benefit to the device of each amount of the resource included in the bid options.

52. A method according to any of claims 45 to 51 wherein the preference table includes an indication that one or more different requests for an amount of the resource are related in some way such that the benefit associated with one request being successful is dependent on the success of the or each other related request.

53. A method according to any of claims 39 to 52 wherein the devices are connected to a first network which in turn is connected to a second network, said method further including the steps of said first network purchasing an amount of a second network shared resource from the second network for onward sale to one or more of the devices as part of the shared resource requested by the or each device, the purchasing step including estimating the aggregated amount of demand for the shared resource at a plurality of different costs of the shared resource desired by the or each device on the basis of the indications from the or each device.

54. A method according to claim 53 wherein the purchasing step includes determining the desired amount of the second network shared resource to purchase on behalf of the first network on the basis of the estimated level of demand for said shared resource from the or each of said devices.

55. A method according to claim 53 or 54 wherein the purchasing step includes reviewing the desired amount of the second network shared resource to purchase with a frequency which is greater than once every hour but less than once every minute.

56. A method according to any of claims 39 to 55 wherein the indication obtaining step comprises generating and transmitting a bid to a resource allocation means, the bid including at least one requested amount of the resource and an associated price.

57. A method according to claim 56 wherein the current cost accessing or determining step comprises said resource allocation means receiving one or more bids from one or more of the devices, determining a current price per unit of the resource available in dependence on the received bids and determining the amount of the resource which can be used or accessed by each device in dependence on the received bids and the current price per unit of the resource available.

58. A method according to claim 57 wherein the resource allocation means performs the informing step of informing the or each device of the amount of the resource which it can use or access.

59. A method according to any of claims 39 to 58 further comprising the steps of:
causing a controlling means to control access to or use of the resource by the or each device, and
instructing the controlling means to restrict the amount of the resource which the or each device may access or use to the amount determined by the resource allocation means.

60. A method according to any of claims 57, 58 or 59, wherein the allocating step includes determining a first price per unit of the shared resource and allocating the requested amount of the shared resource in response to bids whose price offered per unit of the resource is equal to or greater than said first price.

61. A method according to claim 60, wherein the allocating step further includes varying the first price according to the level of demand for the shared resource as determined by the received bids so as to maintain the utilization of the resource approximately equal to a predetermined percentage of the maximum utilization of the resource possible.

62. A method according to claim 60 or 61, wherein the allocating step further includes determining a second price per unit of the resource and allocating a requested amount of the shared resource in response to a new bid if the price offered per unit of the resource is equal to or greater than said second price.

63. A method as claimed in claims 61 and 62 wherein the allocating step further includes varying the second price according to the level of demand as determined by the received bids, at a rate which is greater than the rate at which the first price is varied.

64. A method as claimed in claim 63 wherein the allocating step further comprises setting the second price to a value higher than said first price in response to the level of demand as determined by the received bids being greater than a predetermined threshold.

65. A method as claimed in claim 63 wherein the allocating step further comprises setting the second price to a value higher than said first price in response to a measure of the quality of the resource falling below a predetermined threshold.

66. A method as claimed in any of claims 39 to 55 wherein the indication obtaining step is performed by a resource management agent which also performs the current cost accessing or determining step and the informing step.

67. A method as claimed in claims 40, 44 and 66 wherein the resource management agent of an associated device receives a notification from a current price storing means of the current price per unit amount of resource for each of said sub-resources, and determines how much resource, and of which sub-resource or sub-resources, the device should access or use in accordance with a measurement of the quality of service associated with each sub-resource and the respective indication from the device as to the amount of the shared resource desired, at what quality and at what price.

68. A resource allocation method for allocating access to or use of a shared resource amongst a number of devices which are operable to use the resource, said resource allocation method comprising:
receiving a plurality of bids from one or more of the devices adapted to access or use the shared resource, which bids indicate a requested amount of the shared resource and a price offered for the requested amount;
determining an allocation of access to or use of the resource by the devices in dependence on the bids received; and
instructing a controlling device to control access to the shared resource in accordance with the determined allocation.

69. A resource management method for controlling the use, by a device connected to a data network, of a resource or sub-resources required by the device to transmit or receive data over the data network, the resource management method comprising:
interfacing with a set of preferences associated with the device, said set of preferences including at least one set of indications as to what amounts of the resource or sub-resources are desired by the device for given levels of quality of service associated with the resource or sub-resources and for given ceiling prices under a given set of properties of an associated flow of data to or from the device over the network;
interfacing with the network to determine properties of the resource or sub-resources including the associated level or levels of quality of service, and the associated cost or costs; and
determining an appropriate amount or amounts of the resource or sub-resources for the device to use for an associated flow of data in dependence upon said set of preferences and said properties of said resource or sub-resources.

70. A resource management method as claimed in claim 69 wherein the determining step includes generating estimated indications, on the basis of said set of preferences associated with the device, as to what amounts of the resource or sub-resources are actually desired by the device for levels of quality of service associated with the resource or sub-resources and for the cost or costs of the resource or sub-resources actually available from the network for a given flow of data to or from the device over the network, where the actually available levels of quality of service and cost differ from those included in the set of preferences.

71. A method of routing bids comprising:
receiving bids from users of a shared resource which bids indicate a requested amount of the shared resource and a price offered for the requested amount;
storing address data of one or more allocating devices operable to allocate portions of the shared resource to bidding users together with data indicating the nature of the shared resource which is able to be allocated by the or each allocation device;
processing each bid using said stored data to determine whether the bid should be forwarded to an allocation device and if so to which allocation device it should be forwarded; and
forwarding bids to allocation devices.

72. A bidding method for use by a bidding device operable to communicate with a correspondent device over a communications network, said communications network including at least one shared resource, access to which is required by both the bidding device and the correspondent device in order for a communication between the bidding and correspondent devices to occur, said method including:
detecting the initiation of a communication between the bidding device and the correspondent device; and
generating a bid indicating a requested allocation of the shared resource and a price offered for the requested allocation in response to detection by the detection means of the initiation of a communication.

73. A method according to claim 72, further comprising detecting the termination of the communication; and
generating a termination request requesting that the allocation of the shared resource in connection with the communication be terminated.

74. A method according to claim 72 or 73, further comprising quality of service determination means for determining a desired quality of service for the communication and wherein the bid generation means is operable to generate a bid which requests sufficient allocation of the shared resource to achieve the desired quality of service.

75. A method according to any of claims 72 to 74, wherein the bid generation step includes generating bids having a plurality of different bid options, each bid option including a requested allocation of the shared resource and a price offered for the requested allocation.

76. A method of controlling access to, or use of, a shared resource by one or more devices operable to access or use the shared resource, the method including:
receiving instructions about how much of the shared resource should be allocated to the or each device;
storing data indicating how much of the shared resource should be allocated to the or each device; and
controlling access to or use of the shared resource by the or each device operable to access or use the shared resource in accordance with said stored data.

77. A computer program for carrying out a method according to any of claims 39 to 76.

78. A carrier medium for carrying the computer program according to claim 77.

79. A method of generating a bid for use by a bidding device operable to communicate with a correspondent device over a communications network, said communications network including at least one shared resource, access to which is required by both the bidding device and the correspondent device in order for a communication between the bidding and the correspondent devices to occur, said method including:
forming a plurality of bid options each of which indicates a desired amount of the resource together with a price offered for that amount of resource;
generating information identifying one or more properties of the flow for which the shared resource is required; and
bundling the bid option and flow information together to form a bid.

80. A method of generating data for transmission by a sending device to a receiving device over a communications network, said communications network including at least one shared resource, access to which is required by both the sending device and the receiving device, said method including:
receiving an indication as to how much of the shared resource may be used by the transmitting and receiving devices to enable transmission of the generated data;
generating data for transmission over the network which data includes address information of both the sending and receiving devices; and
transmitting the data onto the network at a rate such that the indicated amount of the shared resource is not exceeded.
